(19) United States
(12) Patent Application Publication
(10) Pub. No.: US 2010/0236134 A1
(43) Pub. Date: Sep. 23, 2010

(54) EMULSION FUEL AND PROCESS AND EQUIPMENT FOR THE PRODUCTION OF THE SAME

(75) Inventors: Kenichi Mogami, Fukuoka (JP); Hidehiro Kumazawa, Aichi (JP)

Correspondence Address: JORDAN AND HAMBURG LLP, 122 EAST 42ND STREET, SUITE 4000, NEW YORK, NY, 10168, US

(73) Assignees: MG Grow Up Corp.; Marufukusuisan Corp.

(21) Appl. No.: 12/734,268

(22) PCT Filed: Oct. 21, 2008
(86) PCT No.: PCT/JP2008/069045

§ 371 Date: Apr. 21, 2010

(30) Foreign Application Priority Data
Oct. 22, 2007 (JP) 2007-274367
Apr. 2, 2008 (JP) 2008-096250
Jun. 10, 2008 (JP) 2008-152140

(51) Int. Cl. C10L 1/32; F02M 25/00

(52) U.S. Cl. 44/301; 261/18.2

(57) ABSTRACT

An emulsion fuel is provided which is usable as a fuel for combusting an internal combustion engine under an appropriate combustion condition. A slight amount of air is added to, and is mixed with, a liquid mixture between a fuel oil as a continuous phase and water as a dispersed phase. In this manner, since air bubbles reduced in buoyancy is hydrophobic, the air bubbles do not adhere the surfaces of water droplets, and are dispersed in the fuel oil, increasing a gas-liquid interfacial area (combustion surface area) and exerting surface activity (similar to the function of a surfactant) due to electrostatic polarization. This makes it possible to prevent the coalescence of fine water droplets and stabilize the water droplets in the emulsion fuel. As a result, in the emulsion fuel, dispersion of water droplet diameters is homogenized, and even if the emulsion fuel is combusted by means of combustion equipment, for example, good combustion efficiency can be ensured, and further, a disadvantage that soot or black smoke is generated can be eliminated.

The present invention relates to an emulsion fuel and process and equipment for producing the same continuously.

### BACKGROUND OF THE INVENTION

As one aspect of the process for the production of emulsion fuel, there is a process for producing an emulsion fuel by stirring/mixing a fuel oil and water by means of a mixer (see patent document 1, for example).

The process for the production of emulsion fuel is basically intended for the production of the emulsion fuel having fine water droplets uniformly dispersed in a fuel oil without using an emulsifier.

Patent document 1: Japanese Patent Application Laid-open No. 5-157221

However, the above-described process for the production of emulsion fuel constitutes merely stirring/mixing a fuel oil and water by one mixer, thus entailing a disadvantage that: in the obtained emulsion fuel, water droplets condense, allowing dispersion of water droplet sizes to be non-uniform; and further, if the emulsion fuel is combusted by means of combustion equipment, the combustion efficiency becomes impaired, and soot or black smoke is generated.

### SUMMARY OF THE INVENTION

In order to solve the above-described problem, the present invention provides the following emulsion fuel.

(1) The present invention is directed to an emulsion fuel comprising fine air bubbles, allowing a slight amount of air to be added to, and to be mixed with, a liquid mixture of a fuel oil as a continuous phase and water as a dispersed phase, by means of a fluid mixer. The fluid mixer comprises a mixing unit allowing a disk-shaped second mixing element to be disposed to be opposed to a disk-shaped first mixing element forming a flow inlet of a fluid at a center part thereof, the mixing unit forming a mixing flow path for flowing and mixing the fluid having in-flow from the flow inlet in a radiation direction between the mixing elements. The mixing unit is disposed in plurality in a casing main body formed in a cylindrical shape at given intervals in an axial direction thereof, forming a space for forming a flow path by the adjacent mixing units and the casing main body; a disk-shaped, collecting-flow-path forming element is disposed in the space for forming the flow path so that a collecting-flow path is formed allowing the fluid having passed through the mixing flow path to outflow substantially equally from an entire circumference of a flow outlet opening like a ring, and then, flow and gather to an axial core side of the casing main body. An expansive guide member for stabilizing a flow-path sectional area on one side face of an element main body is formed at the collecting-flow-path forming element, the guide member being formed in a substantially fan-like, flat shape from an outer circumferential arc face formed on an arc face of a curvature which is identical to that of an outer circumferential edge of the element main body. A pair of side faces connected to be extended from both ends of the outer circumferential arc face to a center side of the element main body, and an abutment face formed as a plane parallel to the element main body.

The guide member is disposed in plurality at a circumferential part of the element main body at equal intervals in a circumferential direction thereof, and is formed so that: an outer circumferential arc face of each of the guide members is flush with an outer circumferential edge face of the collecting-flow-path forming element and an outer circumferential edge face of the second mixing element; and the side faces opposite to each other, of the adjacent guide members is in parallel to each other in a circumferential direction, allowing a groove portion width of a groove portion formed of a side face of the adjacent guide members and a rear face of the element main body to be substantially equal to each other from a circumferential side to a center side, of the collecting-flow-path forming element.

(2) The present invention is directed to an emulsion fuel comprising fine air bubbles, wherein a fuel oil as a continuous phase and water mixed with fine air bubbles as a dispersed phase are mixed with each other by means of the fluid mixer of (1).

(3) The present invention is directed to an emulsion fuel comprising fine air bubbles, wherein a fuel oil mixed with fine air bubbles as a continuous phase and water as a dispersed phase are mixed with each other by means of the fluid mixer of (1).

(4) The present invention is directed to an emulsion fuel comprising fine air bubbles, wherein a liquid mixture, as dispersed phase, obtained by mixing water mixed with fine air bubbles as a continuous phase and a fuel oil as a dispersed phase with each other by means of the fluid mixer of (1), is mixed with a fuel oil as a continuous phase.

(5) The present invention is directed to an emulsion fuel comprising fine air bubbles, wherein a liquid mixture, as a dispersed phase, obtained by mixing water as a continuous phase and a fuel oil mixed with fine bubbles as a dispersed phase with each other by means of the fluid mixer of (1), is mixed with a fuel oil as a continuous phase.

(6) The present invention is directed to an emulsion fuel, wherein a liquid mixture, as a dispersed phase, obtained by mixing water as a continuous phase and a fuel oil as a dispersed phase with each other by means of the fluid mixer of (1), is mixed with a fuel oil as a continuous phase.

(7) The present invention is directed to an emulsion fuel, wherein water treated to be reformed as a dispersed phase and a fuel oil as a continuous phase are mixed with each other by means of the fluid mixer of (1).

(8) The present invention is directed to an emulsion fuel, wherein a fuel oil as a continuous phase and water as dispersed phase are miniaturized and mixed with each other at a precedent stage and are ultra-miniaturized and mixed with each other at a subsequent stage by means of the fluid mixer of (1).

Here, in the case where very fine air bubbles which are on the nano-level or submicron level in diameter of a slight amount of air are formed, an emulsion fuel comprising very fine air bubbles whose diameter is on the nano-level or submicron level can be formed. In this case, more significant increase of a gas-liquid interfacial area (combustion surface area) due to very fine air bubbles and increase of surface activity (similar to the function of a surfactant) due to electrostatic polarization can be accelerated; the coalescence of the miniaturized water droplets can be prevented; and the water droplets can be stabilized more in emulsion fuel. As a result, good combustion efficiency can be enhanced more remarkably. The nano-level designates a level less than 1 micron. The submicron level designates a level of 0.1 micron to 1 micron.

In order to solve the foregoing problem, the present invention provides a method for production of emulsion fuel, as described below.

(9) The present invention is directed to a process for production of emulsion fuel, wherein a fuel oil and water are treated to be mixed with each other, by means of the fluid mixer of (1) thereby forming a liquid mixture comprising a fuel oil as a continuous phase and fine water droplets as a dispersed phase, and subsequently, a slight amount of air is added to the liquid mixture, and is further treated to be mixed with each other, thereby producing an emulsion fuel comprising fine air bubbles.

(10) The present invention is directed to a process for production of emulsion fuel, wherein water and air are treated to be mixed with each other, forming water mixed with fine air bubbles, and subsequently, the water mixed with the fine air bubbles and a fuel oil are treated to be mixed with each other, by means of the fluid mixer of (1), thereby producing an emulsion fuel comprising fine air bubbles, comprising a fuel oil as a continuous phase and fine water droplets and fine air bubbles, as a dispersed phase.

(11) The present invention is directed to a process for production of emulsion fuel, wherein a fuel oil and air are treated to be mixed with each other, forming a fuel oil mixed with fine air bubbles, and subsequently, the fuel oil mixed with the fine air bubbles and water are treated to be mixed with each other, by means of the fluid mixer of (1), thereby producing an emulsion fuel comprising fine air bubbles, consisting of a fuel oil mixed with fine air bubbles, as a continuous phase, and fine water droplets as a dispersed phase.

(12) The present invention is directed to a process for production of emulsion fuel, wherein water and air are treated to be mixed with each other, forming water mixed with fine air bubbles, and subsequently, the water mixed with the fine air bubbles and a fuel oil are treated to be mixed with each other, by means of the fluid mixer of (1), thereby forming a liquid mixture consisting of water mixed with fine air bubbles, as a continuous phase, and fine oil droplets as a dispersed phase, and further subsequently, the liquid mixture and fuel oil are treated to be mixed with each other, thereby producing an emulsion fuel comprising fine air bubbles, comprising a fuel oil as a continuous phase and water droplets containing fine oil droplets phase and fine air bubbles, as dispersed phase.

(13) The present invention is directed to a process for production of emulsion fuel, wherein a fuel oil and air are treated to be mixed with each other, forming a fuel oil mixed with fine air bubbles, and subsequently, the fuel oil mixed with the fine air bubbles and water are treated to be mixed with each other, by means of the fluid mixer of (1), thereby forming a liquid mixture comprising water as a continuous phase, fine oil droplets as a dispersed phase, and fine air bubbles, and subsequently, the liquid mixture and fuel oil are treated to be mixed with each other, thereby producing an emulsion fuel comprising fine air bubbles, comprising a fuel oil as a continuous phase and water droplets containing fine oil droplets and fine air bubbles, as a dispersed phase.

(14) The present invention is directed to a process for production of emulsion fuel, wherein water and a fuel oil are treated to be mixed with each other, by means of the fluid mixer of (1), forming a liquid mixture comprising water as a continuous phase and fine oil droplets as a dispersed phase, and subsequently, the liquid mixture and fuel oil are treated to be mixed with each other, thereby producing an emulsion fuel comprising a fuel oil as a continuous phase and water droplets containing fine oil droplets as a dispersed phase.

(15) The present invention is directed to a process for production of emulsion fuel, wherein water as a dispersed phase is treated to be reformed in advance, and the water as the dispersed phase, which are further treated to be reformed, and a fuel oil as a continuous phase are treated to be mixed with each other, by means of the fluid mixer of (1), thereby producing an emulsion fuel.

(16) The present invention is directed to a process for production of emulsion fuel, wherein a fuel oil as a continuous phase and water as a dispersed phase are treated to miniaturized and mixed with each other in a precedent stage to form a liquid mixture, and subsequently, the liquid mixture is treated to be ultra-miniaturized and mixed in a subsequent stage, by means of the fluid mixer of (1), thereby producing an emulsion fuel.

In order to solve the foregoing problem, the present invention provides equipment for production of emulsion fuel, as described below.

(17) The present invention is directed to equipment for production of emulsion fuel, comprising: a primary mixing treatment section for treating a fuel oil and water to be mixed with each other to form a liquid mixture comprising a fuel oil as a continuous phase and fine water droplets as a dispersed phase; and a secondary mixing treatment section for adding a slight amount of air to the liquid mixture to further perform mixing treatment, said equipment producing an emulsion fuel comprising fine air bubbles, wherein the secondary mixing treatment section is the fluid mixer of (1).

(18) The present invention is directed to equipment for production of emulsion fuel, comprising: a primary mixing treatment section for treating water and air to be mixed with each other to form water mixed with fine air bubbles; and a secondary mixing treatment section for treating water mixed with fine air bubbles and a fuel oil to be mixed with each other, said equipment producing an emulsion fuel comprising fine air bubbles, comprising a fuel oil as a continuous phase and fine water droplets and fine air bubbles, as a dispersed phase, wherein the secondary mixing treatment section is the fluid mixer of (1).

(19) The present invention is directed to equipment for production of emulsion fuel, comprising: a primary mixing treatment section for treating a fuel oil and air to be mixed with each other to form a fuel oil mixed with fine air bubbles; and a secondary mixing treatment section for treating the fuel oil mixed with the fine air bubbles and water to be mixed with each other, said equipment producing an emulsion fuel comprising fine air bubbles, comprising a fuel oil mixed with fine air bubbles, as a continuous phase, and fine water droplets as a dispersed phase, wherein the secondary mixing treatment section is the fluid mixer of (1).

(20) The present invention is directed to equipment for production of emulsion fuel, comprising: a primary mixing treatment section for treating water and air to be mixed with each other to form water mixed with fine air bubbles; a secondary mixing treatment section for treating the water mixed with the fine air bubbles and a fuel oil to be mixed with each other to form a liquid mixture comprising water mixed with fine air bubbles, as a continuous phase, and fine oil droplets as a dispersed phase; and a third mixing treatment section for treating the liquid mixture and fuel oil to be mixed with each other, said equipment producing an emulsion fuel comprising fine air bubbles, comprising a fuel oil as a continuous phase and water droplets containing fine oil droplets and fine air bubbles, as a dispersed phase, wherein the secondary mixing treatment section is the fluid mixer of (1).

(21) The present invention is directed to equipment for production of emulsion fuel, comprising: a primary mixing treatment section for treating a fuel oil and water to be mixed with each other to form a fuel oil mixed with fine air bubbles; a secondary mixing treatment section for treating the fuel oil mixed with the fine air bubbles and water to be mixed with each other to form a liquid mixture comprising water as a continuous phase and fine oil droplets and fine air bubbles as a dispersed phase; and a third mixing treatment section for treating the liquid mixture and fuel oil to be mixed with each other, said equipment producing an emulsion fuel comprising fine air bubbles, comprising a fuel oil as a continuous phase and water droplets containing fine oil droplets and fine air bubbles, as a dispersed phase, wherein the secondary mixing treatment section is the fluid mixer of (1).

(22) The present invention is directed to equipment for production of emulsion fuel, comprising: a primary mixing treatment section for treating water and a fuel oil to be mixed with each other to form a liquid mixture comprising water as a continuous phase and fine oil droplets as a dispersed phase; and a secondary mixing treatment section for treating the liquid mixture and fuel oil to be mixed with each other, said equipment producing an emulsion fuel comprising a fuel oil as a continuous phase and water droplets containing fine oil droplets as a dispersed phase, wherein the primary mixing treatment section is the fluid mixer of (1).

(23) The present invention is directed to equipment for production of emulsion fuel, comprising: a reform treatment section for treating water as a dispersed phase to be reformed, to form reform-treated water; and a mixing treatment section for treating the water to be reformed as a dispersed phase and a fuel oil as a continuous phase to be mixed with each other, said equipment producing an emulsion fuel, wherein the mixing treatment section is the fluid mixer of (1).

(24) The present invention is directed to equipment for production of emulsion fuel, comprising: a primary mixing treatment section at a precedent stage, for treating a fuel oil as a continuous phase and water as a dispersed phase to be miniaturized and mixed with each other to form a liquid mixture; and a secondary mixing treatment section at a subsequent stage, for treating the liquid mixture to be ultra-miniaturized and mixed, said equipment producing an emulsion fuel, wherein the secondary mixing treatment section is the fluid mixer of (1).

(1) In the present invention, an emulsion fuel comprising fine air bubbles, which is reduced in buoyancy, can be produced by miniaturizing and mixing a fuel oil as a continuous phase, water as a dispersed phase, and a slight amount of air. Since the fine air bubbles reduced in buoyancy is hydrophobic, the air bubbles do not adhere to the surfaces of water droplets and disperses in the fuel oil, thus increasing the gas-liquid interfacial area (combustion surface area) and exerting surface activity (similar to the function of a surfactant) through electrostatic polarization. This makes it possible to prevent the fine water droplets from coalescence and stabilize the water droplets in the emulsion fuel. As a result, in the emulsion fuel, dispersion of water droplet diameters is homogenized, and even if the emulsion fuel is combusted by means of combustion equipment, for example, good combustion efficiency can be ensured, and further, a disadvantage that soot or black smoke is generated can be eliminated. The abovementioned emulsion fuel comprising the air bubbles can also be used as a fuel for combusting an internal combustion engine under an appropriate combustion condition by adjusting a mixing ratio between fuel oil and water. In addition, The fuel oils used herein include a gasoline, a fuel oil for aircraft turbine (jet engine fuel oil), a lamp oil, a light oil, a fuel oil for gas turbine, a heavy oil or the like, whereas the present invention is effective for reforming a heavy oil, in particular, and further, even waste oil can be formed as an effectively usable reformed waste by reforming it. Further, even in the case where flame-retardant waste oil has been employed as a fuel oil, the waste oil can be stably combusted by obtaining an emulsion fuel of W/O type, according to the present invention.

(2) In the present invention, an emulsion fuel comprising fine air bubbles can be produced by mixing a fuel oil as a continuous phase and water mixed with fine air bubbles as a dispersed phase. Here, although fine air bubbles reduced in buoyancy exist in water as a dispersed phase, since the air bubbles are hydrophobic, thee air bubbles do not adhere the surfaces of water droplets, and disperses in the fuel oil at when they are mixed with a fuel oil. Therefore, in this case also, dispersion of water droplet diameters is homogenized, and even if the emulsion fuel is combusted by means of combustion equipment, for example, good combustion efficiency can be ensured, and further, a disadvantage that soot or black smoke is generated can be eliminated.

(3) In the present invention, an emulsion fuel comprising fine air bubbles can be manufactured by mixing a fuel oil mixed with fine air bubbles as a continuous phase and water as a dispersed phase with each other. Here, air is miniaturized and mixed with the fuel oil as the continuous phase, so that: oxygen in the air can be efficiently dissolved in the fuel oil; and the amount of the oxygen dissolved in the fuel oil can be increased. Therefore, if the emulsion fuel is combusted by means of combustion equipment, for example, better combustion efficiency can be ensured.

(4) In the present invention, an emulsion fuel of water/fuel oil (O/W/O) type, mixed with fuel oil/water mixed with air bubbles/fuel oil, can be produced by mixing a liquid mixture, as a dispersed phase, between water mixed with fine air bubbles, as a continuous phase, and a fuel oil as a dispersed phase, with a fuel oil as a continuous phase. In the emulsion fuel, expansion due to rapid evaporation of water droplets, which is a feature of an emulsion fuel, is further accelerated due to a combustion heat of very fine oil droplets (nano-level or submicron level) in the water droplets. Therefore, if the emulsion fuel is combusted by means of combustion equipment, for example, combustion efficiency can be enhanced more remarkably.

(5) In the present invention, an emulsion fuel of fuel oil/water/fuel oil (O/W/O) type, mixed with fine air bubbles, can be produced by mixing a liquid mixture, as a dispersed phase, between water as a continuous phase and a fuel oil mixed with fine air bubbles, as a dispersed phase, with a fuel oil as a continuous phase. In this case also, expansion due to rapid evaporation of water droplets, which is a feature of an emulsion fuel, is further accelerated due to a combustion heat of very fine oil droplets (nano-level or submicron level) in the water droplets, and combustion efficiency can be enhanced more remarkably.

(6) In the present invention, an emulsion fuel of fuel oil/water/fuel oil (O/W/O) type can be produced by mixing a liquid mixture, as a dispersed phase, between water as a continuous phase and a fuel oil as a disperse phase, with a fuel oil as a continuous phase. In this case also, expansion due to rapid evaporation of water droplets, which is a feature of an emulsion fuel, is further accelerated due to a combustion heat of very fine oil droplets (nano-level or submicron level) in the water droplets, and combustion efficiency can be enhanced more remarkably.

(7) In the present invention, an emulsion fuel can be produced by mixing water treated to be reformed as a dispersed phase and a fuel oil as a continuous phase with each other. Here, water as a liquid does not exist in a state in which the number of water molecules is 1 molecule, and forms a cluster in which a lot of water molecules are bonded with each other by means of hydrogen bonding between the water molecules (a state of (H₂O)n in assembly). Therefore, in the present invention, reform treatment is performed so as to reduce the number of adjacent water molecules existing around given water molecules to its possible minimum, whereby: homogenization of miniaturized water particles can be achieved; and an emulsion fuel can be formed by mixing the homogenized water particles to be uniformly miniaturized in a state in which they are wrapped around with a fuel oil. Therefore, in the case where the emulsion fuel is combusted by means of combustion equipment as well, for example, good combustion efficiency can also be ensured.

(8) In the present invention, an emulsion fuel can be produced by miniaturizing and mixing a fuel oil as a continuous phase and water as a dispersed phase in a precedent stage and ultra-miniaturizing and mixing them in a subsequent stage. Here, water droplets and a slight amount of impurities in the fuel oil, wrapping the water droplets around there, are miniaturized (micron level) and homogenized, and are mixed with each other in advance, and ultra-miniaturized (nano-level or submicron level) and mixed in the subsequent stage. Therefore, the water droplets and the slight amount of impurities in the fuel oil can be stabilized by ultra-minimizing and homogenizing them, and an emulsion fuel with its good fuel efficiency can be formed inexpensively.

### BRIEF DESCRIPTION OF THE DRAWINGS

FIG. 1 is a conceptual explanatory view showing a configuration of equipment for the production of emulsion fuel, as a first embodiment according to the present invention.

FIG. 2 is a conceptual explanatory view showing a configuration of equipment for the production of emulsion fuel, as a second embodiment according to the present invention.

FIG. 3 is a conceptual explanatory view showing a configuration of equipment for the production of emulsion fuel, as a third embodiment according to the present invention.

FIG. 4 is a conceptual explanatory view showing a configuration of equipment for the production of emulsion fuel, as a fourth embodiment according to the present invention.

FIG. 5 is a conceptual explanatory view showing a configuration of equipment for the production of emulsion fuel, as a fifth embodiment according to the present invention.

FIG. 6 is a conceptual explanatory view showing a configuration of equipment for the production of emulsion fuel, as a sixth embodiment according to the present invention.

FIG. 7 is a conceptual explanatory view showing a configuration of equipment for the production of emulsion fuel, as a seventh embodiment according to the present invention.

FIG. 8 is a conceptual explanatory view showing a configuration of equipment for the production of emulsion fuel, as an eighth embodiment according to the present invention.

FIG. 9 is a side view of a stirring mixer main body of a rotary stirring mixer.

FIG. 10 is a bottom view of an upward stirring member of the stirring mixer main body.

FIG. 11 is a plan view of a downward stirring member of the stirring mixer main body.

FIG. 12 is an explanatory plan view showing a communication state of recessed portions for forming flow paths formed at the upward and downward stirring member, respectively.

FIG. 13 is an explanatory sectional view taken along the line I-I of FIG. 12.

FIG. 14 is a bottom view of the downward stirring member.

FIG. 15 is a sectional front view showing a fluid mixer of the first embodiment.

FIG. 16 is an exploded sectional front view showing a mixing unit of the fluid mixer of the first embodiment.

FIG. 17A is a right side view showing a first mixing element of the mixing unit of the first embodiment.

FIG. 17B is a left side view showing the same.

FIG. 18A is a left side view showing a second mixing element of the mixing unit of the first embodiment.

FIG. 18B is a right side view showing the same.

FIG. 19 is a perspective view showing the mixing unit of the first embodiment.

FIG. 20 is an exploded perspective view showing an assembled state of the unit of the first embodiment.

FIG. 21 is an explanatory view showing an abutted state of the recessed portions formed at the mixing elements, respectively, of the first embodiment.

FIG. 22 is a sectional front view showing a fluid mixer of a second embodiment.

FIG. 23 is an exploded sectional front view showing a mixing unit of the fluid mixer of the second embodiment.

FIG. 24A is a right side view showing a collecting-flow-path forming element of the mixing unit of the second embodiment.

FIG. 24B is a left side of the same.

FIG. 25 is an exploded perspective view showing an assembled state of the mixing unit of the second embodiment.

FIG. 26 is an explanatory right side view of a collecting-flow-path forming element, showing the assembled state of the mixing unit of the second embodiment.

FIG. 27A is a left side view showing a modified second mixing element according to the second embodiment.

FIG. 27B is a landscape view of the front view showing the same.

FIG. 27C is a right side view showing the same.

FIG. 28 is a sectional front view showing a fluid mixer of a third embodiment.

FIG. 29 is an exploded sectional front view showing a mixing unit of the fluid mixer of the third embodiment.

FIG. 30 is an exploded perspective view showing an assembled state of the mixing unit of the third embodiment.

FIG. 31 is a left side view showing a lead-out side element of the mixing unit of the third embodiment.

FIG. 31B is a right side view showing the same.

FIG. 32 is a sectional front view showing a fluid mixer of a fourth embodiment.

FIG. 33 is an exploded sectional front view showing a mixing unit of the fluid mixer of the fourth embodiment.

FIG. 34 is an exploded perspective view showing an assembled state of the mixing unit of the fourth embodiment.

FIG. 35A is an explanatory right side view of the assembled state of the mixing unit, showing an exemplary modification of a collecting-fluid-path forming element.

FIG. 35B is a sectional view taken along the line II-II of FIG. 35A.

FIG. 35C is a sectional view taken along the line of FIG. 35A.

FIG. 36 is a sectional explanatory side view showing an exemplary modification of the fluid mixer of the first embodiment.

FIG. 37 is a sectional explanatory side view showing another exemplary modification of the fluid mixer of the first embodiment.

FIG. 38 is a graph of reformed water measured by ¹⁷O-NMR.

FIG. 39 is a graph of refined water measured by ¹⁷O-NMR.

FIG. 40 is a graph of tap water measured by ¹⁷O-NMR.

FIG. 41 is a particle size distribution map of a primary mixing treatment liquid.

FIG. 42 is a particle size distribution map of an emulsion fuel.

FIG. 43 is a comparison between samples in particle size distribution.

FIG. 44 is a bar graph of a combustion temperature of each emulsion fuel.

### DESCRIPTION OF REFERENCE NUMERALS

A1 to A8 Equipment for the production of emulsion fuel
1 Communication pipe
2 Pressure-feed pump
3 Suction pipe
4 Oil feed section
5 Water feed section
11-11E Fluid mixers
24 Mixing unit
24a Gap-shaped opening (flow outlet)
25 Mixing flow path
26 Collecting flow path
30 First mixing element
31 Inlet head
40 Second mixing element
35a, 41a Rectangular portion (diverting portion and/or converging portion)
52 Guide body
60 Lead-out side element
63 Discharge outlet
80 Rotary stirring mixer
100 Spacer
101 Complex flow generating member

### DESCRIPTION OF THE PREFERRED EMBODIMENTS

Hereinafter, embodiments of the present invention will be described referring to the drawings.

### Description of Equipment for the Production of Emulsion Fuel, as a First Embodiment

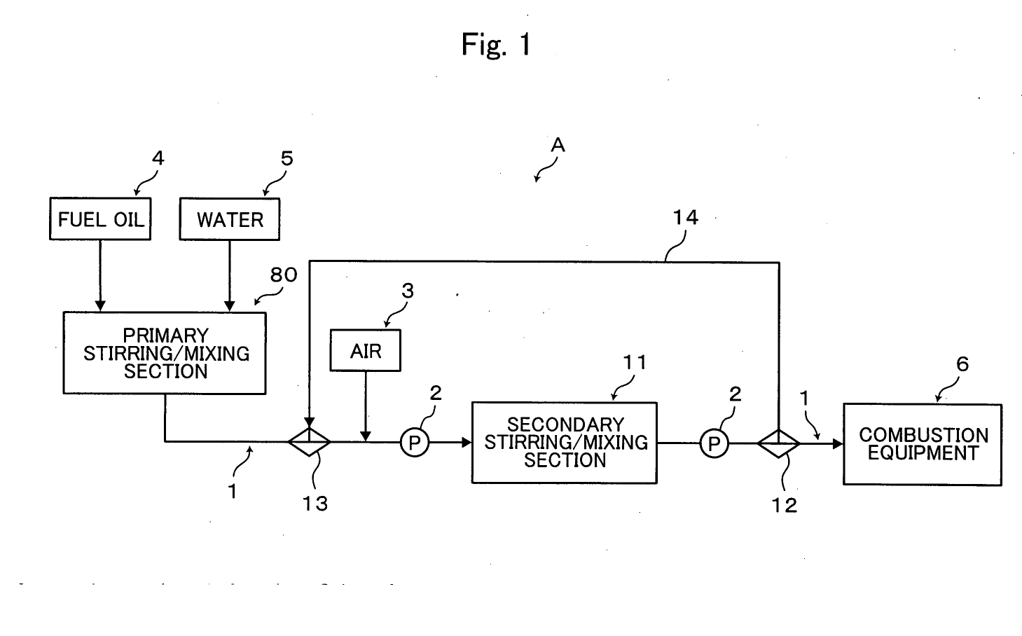

FIG. 1 is a conceptual view of equipment A1 for the production of emulsion fuel, as a first embodiment according to the present invention (hereinafter, referred to as “the first equipment”). The first equipment A1, as shown in FIG. 1, is provided with: a rotary stirring mixer 80 as a primary mixing treatment section for preliminarily uniformly stirring/mixing a fuel oil and water; and a stationary fluid mixer 11 as a secondary mixing treatment section for further stirring/mixing the stirred/mixed liquid mixture by means of the rotary stirring mixer 80. Both of the mixers 80, 11 are connected in communication with each other via a communication pipe 1 as a communication section so as to pressure-feed a predetermined amount of a primary treatment liquid from the rotary fluid mixer 80 to the stationary fluid mixer 11 by means of a pressure-feed pump which is provided at a midcourse part of the communication pipe 1. A proximal end part of a suction pipe 3 as a slight-amount-of-air intake section (slight-amount-of-air feed section) for the intake of a slight amount of air is connected in communication with the midcourse part of the communication pipe 1 positioned at a suction inlet side (at the direct upstream side) of this pressure-feed pump 2, and an opening amount adjustment valve (not shown) is mounted adjustable in opening amount at a distal end part of the suction air pipe 3, allowing the distal end part to be opened in the atmosphere by an appropriate opening amount. A valve section such as a check valve or an open/close valve can be arranged at an appropriate site of the communication pipe 1. In addition, the pressure-feed pump 2 can be arranged at another appropriate site of the communication pipe 1.

In FIG. 1, reference numeral 4 designates a oil feed section for feeding a predetermined amount of fuel oil to the rotary stirring mixer 80 by means of an oil feed pump or the like; and reference numeral 5 designates a water feed section for feeding a predetermined amount of water to the rotary stirring mixer 80 by means of a water feed pump or the like. Reference numeral 12 designates a first three-way valve. Reference numeral 13 designates a second three-way valve. Reference numeral 14 designates a return pipe interposed between the first and second three-way valves 12 and 13. Both of the first and second three-way valves 12 and 13 are manipulated to be switched as required, thereby circularly feeding a liquid mixture to the stationary fluid mixer 11 through the return pipe 14, allowing mixing treatment to be repeated a predetermined number of times (10 times, for example) or during a predetermined period of time (for 20 minutes, for example). The liquid mixture is returned to an upstream side of the rotary stirring mixer 80, and then, is circularly fed to the rotary stirring mixer 80 and the stationary fluid mixer 11, allowing mixing treatment to be performed a predetermined number of times or for a predetermined period of time. A detailed description of the rotary stirring mixer 80 and the stationary fluid mixer 11 will be furnished later.

As the pressure-feed pump 2, there can be used a pump which is capable of transporting a gas-liquid mixture, i.e., a pump (“gas-liquid transport pump” available from NIKUNI Corporation, for example) which is capable of ensuring a stable discharge pressure and discharge flow rate at the time of pressure-feeding an emulsion fuel which is a gas-liquid mixture fluid as well.

In addition, air (ambient air) can be in-taken from the suction pipe 3 to the communication pipe 1 by means of an ejector effect (suction effect utilizing a pressure difference between a pressure in the communication pipe 1 and that in the suction pipe 3).

Further, a slight amount of air intake (slight amount of air feed) for a fuel oil can be appropriately set or adjusted depending upon an amount of intake from the suction pipe 3 to the communication pipe 1 via an adjustment section such as the opening amount adjustment valve (not shown), or alternatively, a suction amount of the pressure-feed pump 2. For example, the volume (inflow amount) of the fine air (ambient air) to be suctioned can be set to be about 1% (0.7% to 1.2%) of the volume (predetermined flow rate) of the liquid mixture of the fuel oil and water to be pressure-fed from the pressure-feed pump 2, and can be in-taken from the suction pipe 3 to the communication pipe 1 by means of the ejector effect. 0% to 3% of the volume of the liquid mixture of the fuel oil and water is preferable as the slight amount of air intake (slight amount of air feed) of the emulsion fuel to be finally supplied to combustion equipment 6 (the slight amount of air intake is set at 0% in the case that air is not in-taken from the suction pipe 3 by closing the opening amount adjustment valve and closing the distal end part of the suction pipe 3). About 1% to 2% is further preferable, and 2% is the most preferable. In the case where a desired air amount cannot be suctioned at one time by means of the ejector effect, a mixing treatment liquid is circulated via the return pipe 14 as described previously, and air is in-taken over a plurality of times, whereby an emulsion fuel which is a finally treated, a desired liquid can be formed. A slight-amount-of-air intake section (slight-amount-of-air feed section) may have a structure which is capable of feeding several % of fine air into the primarily mixed/treated liquid at an upstream side (fluid lead-in port side) of at least the secondary mixing treatment section, and may have a structure of feeding fine air by means of pressure-feeding or the like, without being limitative to the structure of suctioning the fine air from the suction pipe 3 as described above.

At the time of producing an emulsion fuel, a volume ratio of fuel oil and water to be stirred/mixed is fuel oil:water=6 to 9:4 to 1. In the case where “A” heavy oil is employed as a fuel oil, preferably where fuel oil:water=8:2 and “C” heavy oil is employed as a fuel oil, or preferably where fuel oil:water=8.5:1.5 and waste oil is employed as a fuel oil, the emulsion fuel can be formed, preferably by stirring/mixing them in volume ratio of waste oil:water=9:1.

Next, a process for producing an emulsion fuel by means of the abovementioned first equipment A1 (emulsion fuel production process) will be described. That is, the emulsion fuel production process according to the present invention provides: a primary mixing treatment course, by means of a rotary fluid mixer 80 which will be described later, mixing/stirring a liquid mixture of the fuel oil and water to be fluidized in a meandering state while repeating shear-shaped diversion and compressive confluence by means of a centrifugal force; and a secondary mixing treatment course of, by means of a stationary fluid mixer 11 which will be described later, performing secondarily mixing/treating the primarily mixed/treated liquid mixture to be fluidized in a meandering state while repeating shear-shaped diversion and compressive confluence by means of a pressure-feed force, and provides a fine-air feed course of feeding fine air as required prior to the secondary mixing treatment course.

Further, in the primary mixing treatment course, a fuel oil and water are uniformly stirred/mixed by means of the rotary stirring mixer 80 to form a liquid mixture; in a slight-amount-of air feed course, the slight amount of air in-taken through the suction pipe 3 is flowed, by means of the ejector effect, into the liquid mixture partway fed from the rotary stirring mixer 80 to the stationary fluid mixer 11 via the communication pipe 1; and in the secondary mixing treatment course, an emulsion fuel comprising fine air bubbles is continuously produced by gas-liquid mixing the liquid mixture and air by means of the stationary fluid mixer 11. Subsequently, the fine emulsion fuel comprising fine air bubbles is (appropriately) fed to combustion equipment (burner) 6 or the like (via a reservoir section which will be described later, as required).

In the thus produced emulsion fuel, since fine bubbles thus reduced in buoyancy is hydrophobic, the air bubbles do not adhere to the surfaces of water droplets but are dispersed in fuel oil, increasing the gas-liquid interfacial area (combustion surface area) and exerting surface activity (similar to the function of a surfactant) through electrostatic polarization. This makes it possible to prevent the fine water droplets from coalescence, and then, stabilize the water droplets in the emulsion fuel.

As a result, in the emulsion fuel, dispersion of water droplet diameters becomes uniform; and the emulsion fuel is combusted by means of combustion equipment, for example, whereby good combustion efficiency can be ensured; and the disadvantage that soot or black smoke is generated can be eliminated. The abovementioned emulsion fuel comprising fine air bubbles can also be used as a fuel for combusting an internal combustion engine under an appropriate combustion condition, by adjusting a mixing ratio of fuel oil and water.

In particular, water droplets which are a dispersed phase are miniaturized to (2 to 5 microns) by means of the rotary stirring mixer 80 as a primary treatment; and the miniaturized water droplets are stirred/mixed in fuel oil which as a continuous phase, and further, a uniformly dispersed liquid mixture is obtained. In the stationary fluid mixer 11 as a secondary treatment, the miniaturized water droplets, of course, and the fed fine air are formed as very fine air bubbles whose diameters are on the nano-level (less than 1 micron) to be mixed with a liquid mixture. The resultant liquid mixture is formed as an emulsion fuel comprising the very fine water droplets whose diameters are on the nano-level and air bubbles. This allows more increase of the gas-liquid interfacial surface area (combustion surface area) due to the very fine air bubbles and an increase of surface activity (similar to the function of surfactant) due to electrostatic polarization. Further, the coalescence of the very fine water droplets is prevented, allowing the water droplets to be stabilized more significantly in the emulsion fuel.

In addition, fuel oil itself is treated to be reformed by means of the abovementioned primary and secondary treatments. That is, the impurities contained in fuel oil, together with the slight amount of air intake, is miniaturized to (2 to 5 microns) by means of the rotary fluid mixer 80 as a primary mixing treatment section; and fuel oil is obtained as a primary reforming liquid having the impurities and air uniformly dispersed therein. In the stationary fluid mixer 11 as a secondary mixing treatment section, the fed fine impurities contained in the primary liquid mixture and fine air bubbles are ultra-miniaturized to the nano-level (less than 1 micron) in diameter, and these impurities and air bubbles are uniformly mixed/dispersed, whereby a secondary reforming liquid can be formed. In the embodiment, the particle size (average particle size) of 75% in volume under screening of fine impurities and fine air bubbles is obtained as those of at least 4 microns or less (preferably 2 microns or less, or alternatively, further preferably 0.95 micron to 1.5 microns) and air bubbles or impurities of 2 microns are obtained in mode diameter of 1 micron to 4 microns. Further, in order to obtain these fine impurities or air bubbles of desired average particle sizes, as required, it is possible to employ a circulation course of circularly feeding a reform treatment liquid to the rotary fluid mixer 80 and the stationary fluid mixer 11, and then, repeating reform treatment a predetermined number of times (10 times, for example) or for a predetermined period of time (for 20 minutes, for example) as described previously.

The fine impurities have their diameters of 1 micron to 200 microns in size; are rusts or corroded substances which can be mainly generated in distillation equipment, fluidized catalytic crackers, tanks, and pipes or the like; and contain iron oxide, iron sulfide, and iron chloride or the like. In addition, a variety of catalyses employed in oil refinery plant are finely grained. In the embodiment, those contained in fuel oil are referred to as fine impurities. The fine impurities can be filtrated by applying a fuel oil to a fine fuel filter, whereas there is a disadvantage that filtration efficiency is not good. Therefore, only relatively large fine impurities (100 microns or more, for example) are filtrated, and as to smaller fine impurities, the combustion efficiency of an emulsion fuel can be enhanced by refining and treating a fuel oil, as described above.

As a result, the emulsion fuel according to the embodiment is dispersed to oil droplets containing very fine water droplets and is completely combusted by means of combustion equipment, since the fine impurities or air bubbles are ultra-miniaturized in the oil droplets. Therefore, CO₂ can be reduced, allowing for prevention of global warming.

### Experimental Result

In addition, an emulsion fuel of volume ratio of “A” heavy oil:water=7:3 as a fuel oil was produced by mean of the first equipment A1 according to the present invention (using a stationary fluid mixer 11B of a third embodiment, which will be described later, as a stationary fluid mixer), and then, the emulsion fuel was fed to a burner as combustion equipment, and was burned; a combustion temperature reached 800 degrees centigrade 5 minutes after the start of combustion; reached 1,000 degrees centigrade 30 minutes after the start of combustion; and reached 1,150 degrees centigrade after 2 hours 30 minutes after the start of combustion. At this time, no black smoke was observed. Therefore, it was found that the emulsion fuel produced by means of the first equipment A1 according to the present invention is completely combusted at a high temperature of 1,100 degrees centigrade or above.

### Description of Equipment for the Production of Emulsion Fuel, as a Second Embodiment

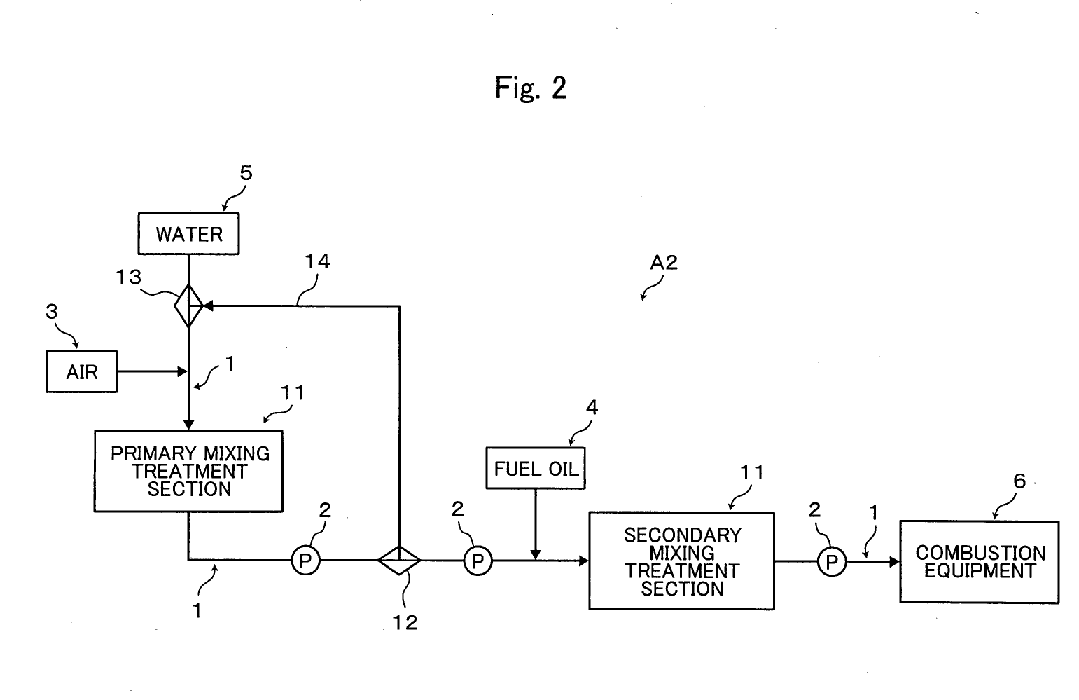

FIG. 2 is a conceptual view of equipment A2 for the production of emulsion fuel, as a second embodiment according to the present invention (hereinafter, referred to as “the second equipment”). The second equipment A2, as shown in FIG. 2, allows a water feed section 5 to be connected in communication with a stationary fluid mixer 11 as a primary mixing treatment section, via a communication pipe 1; a proximal end part of a suction pipe 3 to be connected in communication with a midcourse part of the communication pipe 1 and a distal end part of the suction pipe 3 to be opened in the ambient air. In addition, a stationary fluid mixer 11 as a secondary mixing treatment section is connected in communication with the abovementioned stationary fluid mixer 11, via a communication pipe 1; a pressure-feed pump 2 is provided at a midcourse part of the communication pipe 1; and an oil feed section 4 is connected in communication with a portion of the communication pipe 1, which is positioned at a downstream side of the pressure-feed pump 2. Further, between a portion of the communication pipe 1, which is positioned at an upstream side more than the proximal end part of the suction pipe 3, and a portion of the communication pipe 1, which is positioned at a downstream side more than the stationary fluid mixer 11 as the primary mixing treatment section, a return pipe 14 is interposed via first and second three-way valves 12, 13, allowing water mixed with air bubbles to be circulated in the stationary fluid mixer 11 through the return pipe 14.

In this manner, in the second equipment A2, in the primary mixing treatment course, water and air are treated to be mixed with each other by means of the stationary fluid mixer 11 as the primary mixing treatment section, thereby forming water mixed with fine air bubbles. Subsequently, in a secondary mixing treatment course, the water, which is mixed with the fine air bubbles, and fuel oil are treated to be mixed with each other by means of a stationary fluid mixer 11 as a second mixing treatment section, whereby an emulsion fuel comprising fine air bubbles can be formed, the emulsion fuel consisting of a fuel oil as a continuous phase, fine water droplets as a dispersed phase, and fine air bubbles. The final volume ratio of fuel oil, water, and air, of the emulsion fuel is similar to those of the emulsion fuel as the first embodiment, so that in a volume ratio of fuel oil:water=8:2, the volume ratio of air can be set to be 2% of the volume (predetermined flow rate) of a liquid mixture thereof.

Thus, in the primary mixing treatment course, water and air are treated to be mixed with each other in advance to form water mixed with fine air bubbles, whereby miniaturization of a very small amount of air to be added can be reliably performed. At this time, the water mixed with air bubbles is circulated in the stationary fluid mixer 11 for a predetermined period of time, whereby required miniaturization of air bubbles and an increased amount of air bubbles can be achieved.

Thus, in the subsequent secondary mixing treatment course, a liquid mixture consisting of a fuel oil as a continuous phase, fine water droplets as a dispersed phase, and fine air bubbles can be formed by means of the stationary fluid mixer 11 as the secondary mixing treatment section, allowing an emulsion fuel mixed fine air bubbles to be readily and reliably produced inexpensively in a “one-pass” process.

In this case, in water as a dispersed phase, although fine air bubbles reduced in buoyancy exists, since the air bubbles are hydrophobic, the air bubbles do not adhere to the surfaces of water droplets, and are dispersed in fuel oil when they are mixed with fuel oil. As a result, a gas-liquid interfacial area (combustion surface area) is increased; surface activity (similar to the function of surfactant) is exerted by means of electrostatic polarization; and the coalescence of the miniaturized water droplets is prevented, allowing the water droplets to be stabilized in the emulsion fuel. Therefore, the diameters of the water droplets are uniformly dispersed in the emulsion fuel produced by the second equipment A2 as well; if the emulsion fuel is combusted by the combustion equipment 6, for example, good combustion efficiency can be ensured, and the disadvantage that soot or black smoke is generated can be eliminated.

### Description of Equipment for the Production of Emulsion Fuel, as a Third Embodiment

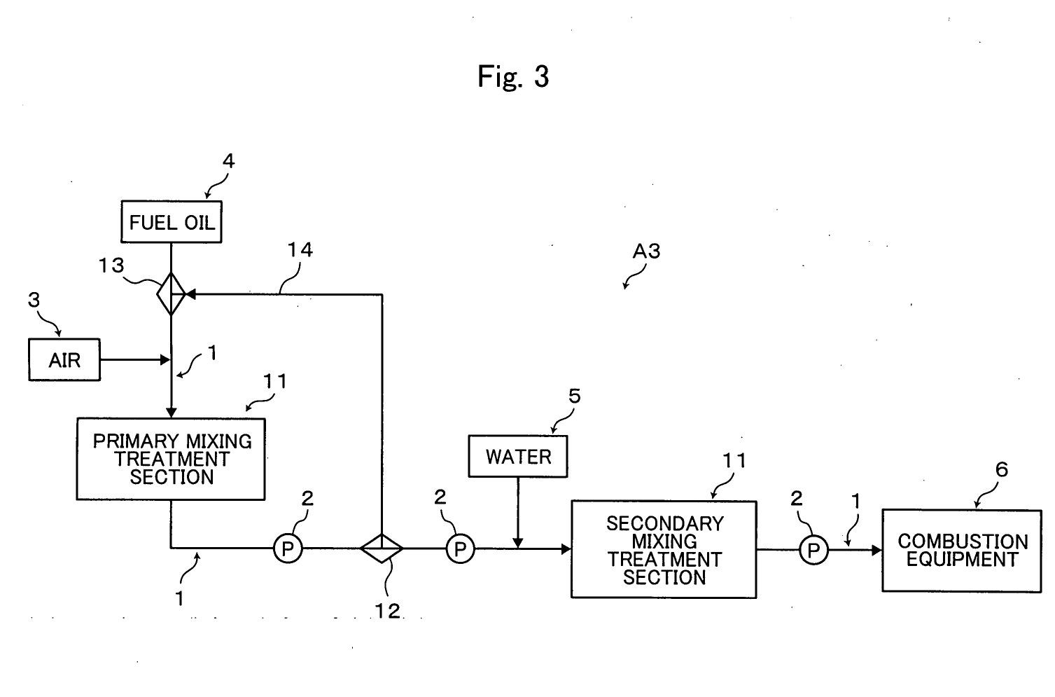

FIG. 3 is a conceptual view of equipment A3 for the production of emulsion fuel, as a second embodiment according to the present invention (hereinafter, referred to as “the third equipment”). The third equipment A3, as shown in FIG. 3, allows an oil feed section 4 to be connected in communication with a stationary fluid mixer 11 as a primary mixing treatment section via a communication pipe 1; a proximal end part of a suction pipe 3 to be connected in communication with a midcourse part of the communication pipe 1; and a distal end part of the suction pipe 3 to be opened in the ambient air. In addition, a stationary fluid mixer 11 as a secondary mixing treatment section is connected in communication with the abovementioned stationary fluid mixer 11 via the communication pipe 1; a pressure-feed pump 2 is provided at a midcourse part of the communication pipe 1; and a water feed section 5 is connected in communication with a portion of the communication pipe 1, which is positioned at a downstream side of the pressure-feed pump 2. Further, between a portion of the communication pipe 1, which is positioned at an upstream side more than the proximal end part of the suction pipe 3, and a portion of the communication pipe 1, which is positioned at a downstream side more than the stationary fluid mixer 11 as the primary mixing treatment section, a return pipe 14 is interposed via the first and second three-way valves 12, 13, allowing fuel oil mixed with air bubbles to be circulated in the stationary fluid mixer 11 through the return pipe 14.

In this manner, in the third equipment A3, in the primary mixing treatment course, fuel oil and air are treated to be mixed with each other by means of the stationary fluid mixer 11 as the primary mixing treatment section, thereby forming fuel oil mixed with fine air bubbles. Subsequently, in the secondary mixing treatment course, the fuel oil mixed with the fine air bubbles and water are treated to be mixed with each other by means of the stationary fluid mixer 11 as the secondary mixing treatment section, thereby making it possible to form an emulsion fuel comprising fine air bubbles, consisting of the fuel oil mixed with fine air bubbles as a continuous phase and fine water droplets as a dispersed phase. The final volume ratio of fuel oil, water, and air of the emulsion fuel is similar to that of the emulsion fuel as the first embodiment. For example, the volume ratio of fuel oil:water=8:2, and the volume ratio of air can be set to be 2%, for example, of the volume (predetermined flow rate) of a liquid mixture thereof.

Thus, in the primary mixing treatment course, the fuel oil and fine air are treated to be mixed with each other in advance, and the fuel oil mixed with fine air bubbles is formed, whereby miniaturization of a very small amount of air to be added can be reliably performed and fine air bubbles can be uniformly dispersed in the fuel oil. At this time, the fuel oil mixed with air bubbles is circulated in the stationary fluid mixer 11 for a predetermined period of time, whereby required miniaturization of air bubbles and an increased amount of air bubbles can be achieved.

In addition, in the subsequent secondary mixing treatment course, a liquid mixture consisting of fuel oil mixed with fine air bubbles as a continuous phase and fine water droplets as a dispersed phase can be formed. As a result, a gas-liquid interfacial area (combustion surface area) is increased; surface activity (similar to the function of surfactant) is exerted by means of electrostatic polarization; and the coalescence of the miniaturized water droplets is prevented, allowing the water droplets to be stabilized in the emulsion fuel. Therefore, in this case also, an emulsion fuel comprising fine air bubbles can be readily and reliably produced inexpensively in the “one-pass” process.

In this case, since the fine bubbles thus reduced in buoyancy is hydrophobic, the air bubbles are kept to be dispersed in fuel oil, and do not adhere to the surfaces of water droplets. As a result, the gas-liquid interfacial area (combustion surface area) is increased; surface activity (similar to the function of surfactant) is exerted by means of electrostatic polarization; and the coalescence of the miniaturized water droplets is prevented, allowing the water droplets to be stabilized in the emulsion fuel. Therefore, the diameters of the water droplets are uniformly dispersed in the emulsion fuel produced by the third equipment A3 as well; if the emulsion fuel is combusted by the combustion equipment 6, for example, good combustion efficiency can be ensured, and the disadvantage that soot or black smoke is generated can be eliminated.

### Description of Equipment for the Production of Emulsion Fuel, as a Fourth Embodiment

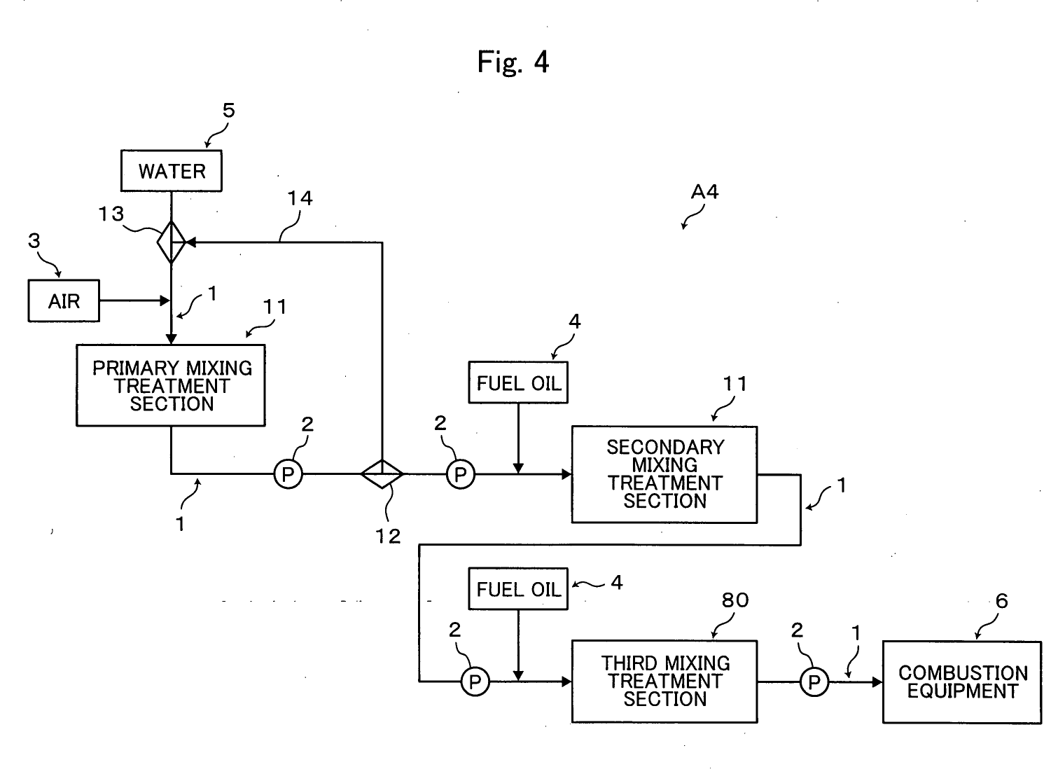

FIG. 4 is a conceptual view of equipment A4 for the production of emulsion fuel, as a fourth embodiment according to the present invention (hereinafter, referred to as “the fourth equipment”). The fourth equipment A4, as shown in FIG. 4, is provided with: a rotary stirring mixer 80 as a third mixing treatment section to be connected in communication with the stationary fluid mixer 11 as the secondary mixing treatment section of the aforementioned second equipment A2 via a communication pipe 1; a pressure feed pump 2 to be provided at a midcourse part of the communication pipe 1; and an oil feed section 4 to be connected in communication with a portion of the communication pipe 1, which is positioned at a downstream side of the pressure-feed pump 2.

In this manner, in the fourth equipment A4, in the primary mixing treatment course, water and air are treated to be mixed with each other by means of the stationary fluid mixer 11 as the primary mixing treatment section, thereby forming water mixed with fine air bubbles. Subsequently, in the secondary mixing treatment course, by means of the stationary fluid mixer 11 as the secondary mixing treatment section, the water mixed with fine air bubbles, and fuel oil (water:fuel oil=7:3 in volume ratio, for example) are treated to be mixed with each other, forming a liquid mixture consisting of water as a continuous phase and fine oil droplets as a dispersed phase. Further subsequently, in a third mixing treatment course, by means of a rotary stirring mixer 80 as a third mixing treatment section, the liquid mixture and fuel oil (for example, the final volume ratio of fuel oil and water is fuel oil:water=8:2 and the volume ratio of air is 2%, for example, of the volume (predetermined flow rate) of a liquid mixture thereof) are treated to be mixed with each other, thereby making it possible to produce an emulsion fuel comprising fine air bubbles, consisting of a fuel oil as a continuous phase, fine oil droplets as a dispersed phase, and water droplets containing fine air bubbles. The final volume ratio of fuel oil, water, and air, of the emulsion fuel can be set to be similar to that of the aforementioned emulsion fuel as the first embodiment.

Thus, an emulsion fuel of fuel oil/water mixed with air bubbles/fuel oil (O/W/O) type, characterized by: water mixed with air bubbles by treating water and air to be mixed with each other; a liquid mixture employing the water mixed with air bubbles as a continuous phase and employing a fuel oil as a dispersed phase; a fuel oil employing the liquid mixture as a dispersed phase and employing a fuel oil as a continuous phase, can be readily and reliably produced inexpensively as an emulsion fuel mixed with fine air bubbles in the “one-pass” process.

In this case, expansion due to rapid evaporation of water droplets, which is a feature of emulsion fuel, is further accelerated because of a combustion heat of very fine oil droplets (nano-level or submicron level) in water droplets. At this time, since air bubbles which is hydrophobic do not adhere the surface of the water droplets, the gas-liquid interfacial area (combustion surface area) is increased and surface activity (similar to the function of surfactant) is exerted due to electrostatic polarization, thus preventing coalescence of the fine water droplets and allowing the water droplets to be stabilized in emulsion fuel. Thus, the emulsion fuel produced by the fourth equipment A4 is combusted by means of combustion equipment 6, for example, whereby combustion efficiency can be further enhanced and the disadvantage that soot or black smoke is generated can be reliably eliminated.

### Description of Equipment for the Production of Emulsion Fuel, as a Fifth Embodiment

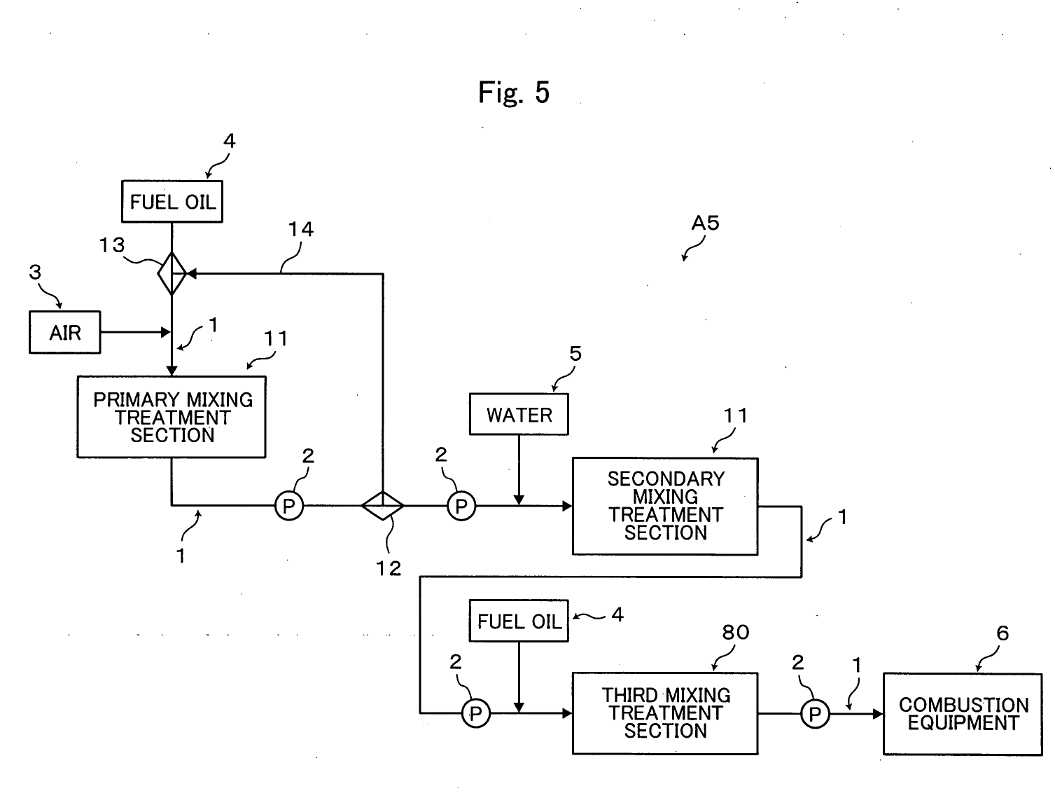

FIG. 5 is a conceptual view of equipment for the production of emulsion fuel, as a fifth embodiment according to the present invention (hereinafter, referred to as “the fifth equipment”). The fifth equipment A5, as shown in FIG. 5, is provided with: a rotary stirring mixer 80 as a third mixing treatment section to be connected in communication with the stationary fluid mixer 11 as the secondary mixing treatment section of the aforementioned third equipment A3 via a communication pipe 1; a pressure-feed pump 2 to be provided at a midcourse part of the communication pipe 1; and an oil feed section 4 to be connected in communication with a portion of the communication pipe 1, which is positioned at a downstream side of the pressure-feed pump 2.

In this manner, in the fifth equipment A5, in the primary mixing treatment course, a fuel oil and air are treated to be mixed with each other by means of the stationary fluid mixer 11 as the primary mixing treatment section, forming a fuel oil mixed with fine air bubble. Subsequently, in the secondary mixing treatment course, the fuel oil mixed with fine air bubbles and water (fuel oil: water=3:7 in volume ratio, for example) are treated to be mixed with each other by the stationary fluid mixer 11 as the secondary mixing treatment section, forming a liquid mixture consisting of water as a continuous phase, fine oil droplets as a dispersed phase, and fine air bubbles. Further subsequently, in the third mixing treatment course, the liquid mixture and fuel oil (for example, the final volume ratio of fuel oil and water is fuel oil:water=8:2 and the volume ratio of air is set at 2% of the volume (predetermined flow rate) of the liquid mixture thereof) are treated to be mixed with each other by means of the rotary stirring mixer 80 as the third mixing treatment section, thereby making it possible to produce an emulsion fuel comprising fine air bubbles, consisting of a fuel oil as a continuous phase, fine oil droplets as a dispersed phase, and water droplets mixed with fine air bubbles. The final volume ratio of fuel oil, water, and air, of the emulsion fuel, can be set to be similar to that of the aforementioned emulsion fuel as the first embodiment.

Thus, an emulsion fuel of fuel oil mixed with fine air bubbles/water/fuel oil (O/W/O) type, characterized by: a fuel oil mixed with fine air bubbles by treating fuel oil and air to be mixed with each other; a liquid mixture employing the fuel oil mixed with fine air bubbles as a dispersed phase and employing water as a continuous phase; and a fuel oil mixed with fine air bubbles, which employs the liquid mixture as a dispersed phase and employs a fuel oil as a continuous phase, can be readily and reliably produced inexpensively as an emulsion fuel mixed with fine air bubbles in the “one-pass” process.

In this case also, expansion due to sudden evaporation of water droplets, which is a feature of emulsion fuel, is further accelerated owing to a combustion heat of very fine oil droplets (in the nano-level or submicron level) in water droplets. At this time, since air bubbles which is hydrophobic do not adhere the surface of the water droplets, remained dispersed in the fuel oil, the gas-liquid interfacial area (combustion surface area) is increased and surface activity (similar to the function of surfactant) is exerted due to electrostatic polarization, thus preventing coalescence of the fine water droplets and allowing the water droplets to be stabilized in emulsion fuel. Thus, the emulsion fuel produced by means of the fifth equipment A5 is combusted by means of combustion equipment 6, for example, whereby combustion efficiency can be further enhanced and the disadvantage that soot or black smoke is generated can be reliably eliminated.

### Description of Equipment for the Production of Emulsion Fuel, as a Sixth Embodiment

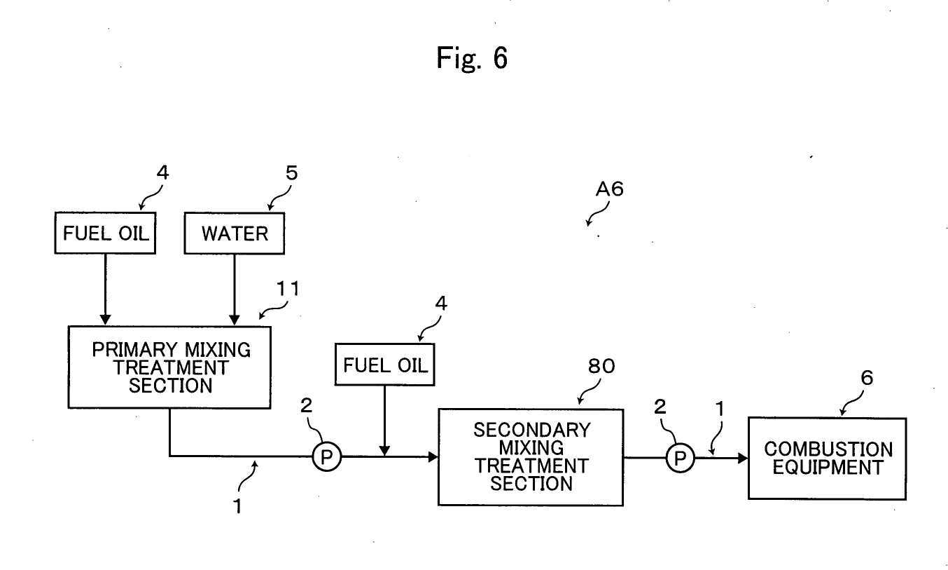

FIG. 6 is a conceptual view of equipment A6 for the production of emulsion fuel, as a sixth embodiment according to the present invention (hereinafter, referred to as “the sixth equipment”). The sixth equipment, as shown in FIG. 6, is provided with: a feed-oil section 4 for feeding a predetermined amount of fuel oil by means of an oil feed pump or the like; a water feed section 5 for feeding a predetermined amount of water by means of a water feed pump or the like; a stationary fluid mixer 11 as a primary mixing treatment section for preliminarily uniformly stirring/mixing the fuel oil and water fed from these oil feed section 4 and water feed section 5; a rotary stirring mixer 80 as a secondary mixing treatment section for further stirring/mixing the liquid mixture stirred/mixed by means of the stationary fluid mixer 11; and a communication pipe 1 as a communication section interposed between the mixers 11 and 80. At a midcourse part of the communication pipe 1, a pressure-feed pump 2 is provided for pressure-feeding a predetermined amount of liquid mixture from the stationary fluid mixer 11 to the rotary stirring mixer 80; and an oil feed section 4 for feeding a predetermined amount of fuel oil by means of an oil feed pump or the like is connected in communication with a midcourse part of the communication pipe 1, which is positioned at a downstream side of the pressure-feed pump 2.

In this manner, in the sixth equipment A6, in the primary mixing treatment course, water and a fuel oil (water:fuel oil=7:3 in volume ratio, for example) is treated to be mixed with each other by means of the stationary fluid mixer 11 as the primary mixing treatment section, thereby forming a liquid mixture consisting of water as a continuous phase and fine oil droplets as a dispersed phase. Subsequently, in the secondary mixing treatment course, the liquid mixture and fuel oil (the final volume ratio of fuel oil and water is set so that fuel oil:water=8:2) are treated to be mixed with each other by mean of the rotary stirring mixer 80 as the secondary mixing treatment section, thereby making it possible to produce an emulsion fuel consisting of a fuel oil as a continuous phase and fine oil droplets as a dispersed phase. The final volume ratio of fuel oil and water of the emulsion fuel can be set to be similar to that of the aforementioned emulsion fuel as the first embodiment.

Thus, an emulsion fuel of fuel oil/water/fuel oil (O/W/O) type, characterized by: a liquid mixture in which water is employed as a continuous phase and a fuel oil is employed as a dispersed phase, wherein the liquid mixture is employed as a dispersed phase and the fuel oil is employed as a continuous phase, can be readily and reliably produced inexpensively in the “one-pass” process.

In this case also, expansion due to rapid evaporation of water droplets, which is a feature of emulsion fuel, is further accelerated owing to a combustion heat of very fine oil droplets (in the nano-level or submicron level) in water droplets. Therefore, the emulsion fuel produced by means of the sixth equipment A6 is combusted by means of the combusting equipment 6, whereby good combustion efficiency can be ensured.

### Description of Equipment for the Production of Emulsion Fuel, as a Seventh Embodiment

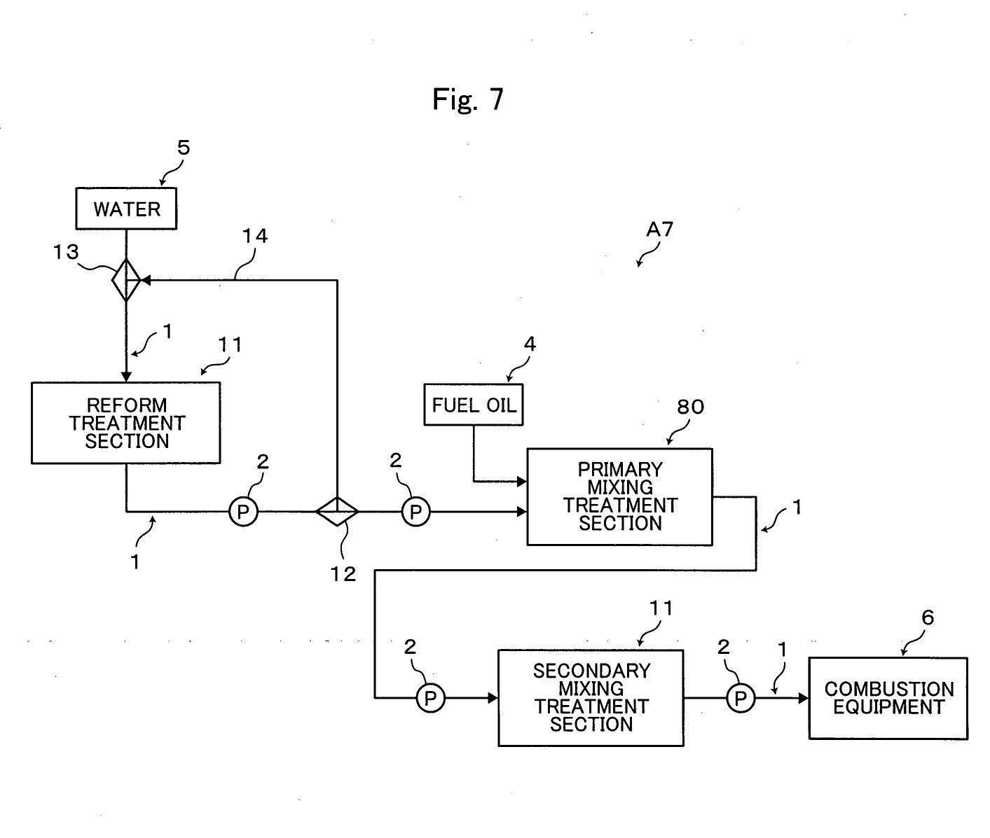

FIG. 7 is a conceptual view of equipment A7 for the production of emulsion fuel, as a seventh embodiment according to the present invention (hereinafter, referred to as “the seventh equipment”). The seventh equipment A7, as shown in FIG. 7, is provided with: a water feed section 5 for feeding a predetermined amount of water by means of a water feed pump or the like; a stationary fluid mixer 11 as a reform treatment section for reform treatment of the water fed from the water feed section 5 to form reformed treated water (hereinafter, referred to as “reformed water”); an oil feed section 4 for feeding a predetermined amount of fuel oil by means of an oil feed pump or the like; a rotary stirring mixer 80 as a primary mixing treatment section for preliminarily uniformly stirring/mixing the fuel oil and reformed water fed from these oil feed section 4 and stationary fluid mixer 11 as a reform treatment section; a stationary fluid mixer 11 as a secondary mixing treatment section for further stirring/mixing the liquid mixture stirred/mixed by means of the rotary stirring mixer 80; and a communication pipe 1 as a communication section interposed between the mixers 11 and 80. At a midcourse part of the communication pipe 1, a pressure-feed pump 2 is provided for pressure-feeding a predetermined amount of liquid mixture to the stationary fluid mixer 11 or the rotary stirring mixer 80. The stationary fluid mixer 11 as a reform treatment section can be appropriately used as the one which is smaller in size than the stationary fluid mixer 11 as the secondary mixing treatment section.

In addition, between a portion of the communication pipe 1, which is positioned at an upstream side more than the stationary fluid mixer 11 as a reform treatment section, and a portion of the communication pipe 1, positioned at a downstream side more than the stationary fluid mixer 11 as the reform treatment section, a return pipe 14 is interposed via first and second three-way valves 12, 13, allowing reformed water to be appropriately circulated through the return pipe 14. That is, both of the first and second three-way valves 12, 13 are manipulated to be switched as required, whereby reformed water is fed to the stationary fluid mixer 11; and reform treatment is repeated a predetermined number of times (10 times, for example) or for a predetermined period of time (for 15 minutes, for example), whereby a degree of reforming can be enhanced. The degree of reforming designates the degree of reform treatment so as to reduce a cluster (which is an assembly and is in the state of (H₂O)n) formed when a lot of water molecules are bonded with each other by means of hydrogen bonding between water molecules, namely so as to reduce the number of water molecules adjacent to each other, existing around given water molecules, to its possible minimum.

In this manner, in the seventh equipment A7, in the reform treatment course, the water as a dispersed phase is treated to be reformed in advance by means of the stationary fluid mixer 11 as a reform treatment section, thereby forming reformed water which is reduced in the number of water molecules adjacent to each other, existing around given water molecules, and which is homogenized in miniaturized particle size of the water. In addition, in the primary mixing treatment, the reformed water and fuel oil are treated to be mixed with each other by means of the rotary stirring mixer 80 as the primary mixing treatment, at a ratio of reformed water:fuel oil=2:8 in volume ratio, for example, and then, are mixed to be uniformly miniaturized (in the micron level of several microns to several tens of microns) in a state in which the particles of the homogenized reformed water are enwrapped with those of fuel oil. Subsequently, in the secondary mixing treatment, the liquid mixture is treated to be mixed by means of the stationary fluid mixer 11 as the secondary mixing treatment section, whereby the liquid mixture is mixed to be uniformly miniaturized (in the nano-level or submicron level) in a state in which the particles of the homogenized reformed water is enwrapped with those of fuel oil. The final volume ratio of reformed water and fuel oil, of the emulsion fuel, can be set to be reformed water:fuel oil=1 to 3:9 to 7.

Thus, the reformed water that is miniaturized and homogenized by means of the stationary fluid mixer 11 is employed as a dispersed phase in advance; a fuel oil is employed as a continuous phase; primary mixing treatment is performed by means of the rotary stirring mixer 80; and further, secondary mixing treatment is performed by means of the stationary fluid mixer 11, whereby an emulsion fuel can be readily and reliably produced inexpensively in the “one-pass” process.

In this case also, expansion due to sudden evaporation of water droplets, which is a feature of emulsion fuel, is further accelerated owing to a combustion heat of very fine oil droplets (in the nano-level or submicron level) in water droplets. Therefore, the emulsion fuel produced by means of the seventh equipment A7 is combusted by means of the combustion equipment 6, for example, making it possible to ensure good combustion efficiency.

### First Experimental Result

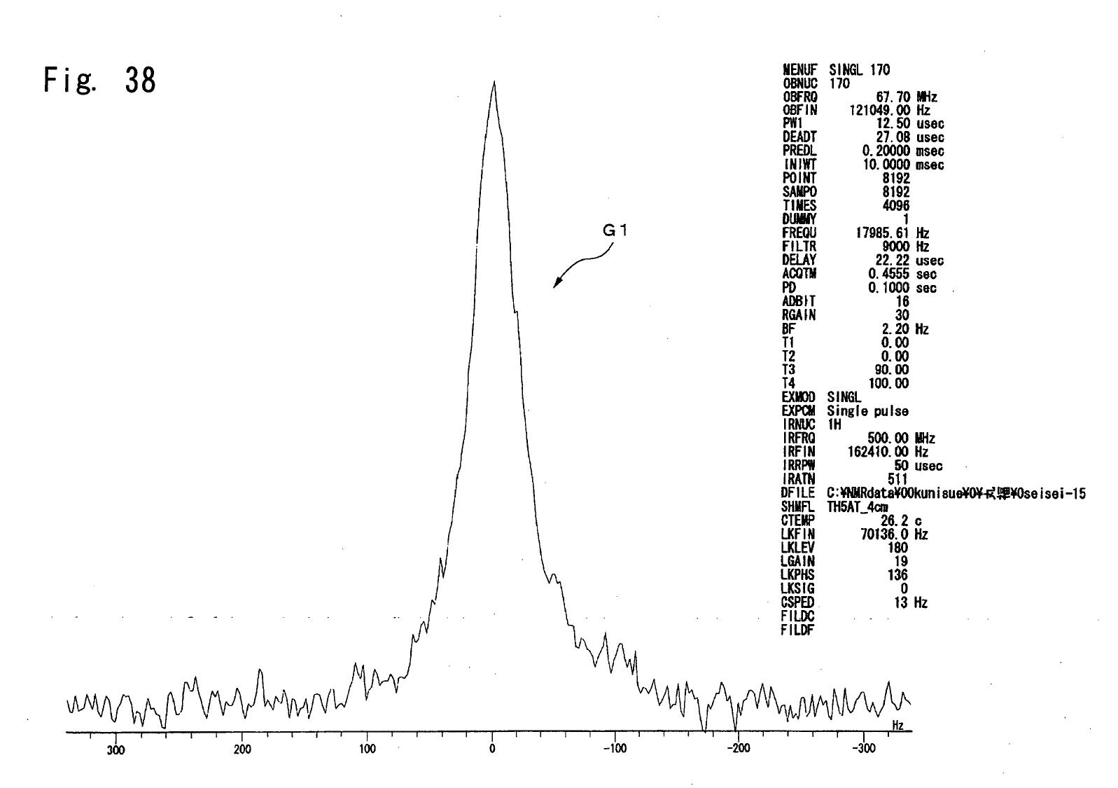

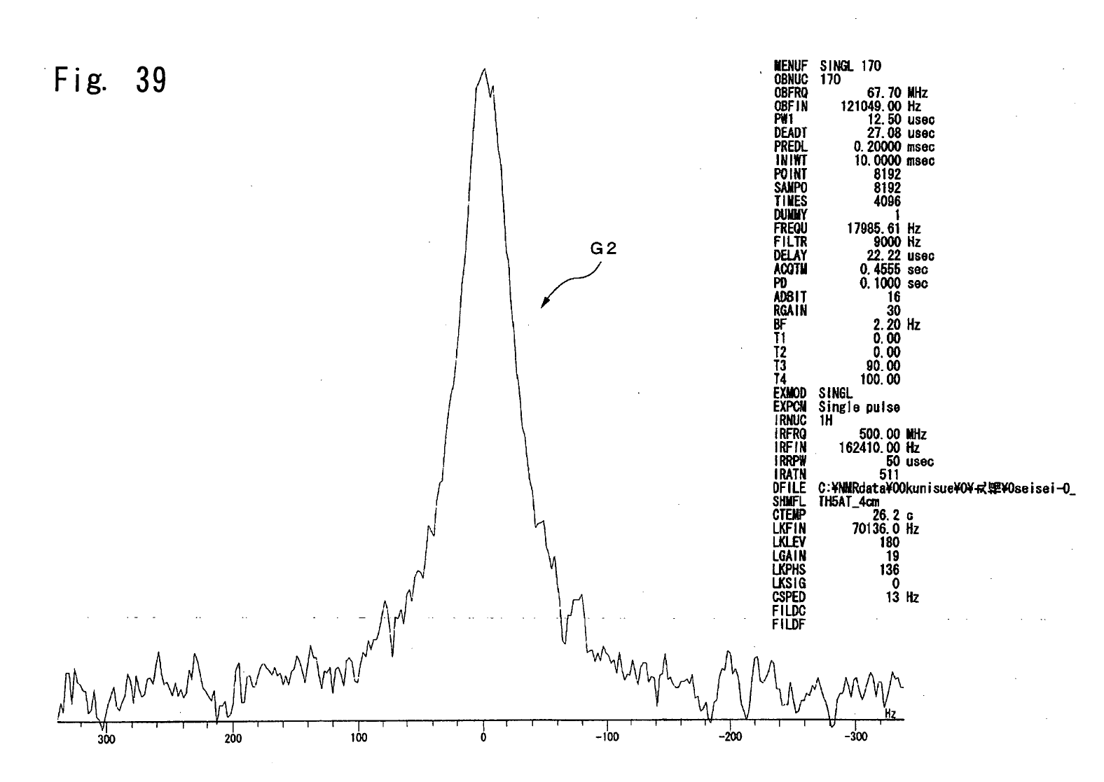

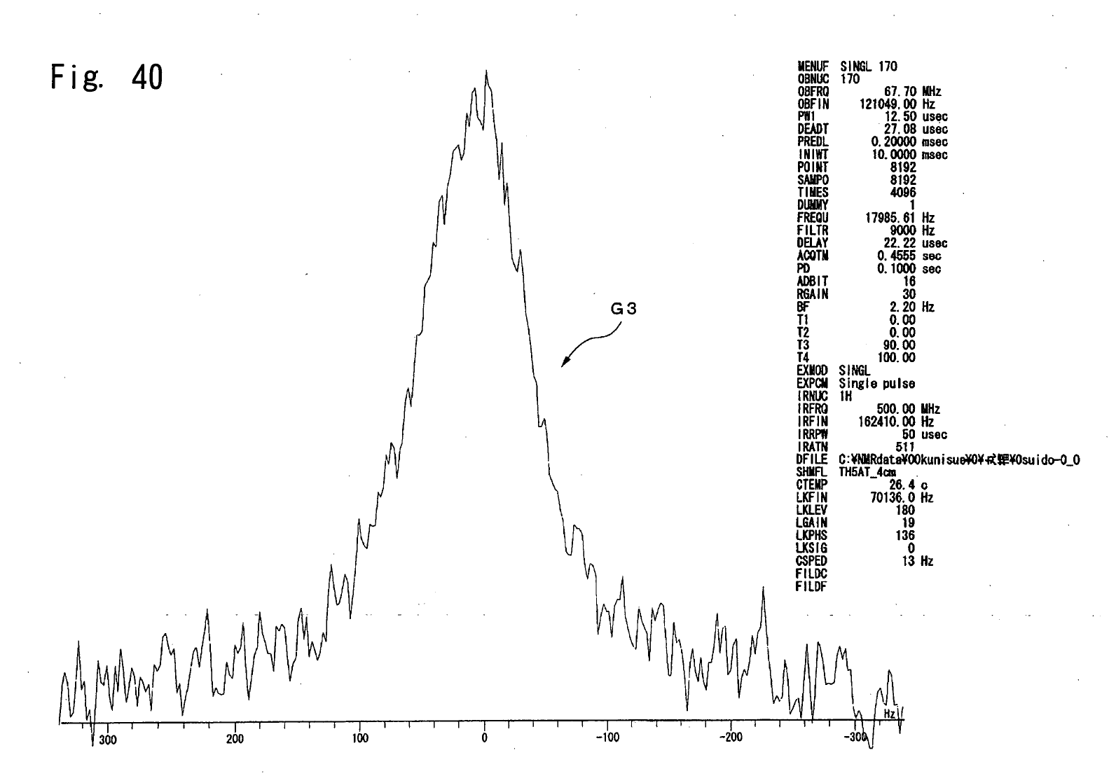

Next, reform treatment experiment using a stationary fluid mixer as a reform treatment section and its related result will be described. Reform treatment of refined water was performed using a stationary fluid mixer 11B of the third embodiment, which will be described later, as a stationary fluid mixer, and repeatedly circulating refined water (refined water free of impurities) in the stationary fluid mixer 11B for fifteen minutes. In addition, as to the reformed water that was treated to be reformed, a half-width was measured by means of NMR “Nuclear Magnetic Resonance” (hereinafter, referred to as “¹⁷O-NMR”) while ¹⁷O (oxygen nucleus) is targeted to be measured. JNM-A500 available from JEOL, Ltd. was used as an measuring instrument; the measurement temperature was set at 26.2 degrees centigrade (which is a numeric value in chart CTEMP); and the measurement condition was: estimation of 4,096-times (which is a numeric value of chart TIMES); a repetition time of 0.1 second (which is a numeric value of chart PD); and 90-pulse (chart PW1=12.5 microseconds) and no lock measurement. Graph G1 shown in FIG. 38 is a graph indicating a measurement result of the reformed water, obtained using ¹⁷O-NMR. As the result of measuring a half-width of reformed water from this graph G1, the half-width=43.9 Hz was obtained. Graph G2 shown in FIG. 39 is a graph indicating a measurement result of refined water (unreformed) targeted for comparison using ¹⁷O-NMR. As the result of measuring a half-width of refined water from this graph G2, the half-width=50.497 Hz was obtained. Graph G3 shown in FIG. 40 is a graph indicating a measurement result of tap water (unreformed) targeted for comparison using ¹⁷O-NMR. As the result of measuring the half-width of tap water from this graph G3, the half-width=96.602 Hz was obtained.

In this manner, it was found that the half-width of reformed water narrows, i.e., is about 80% of refined water (unreformed) and about 45% of tap water (unreformed). A narrow half-width denotes that: hydrogen and oxygen, of water molecules resonate with each other; and molecular motion becomes active. Therefore, it is contemplated that the cluster of reformed water is reformed to be smaller than that of refined water (unreformed) or tap water (unreformed).

Next, an emulsion fuel was produced by treating the abovementioned reformed water and “A” heavy oil as a fuel oil to be mixed with each other by means of the seventh equipment A7 (the stationary fluid mixer 11B of the third embodiment, which will be described later, was used as a stationary fluid mixer serving as a second mixing treatment section). At this time, the mixing ratios of reformed water and “A” heavy oil were such that reformed water: “A” heavy oil in volume rate is 1.9 (a first pattern); 1.5:8.5 (a second pattern); 2:8 (a third pattern); 2.5:7.5 (a fourth pattern); and 3:7 (a fifth pattern). In addition, only “A” heavy oil was a sixth pattern (“A” heavy oil burning). Each of the abovementioned fuel oils of the first to sixth patterns was fed to a burner as the combustion equipment 6 (Mechanical Gun Burner MGHA-91 available from Corona Corporation); the inside of a furnace was combusted by means of the burner; and time intervals required for the intra-furnace temperature to reach 900 degrees centigrade (required time intervals) were measured, respectively. Further, an intra-furnace temperature change with time was depicted as a graph, with an intra-furnace temperature axis being a vertical axis and a time axis being a horizontal axis.

As a result, the intra-furnace temperature change with time in each pattern was obtained as a curve graph. When all patterns are superimposed on each other, there was obtained a curve graph which is substantially identical to the case of the sixth pattern (combustion with only “A” heavy oil) leading up to the required time intervals in the emulsion fuels of the first to third patterns, whereas in each of the fourth and fifth patterns, the temperature gradient became gentle around 600 degrees centigrade and the required time interval became about 1.4 times to about 1.8 times in comparison with the case of the sixth pattern (combustion with only “A” heavy oil). Therefore, it was found that reformed water:fuel oil=2:8 (the third pattern) is preferable from the viewpoint of a fuel consumption rate in the area of 900 degrees centigrade. In addition, in the fifth pattern, which is flawed in a rise leading up to arrival at 900 degrees centigrade also, for example, it was found that the rise (required time interval) is very effective from the viewpoint of fuel consumption rate by combustion with only “A” heavy oil in the sixth pattern, and then, changing it to the fifth pattern, followed by continuously using the fifth pattern.

### Second Experimental Result

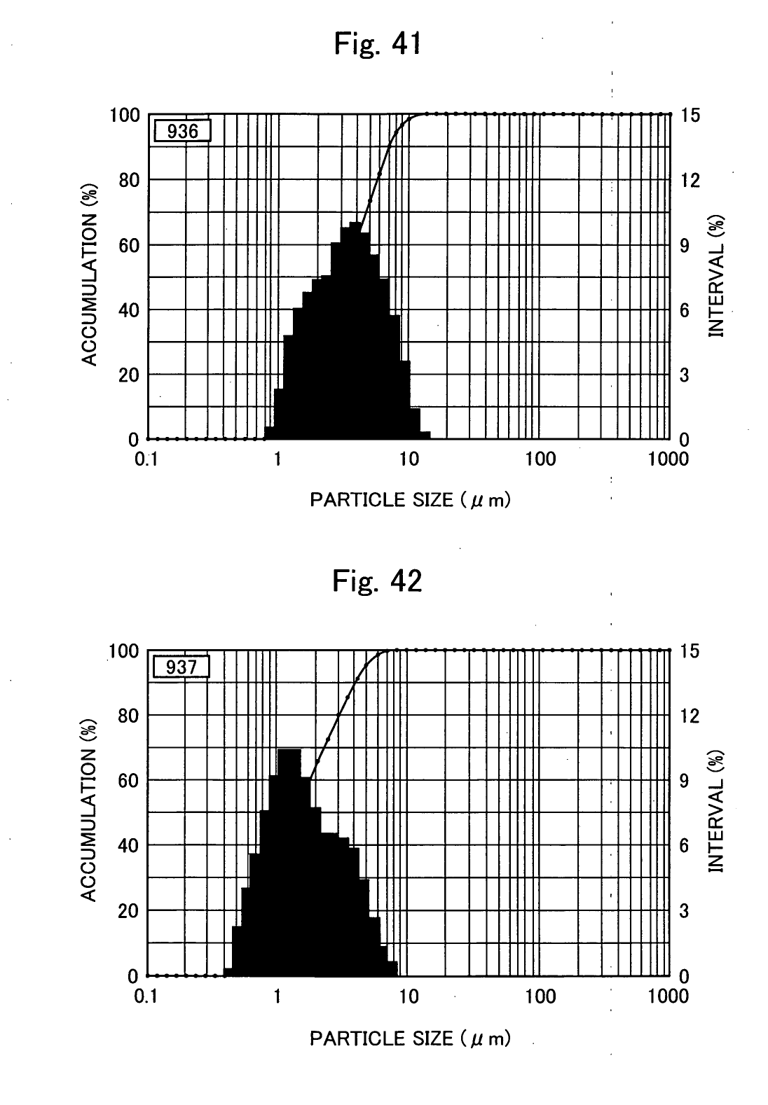

Next, an emulsion fuel was produced by means of the abovementioned seventh equipment A7 (a stationary fluid mixer 11B of the third embodiment, which will be described later, was used as a reform treatment section; a rotary fluid mixer 80, which will be described later, was used as a primary mixing treatment section; and a stationary fluid mixer 11B, which will be described later, was used as a secondary mixing treatment section). Specifically, refined water (refined water free of impurities) was first repeatedly circulated in the stationary fluid mixer 11B for fifteen minutes, thereby performing reform treatment of refined water; and the resultant refined water was used as reformed water. Next, “C”—heavy oil and the reformed water were fed to the rotary fluid mixer 80 in volume ratio of 8.5:1.5; and primary mixing treatment was performed for 5 minutes by mean of the rotary fluid mixer 80. Afterwards, the primarily mixed and treated liquid was repeatedly circulated in the stationary fluid mixer 11B only 5 times, and an emulsion fuel was produced as a secondarily mixed and treated liquid (finally treated liquid). In addition, the emulsion fuels that are the abovementioned primarily and secondarily mixed and treated liquids were employed as samples, respectively, and the particle size distribution measurement was performed as to the water droplets or fine impurities in each of the samples. At this time, each of the samples was diluted and measured by means of toluene (dispersant). FIG. 41 is a particle size distribution map of the primarily mixed and treated liquid, indicating a measurement result. Table 1 is a summarized data table indicating the measurement result.

TABLE 1
Comparison of miniaturization by mixer

| | | Rotary | Stationary |
|---|---|---|---|
| Summarized data | Units | fluid mixer | fluid mixer |
| Accumulated % diameter (10%) | μm | 1.391 | 0.731 |
| Accumulated % diameter (50%) | μm | 3.347 | 1.542 |
| Accumulated % diameter (90%) | μm | 7.210 | 4.086 |
| Specific surface area | | 2.206 | 4.368 |
| R R-N | | 2.2595 | 2.1216 |
| R R-B | | 3.268 × 10⁻² | 1.443 × 10⁻¹ |
| Normal distribution 50% | μm | 3.195 | 1.706 |
| Normal distribution σg | — | 1.759 | 1.850 |
| Sample concentration | mV | 2985 | 1875 |

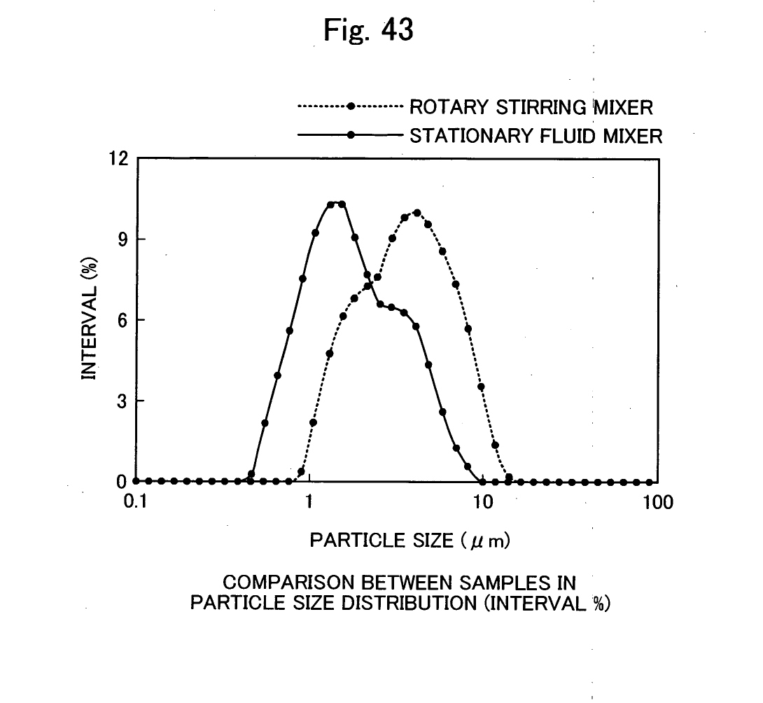

It was found that the particles of the water droplets or fine impurities in the primarily mixed and treated liquid are distributed in the range of 1 micron or slightly smaller to 10 microns or slightly greater, from the particle size distribution map of FIG. 41, and the particle size of 50% under screening is 3.347 microns from Table 1. Therefore, it was found that the water droplets or fine impurities in the primarily mixed and treated liquid are miniaturized (in the micrometer level) and are homogenized. FIG. 42 is a particle size distribution map of an emulsion fuel, indicating a measurement result. It was found that the particles of the water droplets or fine impurities in the emulsion fuel are distributed in the range of 0.4 or slightly smaller to 9 microns or slightly smaller, from the particle size distribution map of FIG. 42, and the particle size of 50% under screening is 1.542 microns from Table 1. Therefore, it was found that the water droplets or fine impurities in the emulsion fuel are miniaturized (in the nano-level or sub-micron level) and are homogenized. FIG. 43 is a view of inter-sample comparison of particle size distribution. From the figure, it was clearly recognized that there is a difference between: the situation of miniaturization (micrometer level) and homogenization of water droplets or fine impurities by means of the rotary fluid mixer 80; and the situation of ultra-miniaturization (nano-level or submicron level) and homogenization of the water droplets or fine impurities by means of the stationary fluid mixer 11B.

### Description of Equipment for the Production of Emulsion Fuel, as an Eighth Embodiment

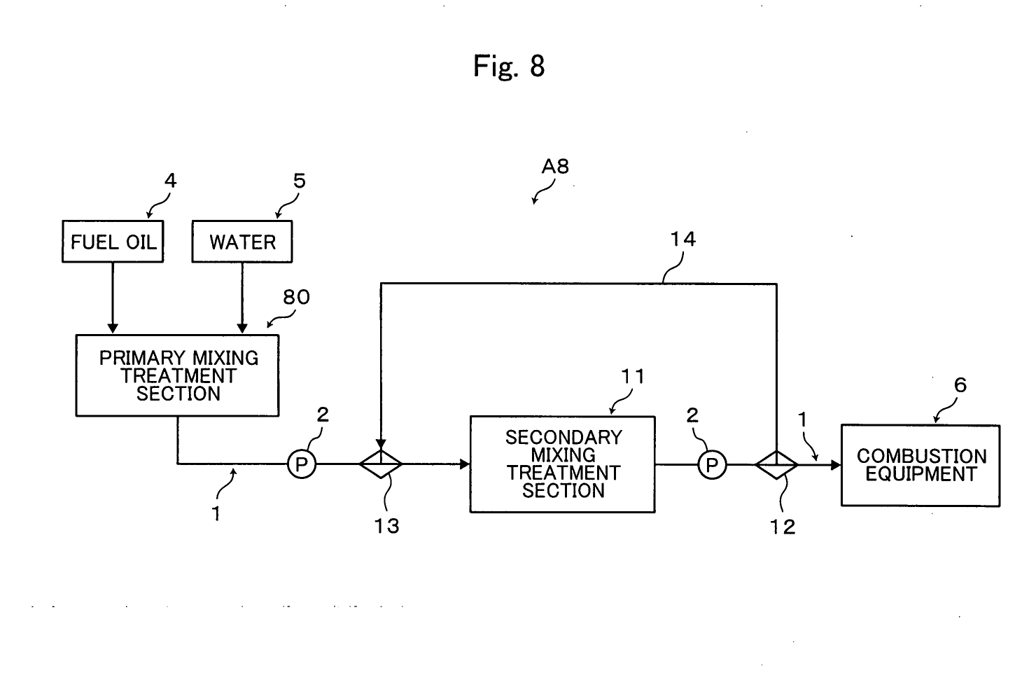

FIG. 8 is a conceptual view of equipment A8 for the production of emulsion fuel, as an eighth embodiment according to the present invention (hereinafter, referred to as “the eighth equipment”). The eighth equipment A8, as shown in FIG. 8, is identical to the first equipment A1 mentioned previously in basic configuration, whereas it is different therefrom in that a suction pipe 3 is not provided as a slight-amount-of-air intake section. That is, the eighth equipment A8 is provided with: a rotary stirring mixer 80 as a primary mixing treatment section for preliminarily uniformly stirring/mixing a fuel oil and water; and a stationary fluid mixer 11 as a secondary mixing treatment section for further stirring/mixing the liquid mixture stirred/mixed by means of the rotary stirring mixer 80. Both of the mixers 80, 11 are connected in communication with each other via a communication pipe 1 as a communication section, so as to pressure-feed a predetermined amount of a primarily treated liquid from the rotary fluid mixer 80 to the stationary fluid mixer 11 by means of a pressure-feed pump 2 which is provided at a midcourse part of the communication pipe 1.

In FIG. 1, reference numeral 4 designates an oil feed section for feeding a predetermined amount of fuel oil to the rotary stirring mixer 80 by means of an oil feed pump or the like; reference numeral 5 designates a water feed section for feeding a predetermined amount of water to the rotary stirring mixer 80 by means of a water feed pump or the like. Reference numeral 12 designates a first three-way valve; reference numeral 13 designates a second three-way valve; reference numeral 14 designates a return pipe interposed between the first and second three-way valves. Both of the first and second three-way valves 12, 13 are manipulated to be switched as required, whereby a liquid mixture is circularly fed to the stationary fluid mixer 11 through the return pipe 14, allowing mixing treatment to be repeated for a predetermined period of time.

In this manner, in the eighth equipment A8, in the primary mixing treatment course, the fuel oil as a continuous phase and the water as a dispersed phase (fuel oil:water=8:2 in volume ratio, for example) are finely and uniformly treated to be stirred/mixed by means of the rotary stirring mixer 80 as the primary mixing treatment section of the precedent stage, thereby forming a liquid mixture. Afterwards, in a secondary mixing treatment course, the resultant liquid mixture is fed from the rotary stirring mixer 80 to the stationary fluid mixer 11 as the secondary mixing treatment section of the subsequent stage through the communication pipe 1, and the liquid mixture is treated to be mixed very finely and uniformly by means of the stationary fluid mixer 11, so as to continuously produce an emulsion fuel. The emulsion fuel is fed to combustion equipment (burner) 6 or the like via the reservoir section to be described later, if necessary. The final volume ratio of fuel oil and water of the emulsion fuel can be set to be similar to that of the aforementioned emulsion fuel as the first embodiment.

At this time, by performing miniaturizing/mixing treatment of the precedent stage, the particles of water and the particle of fuel oil coming into enwrapping around them are mixed to be miniaturized and homogenized in advance. Afterwards, by performing ultra-miniaturizing/mixing treatment of the subsequent stage, the fine particles of fuel oil coming into enwrapping those of water are inexpensively produced as a stable emulsion fuel consisting of the ultra-miniaturized and homogenized particles of water and fuel oil by mixing stepwise from a fine level (micron level) to a very fine level (nano-level or submicron level).

As a result, in the obtained emulsion fuel, dispersion of water droplet diameters is homogenized; the emulsion fuel is combusted by means of combustion equipment, for example, whereby good combustion efficiency can be ensured; and a disadvantage that soot or black smoke is generated can be eliminated. The abovementioned emulsion fuel comprising fine air bubbles can also be used as a fuel for combusting an internal combustion engine under an appropriate combustion condition, by adjusting a mixing ratio of fuel oil and water.

In addition, the water droplets that are a dispersed phase are miniaturized (in 2 to 5 microns) by means of the rotary stirring mixer 80 as a primary treatment; and the miniaturized water droplets are stirred/mixed in a fuel oil which is a continuous phase, and further, are uniformly dispersed, thereby forming a liquid mixture. In the stationary fluid mixer 11 as a secondary treatment, an emulsion fuel comprising very fine water droplets whose diameters of the miniaturized water droplets are on the nano-level can be formed. As a result, the emulsion fuel is dispersed to oil droplets containing very fine water droplets, by means of combustion equipment, and is completely combusted. Therefore, CO₂ can be reduced, and global warming can be prevented.

Further, an opening amount adjustment valve (not shown), which is provided in the aforementioned first equipment A1 is adjusted to be closed, and air intake is stopped as well, thereby making it possible to produce an emulsion fuel similar to that produced by means of the eighth equipment A8.

### Comprehensive Experimental Result

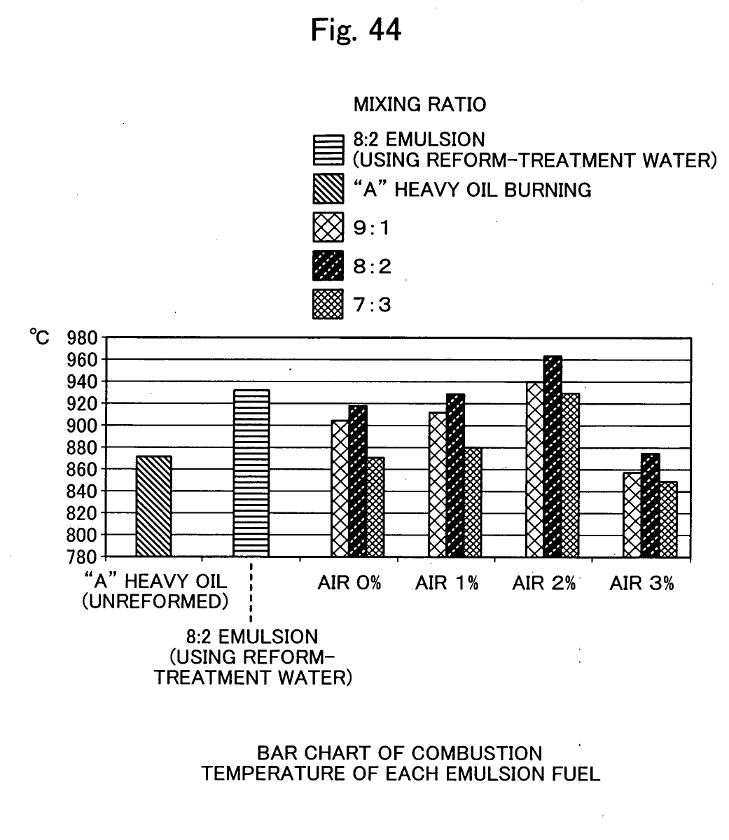

Next, an emulsion fuel whose amount of air intake is 1%, 2%, 3% of a volume of fuel oil+water; an emulsion fuel using reformed water; and an emulsion fuel whose amount of air intake is 0% were produced using the aforementioned first equipment A1, seventh equipment A7, and eighth equipment A8, respectively, and the combustion temperature of each of the emulsion fuels and the reduction rate of fuel consumption amount were compared. In each of pieces of the equipment A1, A7, A8, a stationary fluid mixer 11B which will be described later was used as a reform treatment section; a rotary fluid mixer 80 which will be described later was used as a primary mixing treatment section; and a stationary fluid mixer 11B which will be described later was used as a secondary mixing treatment section. In an emulsion fuel in which reformed water is not used, tap water was used. In addition, in the emulsion fuel using reformed water, a mixing ratio of “A” heavy oil as a fuel oil:reformed water=8:2 was set. In other emulsion fuels, mixing ratios of “A” heavy oil as a fuel oil:water (tap water)=9:1, 8:2, 7:3 was set. As Comparative Example, “A” heavy oil was combusted. Reformed water was produced by repeatedly circulating tap water in the stationary fluid mixer 11B for 20 minutes and treating the tap water to be reformed. An emulsion fuel was produced by feeding “A” heavy oil and tap water at a predetermined rate in the rotary fluid mixer 80 and the stationary fluid mixer 11B, and then, repeatedly circulating them for 20 minutes to be treated to be mixed with each other. At this time, a predetermined amount of air was fed after pressed into the liquid mixture. The emulsion fuels produced as described above and “A” heavy oil as Comparative Example each were fed to combustion equipment (Mechanical Gun Burner MGHA-161 available from Corona Corporation was used), and the combustion efficiency of the combustion equipment was experimented. Table 2 shows average values of temperature change from 30 minutes to 45 minutes after the start of combustion, which were calculated as combustion temperatures of an experimental result. FIG. 44 is a bar graph depicting the combustion temperature of each emulsion fuel shown in Table 2. The combustion temperature of the emulsion fuel using reformed water was 932 degrees centigrade. The combustion temperature of “A” heavy oil burning was 872 degrees centigrade. In comparison with the “A” heavy oil, the emulsion fuel was small in amount to be consumed until a temperature substantially identical thereto has reached. Table 3 shows reduction rates (fuel reduction rates) of the fuel consumption quantities of the emulsion fuels to “A” heavy oil burning.

TABLE 2
Combustion temperature data

Unit: degrees centigrade

| | Air | | Air | |
|---|---|---|---|---|
| Compounding ratio | amount | Air amount | amount | Air amount |
| (“A” heavy oil:water) | 0% | 1% | 2% | 3% |
| 9:1 | 905 | 912 | 940 | 858 |
| 8:2 | 918 | 929 | 963 | 875 |
| 7:3 | 871 | 879 | 930 | 849 |

TABLE 3
Fuel reduction rate

Unit: %

| | Air | | Air | |
|---|---|---|---|---|
| Compounding ratio | amount | Air amount | amount | Air amount |
| (“A” heavy oil: water) | 0% | 1% | 2% | 3% |
| 9:1 | 10.6 | 10.7 | 11.1 | 9.8 |
| 8:2 | 21.5 | 21.8 | 23.0 | 20.1 |
| 7:3 | 29.9 | 30.3 | 32.9 | 28.8 |

From these tables, it was found that the best fuel reduction rate is obtained in the emulsion fuel whose mixing ratio is “A” heavy oil:water (tap water)=8:2 and whose air amount is 2%; and the second best is obtained in the emulsion fuel using reformed water. In addition, it was found that the air quantities of 1%, 2% are effective as long as mixing ratio of “A” heavy oil:water (tap water)=8:2. Further, it was visually recognized that the emulsion fuel in mixing ratio of “A” heavy oil:water (tap water)=7:3 is not good in combustion stability in the temperature range of 900 degrees centigrade or more at the time of experimentation.

### Description Common to the Entire Equipment for the Production of Emulsion Fuel

The first equipment A1 to the eighth equipment A8 each can reform water and fuel oil while in mixing treatment, whereas it can reform water and fuel oil independently in advance. That is, a reform treatment section included in the seventh equipment A7, i.e., a reform treatment section for independently performing reform treatment of the water fed from a water feed section 5 to form the reform-treated water can be provided at the straight downstream side of each of the water feed sections 5 of each of pieces of the first to six equipment A1 to A6 and the eighth equipment A8. In that case, an effect in mixing treatment of the abovementioned reform-treated water and fuel oil can be obtained similarly. Further, a synergetic effect with effects uniquely attained by pieces of the first to eighth equipment can also be obtained.

In addition, a reform treatment section for independently performing reform treatment of the fuel oils fed from oil feed sections 4 to form a reform-treated oil (hereinafter, referred to as “reformed oil”) can also be provided at the straight downstream side of each of the oil feed sections 4 of pieces of the equipment A1 to A8. In the reform treatment section, the fine impurities or air bubbles in fuel oil are ultra-miniaturized and are homogenized, whereby reformed oil can be formed. Therefore, a wide variety of emulsion fuels can be formed by appropriately treating unreformed water, reformed water, unreformed oil, and reformed oil to be mixed with each other in combination, and a synergetic effect with the effects uniquely attained by each of pieces of the equipment A1 to A8 can also be obtained. As a result, a wide variety of emulsion fuels can be selected or employed more flexibly.

In the abovementioned first equipment A1 to eighth equipment A8, the residual reformed fuel oil produced when it is fed to the combustion equipment 6 is diverted from the communication pipe 1; the resultant fuel oil is reversed in a reservoir section (not shown); and the reserved oil is appropriately recycled from the reservoir section to the communication pipe 1 so as to be able to be fed to the combustion equipment 6. At this time, the reformed fuel oil can also be fed from the reservoir section to the combustion equipment 6 after reform treatment has been performed again by means of the stationary fluid mixer 11 and/or rotary stirring mixer 80. In addition, in the abovementioned first equipment A1 to eighth equipment A8, functional sections are automatically controlled by means of computer, whereby an emulsion fuel can be continuously and automatically produced.

The emulsion fuels produced by means of the first equipment A1 to eighth equipment A8 configured as described above are those in which water (or reformed water) and fuel oil (or reformed oil) are mixed in a high-pressure very fine state (on the order of 1 micron) and are finely mixed in a state in which the particles of water is wrapped by those of fuel oil. In other words, the water and fuel oil that are ultra-miniaturized under high pressure and are finely mixed with each other are obtained as a fuel as is, and thus, there is no need for emulsifier or the like. In the emulsion fuel, it is contemplated that an action, such as acceleration of molecular dynamics, cavitation (air bubbles or vaporizing action), or a latent heat, takes place. That is, in molecular dynamics, water molecules are destined for vaporization; a volume thereof is increased in an accelerative manner (H₂O density is decreased); and cavitation allows water particles to vaporize momentarily due to combustion of fuel oil, thus producing a pressure increase and a vibration. It is contemplated that the water molecules spread in an accelerative manner are held down due to a pressure increase exerted by cavitation, and at the same time, a shock is applied by means of vibration and a latent heat is generated, causing thermal conduction. Further, although no attenuation is observed in heat rate at the time of intra-furnace combustion of the combustion equipment 6, this is considered to be because the abovementioned state is established at the numeric value of 40.8 KJ/mol in water evaporation heat and 7.53 KJ/mol in heating thermal capacity from 0 degree centigrade to 100 degrees centigrade, and catenative transfer of thermal energy is performed, in consideration of special property of hydrogen bonding of water as well. Therefore, as to the heat rates of the emulsion fuels produced in the first equipment A1 to eight equipment A8, it is possible to say that the workings of exchange/transfer of heat rates, which cannot be described in mere comparison of the heat rates at the time of combustion possessed by substances thereof, are performed in combustion of the fine particles of different substances of the order of 1 micron.

Hereinafter, the structures of a rotary stirring mixer 80 and stationary fluid mixers 11 to 11E, which are appropriately employed as the first to third mixing treatment sections, will be specifically described, respectively.

### Description of a Rotary Stirring Mixer

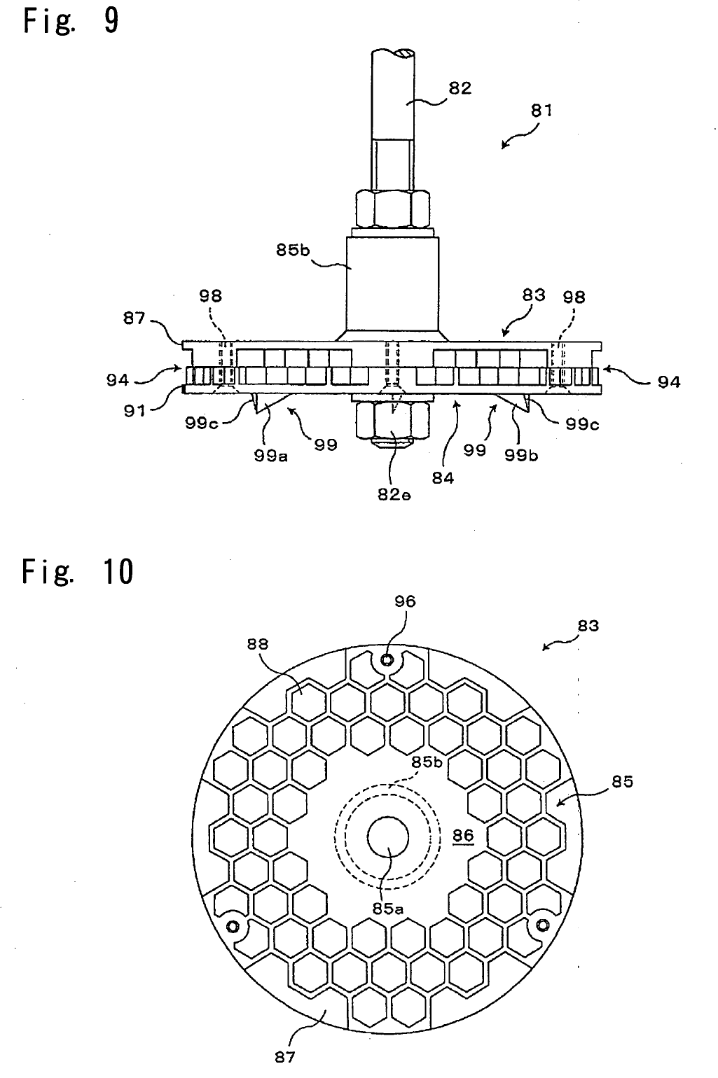

FIG. 9 is a side view of a stirring mixer main body 81 which is an essential part of the rotary stirring mixer 80. Basically, the rotary stirring mixer 80 is provided with: an accommodation tank (not shown) for accommodating untreated fluid to be stirred/mixed (fuel oil and water in the present invention); the stirring mixer main body 81 disposed in the accommodation tank, for stirring/mixing the stirred mixture to form a liquid mixture; and an electromotive motor (not shown) as a drive source for rotatably driving the stirring mixer main body 81. Each of the distal end part(s) of the oil feed section 4 and/or water feed section 5 is connected in communication with an upper part of the accommodation tank, and a proximal end part of the communication pipe 1 is connected in communication with a lower part of the accommodation tank.

The stirring mixer main body 81, as shown in FIG. 9, allows an upper end part of a rotary shaft 82 to be removably connected in conjunction with a drive shaft of the electromotive motor, allowing a pair of stirring members 83, 84 to be coaxially disposed and integrally connected to a lower end part of the rotary shaft 82, with the stirring members being vertically opposed to each other.

The upper stirring member 83, as shown in FIG. 10, is formed in a honeycomb shape while recessed portions 88 for forming a flow path, which are hexagonal from the bottom view in a radial direction and a circumferential direction, are densely formed in order on a bottom face of a stirring main body 85 formed in a disk shape with its predetermined thickness, with the exception of a center part 86 and an outer circumferential part 87 with its predetermined width. The center part 86 of the stirring main body 85 is formed to be flush with a bottom face of the recessed portions 88 for forming flow paths, whereas the outer circumferential portion 87 is formed to be flush with a top face of the recessed portions 88 for forming flow paths. Further, a rotary shaft through hole 85a is formed at a center position on the top face of the stirring main body 85 and a cylindrical connecting portion 85b is integrally connected in communication with the rotary shaft through hole 85a, on the top face of the stirring main body 85.

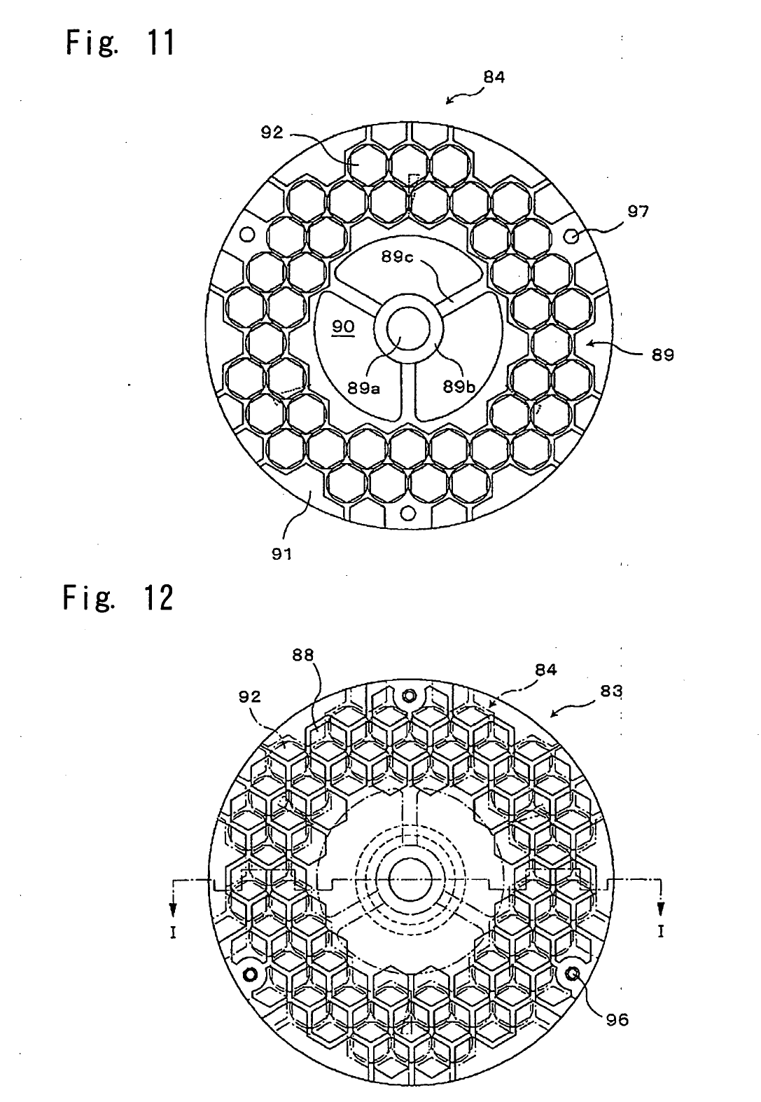

On the other hand, as shown in FIG. 11, the downward stirring member 84 opens while a flow inlet 90 as an flow inlet section is perforated in a vertical direction at the center part of the stirring main body 89 formed to be substantially identical to the abovementioned stirring main body 85 in size, i.e., in thickness and outer diameter. Further, on the top face of the stirring main body 89, with the exception of the outer circumferential portion 91 with its predetermined width, recessed portions 92 for forming flow paths, which are hexagonal from the bottom view in a radial direction and a circumferential direction, are densely formed in sequential order in a honeycomb shape. A boss section 89b having a rotary shaft through hole 89a is disposed at the center position of the stirring main body 89, i.e., at the center position of the flow inlet 90; and a boss section 89b is connected via a connecting piece 89c to an inner circumferential edge part of the stirring main body 89 forming the flow inlet 90.

In addition, as shown in FIG. 12, both of the stirring members 83, 84 are opposed to each other, allowing both of the rotary shaft through holes 85a, 89a to coincide with each other in a vertical direction and to be connected to each other in an overlapped manner. Reference numeral 82c designates a male screw portion formed at a lower end part of the rotary shaft 82; reference numerals 82d, 82e designate female screw portions; and reference numerals 82f, 82g designate washers. As shown in FIGS. 9 to 11, reference numeral 96 designates an upward screw hole; reference numeral 97 designates a downward screw hole; and reference numeral 98 designates a screw.

Moreover, the recessed portions 88, 92 for forming flow paths, which are formed in both of the rotors 83, 84, face to each other in a displaced state. That is, as shown in FIG. 7, the center part of the adjacent recessed portions 88 for forming flow paths are positioned at the center part of one recessed portion 92 for forming a flow path, facing to another one; and the center part of the adjacent three recessed portions 92 for forming flow paths are positioned at the center part of one recessed portion 88 facing to another one. Between the recessed portions 88 and 92 for forming flow paths, a stirring/mixing flow path 93 is formed through which a fluid to be treated flows in a radiation direction while meandering so as to diverge (in a shear manner) from one recessed portion 88(92) for forming a flow path while it is sheared by two recessed potions 92(88) facing to each other, and then, converge (in a compressive manner) from two recessed portions 88(92) for forming a flow path while it is compressed in one recessed portion 92(88) for forming a flow path, facing to another one. Further, between the outer circumferential part 87 of the upper rotor 83 and the outer circumferential part 91 of the lower rotor 84, a flow outlet 94 opening over the outer circumferential edge is formed as a flow outlet section.

In this manner, as shown in FIG. 13, a pair of upward and downward stirring members 83, 84 are rotated by means of an electromotive motor, a fluid R to be treated (which is indicated by the arrow in FIG. 13) inflows from a flow inlet 90 formed at the center part of the downward stirring member 84. In the stirring/mixing flow path 93, the fluid diverges from one recessed portion 88(92) for forming a flow path to two recessed portions 92(88) for forming flow paths, facing to another one, or alternatively, converts from the two recessed portions 88(92) for forming flow paths in one recessed portion 88(92) for forming a flow path, facing to another one. Afterwards, the fluid flows in the radiation direction, and outflows from the flow outlet 94 while repeating diversion and confluence, and moreover, meandering.

Sequentially, the fluid R to be treated, having flown out of the flow outlet 94, flows smoothly from an upward direction to a downward direction along the interior face of a peripheral wall of an accommodation tank, and then, upward from the bottom face of the accommodation tank, so as to be flown (circulated) in the flow inlet 90 again.

In this way, the fluid R to be treated, having flown out of the flow inlet 90, flows through the stirring/mixing flow path 93, is flown out of the flow outlet 94, and then, is in-flown from the flow inlet 90 so that a circulation flow path of the fluid R to be treated, of flow inlet 90->stirring mixing flow path 93->flow outlet 94->flow inlet 90 is formed. As a result, fine impurities (or air bubbles in some cases) are miniaturized while they are efficiently circulated, whereby fuel oil which is the fluid R to be treated can be reformed.

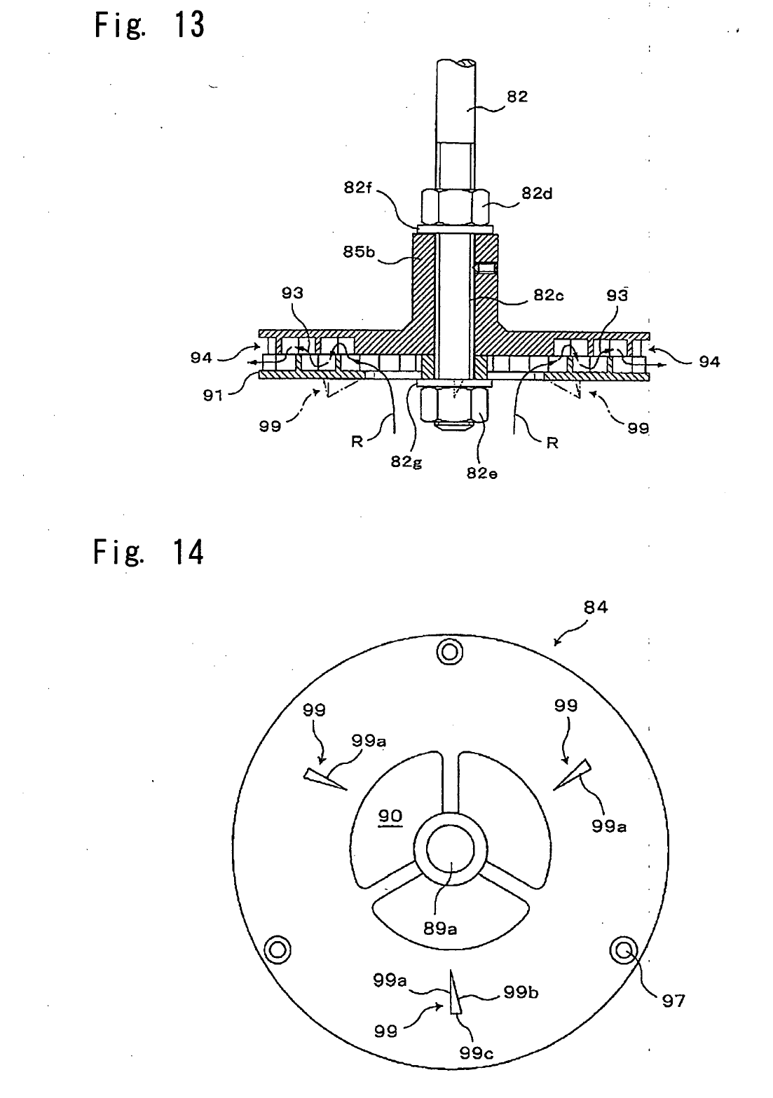

Moreover, as shown in FIGS. 9, 13, and 14, on the bottom face of the downward stirring member 84, a plurality of inflow acceleration blades 99 (3 blades in the embodiment) are protruded at constant intervals in a circumferential direction; the inflow acceleration blades 99 have a working face 99a shaped like a right-angled triangle and formed to be large in width, extending and protruding gently downward from the center of the stirring member 84 in the radiation direction. Reference numeral 99b designates a tapered back face of the inflow acceleration blade 99; and reference numeral 99c designates an end face of the inflow acceleration blade 99.

In this manner, the inflow acceleration blade 99 rotates integrally with the stirring member 84, and the working face 99a of the inflow acceleration blade 99 acts upon the fluid R to be treated, whereby: the flow of suctioning the fluid R to be treated at the side of the inflow hole 90 is generated at a position proximal to the outer circumference of the inflow hole 90; and the inflow of the fluid R to be treated, to the inflow hole 90, is accelerated. Therefore, even in the case where a highly viscous fluid, for example, “C” heavy oil, which is a fuel oil, and water are stirred/mixed with each other, the resultant liquid mixture can be smoothly flown into the inflow hole 90, and the stirring and mixing of the fluid R to be treated, based upon backflow, can be efficiently performed.

### Description of a Stationary Fluid Mixer

Hereinafter, a description will be given with respect to fluid mixers 11 to 11E of the first to fourth embodiments, as stationary fluid mixers (hereinafter, occasionally merely referred to as “fluid mixers”) for mixing a fluid to be treated (hereinafter, referred to as a “fluid”) such as gas and liquid (gas-liquid) or liquid and liquid (liquid-liquid).

### Fluid Mixer 11 as the First Embodiment

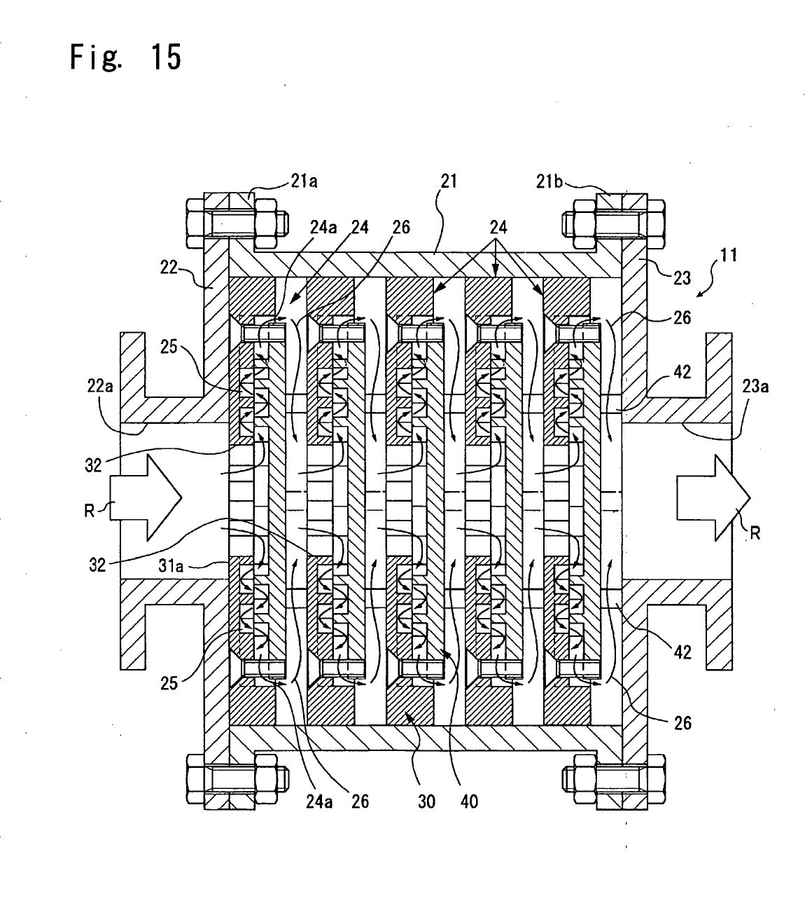

The fluid mixer 11 of the first embodiment will be described referring to FIGS. 15 to 21. That is, the fluid mixer 11, as shown in FIG. 15, has a cylindrical casing main body 21, both ends of which open. Flanges 21a, 21b are formed at opening portions at both ends of the casing main body 21, and capping members 22, 23 of the casing main body 21 are removably mounted on the flanges 21a, 21b, respectively. Openings 22a, 23a, which are gateways of fluid R of the fluid mixer 11, are formed at the capping members 22, 23. In the embodiment, the opening of the capping member 22, positioned at the left side in FIG. 15, is employed as a fluid feed port 22a, whereas the opening of the capping member 23, positioned at the right side in the figure, is employed as a fluid lead-out port 23a.

In addition, plural sets of mixing units 24 for applying mixing treatment to a fluid (five sets in the embodiment) are accommodated in the casing main body 21 and an inner circumferential face of the casing main body 21 and an outer circumferential face of each of the mixing units 24 are brought into a gapless intimate contact with each other.

As shown in FIG. 16, each mixing unit 24 is structured similarly, and is provided with two disk-shaped (substantially disk-shaped) members disposed in opposite to each other, more specifically first and second mixing elements 30, 40 which are formed in the disk shape. Among the two first and second mixing elements 30, 40, the first mixing element 30 disposed at the fluid feed port side (upstream side) allows a flow inlet 32 for fluid R (indicated by the arrow in FIG. 15 or the like) to be formed in a penetrative state at the center part of the disk-shaped element main body 31.

Further, a thick circumferential wall portion 33 is formed to be protrusive at a downstream side all around the outer circumferential edge part of an element main body 31; and a recessed portion 34 having a circular opening is formed toward the downstream side by means of the element main body 31 and the circumferential wall portion 33. Reference numeral 31a designates an upstream side face oriented toward the fluid feed port 22a of the element main body 31 and reference numeral 31b designates a downstream side face oriented toward the fluid lead-out port 23a of the element main body 31 (which is opposite to a second mixing element 40).

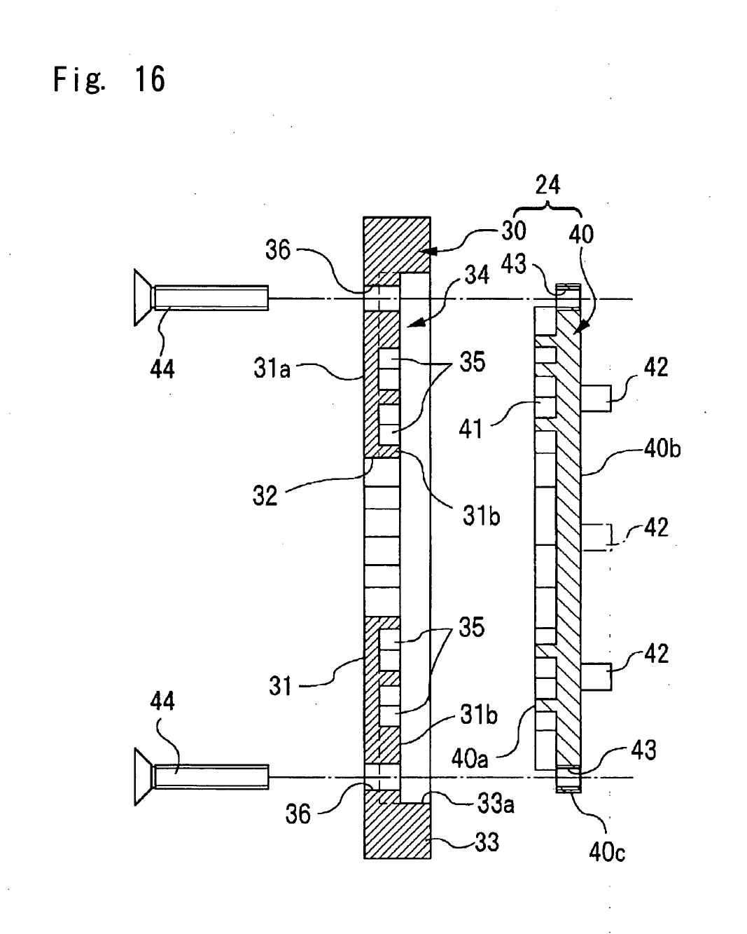

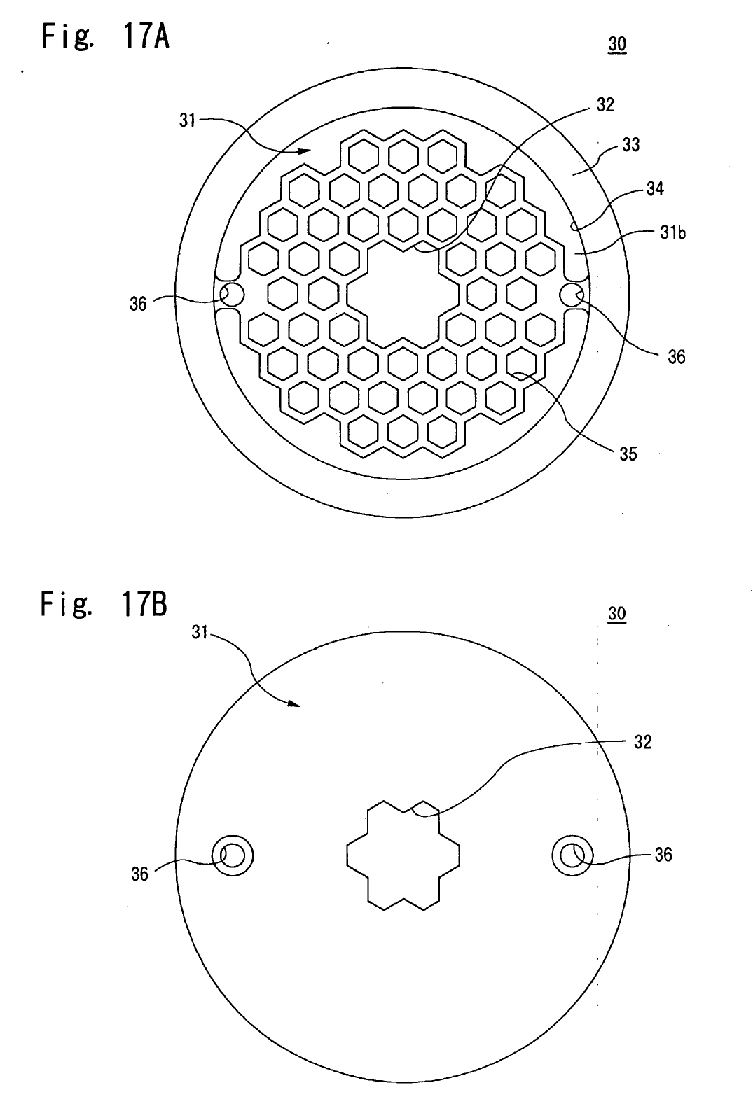

As shown in FIGS. 17A and 17B, at the downstream side face 31b of the element main body 31, a plurality of recessed portions 35, opening shapes of which are regular hexagons, are formed in a gapless manner. A number of recessed portions 35 are formed in a so called honeycomb shape. Reference numeral 36 designates a through hole for screw employed to fixing the second mixing element 40 to the first mixing element 30 by means of screw-tightening.

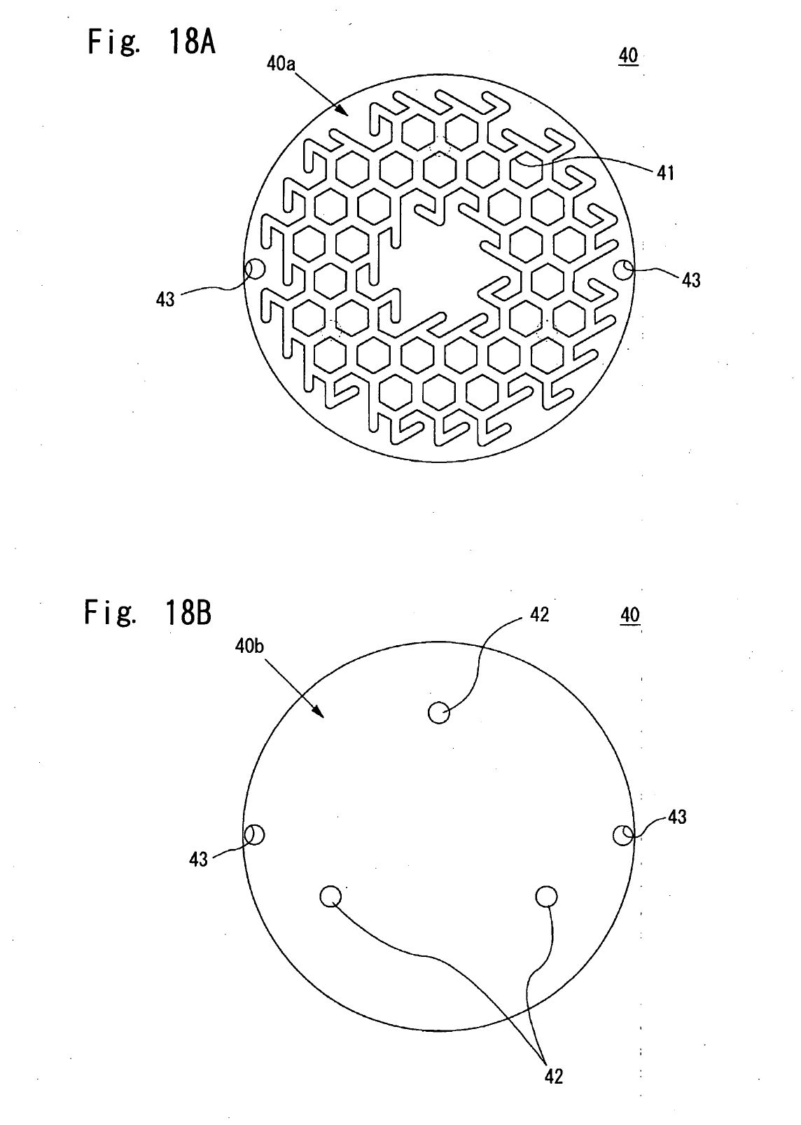

As shown in FIGS. 16, 18A and 18B, among the two mixing elements, the second mixing element 40 disposed at the fluid lead-out side (downstream side) is smaller in diameter than the first mixing element 30. The diameter of the second mixing element 40 is smaller than that of the recessed portion 34 of the first mixing element 30, allowing the second mixing element 40 to be engaged into the recessed portion 34.

In addition, on an opposite face to the first mixing element 30, of the second mixing element 40, i.e., at the upstream side 40a (opposite to the first mixing element) which is oriented toward the fluid feed port 22a, like the element main body 31 of the first mixing element 30, a plurality of recessed portions 41, opening shapes of which are regular hexagons, are formed in a gapless state. Further, three protrusions 42 are formed on a surface of the downstream side face 40b that is facially opposite to the upstream side face. Reference numeral 43 designates a screw hole formed to mount a female screw employed to fix the second mixing element 40 to the first mixing element 30 by means of screw-tightening.

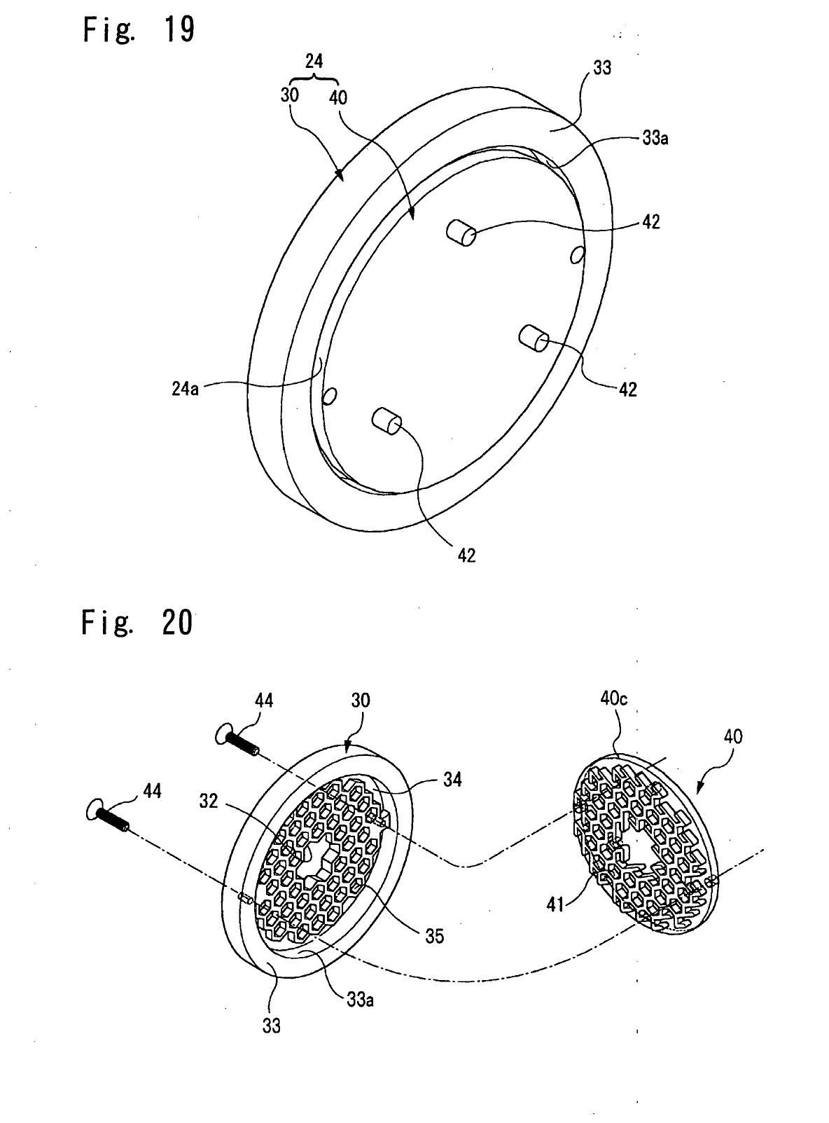

Further, both of the mixing elements 30, 40 are assembled in the layouts as shown in FIGS. 19 and 20. Specifically, the second mixing element 40 is positioned in a recessed portion 34 of the first mixing element 30. At this time, the orientation of the second mixing element 40 is determined (see FIG. 20) so that opening faces of a number of honeycomb-shaped recessed portions 35 of the downstream side face 31b of the first mixing element 30 abuts in a face-to-face state against those of a number of honeycomb-shaped recessed portions 41 of the upstream side face 40a of the second mixing element 40. If the second mixing element 40 is oriented in this way, a face having the protrusion 42 formed thereon can be seen from the outside (see FIG. 19). In this state, the through hole 36 of the first mixing element 30 and the screw hole 43 of the second mixing element 40 are positionally aligned with each other, and these mixing elements are assembled by tightening them with a screw 44.

As shown in FIG. 19, the diameter of the second mixing element 40 is smaller in size than that of the recessed portion 34 of the first mixing element 30. However, it should be noted that there is a slight difference in diameter.

Therefore, upon assembling both of the mixing elements 30, 40, between an inner circumferential face 33a of the circumferential wall portion 33 of the first mixing element and an outer circumferential end face 40c of the second mixing element 40, a ring-shaped gap is formed as a discharge canal 24a all around the outer circumferential end face of the second mixing element 40; and a dead end opening portion positioned at the downstream side of the discharge canal 24a is a flow outlet for fluid, and is opened in a ring shape toward the downstream side.

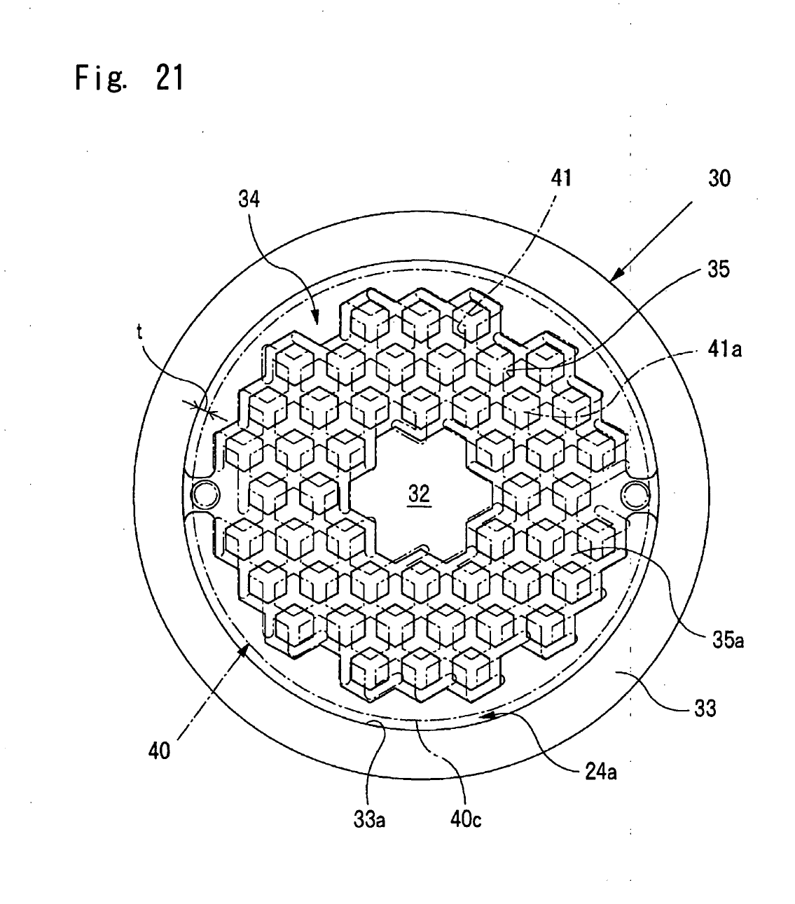

The fluid fed to the flow inlet 32 of the first mixing element 30 passes through a mixing flow path 25 to be described later (see FIG. 15), and then, is discharged from this flow outlet. A discharge width “t” of the discharge canal 24a is formed substantially equally in width all around there, and is formed in width of the order of 1/20 of the radius of the second mixing element 40 (more specifically, of the order of 2 mm) (see FIG. 21).

If the flow outlet of the discharge canal 24a all around the outer circumference of the second mixing element 40 is formed substantially equally in width, a fluid can be discharged substantially equally all around it. Thus, dispersion of a fluid pressure hardly occurs, and a disadvantage is prevented such that a bias of the discharge amount of fluid occurs depending upon the position of the outer circumferential part of the mixing unit 24. If the bias of the discharge amount is prevented, a discharge canal resistance is lowed and the generation of a location in which the fluid pressure becomes locally high is prevented.

In addition, as shown in FIG. 21, the size of the discharge canal 24a, i.e., the width “t” of a gap becomes substantially equal all around there. In this manner, the discharge canal resistance can be lowered more reliably, and the occurrence of a local high-pressure region, in particular, the occurrence of a local high-pressure region in the vicinity of the discharge canal 24a can be prevented.

Hereinafter, a description will be given with respect to a correlation of a number of honeycomb-shaped recessed portions 35, 41, to be formed on the abutment-side face of each of the mixing elements 30, 40.

As shown in FIG. 21, abutment faces of both of the mixing elements 30, 40 abuts against each other while the rectangular portion 41a of the recessed portion 41 of the second mixing element 40 is positioned at a center position of the recessed portion 35 of the first mixing element.

If these faces are thus abutted as each other, a fluid can be flown between the recessed portion 35 of the first mixing element 30 and the recessed portion 41 of the second mixing element 40. In addition, the rectangular portion 41a is positioned where the rectangular portions 41a of the three recessed portions 41 gather.

Therefore, a fluid is diverted to three discharge canals in consideration of a case in which the fluid flows from the side of the recessed portion 35 of the first mixing element 30 to the side of the recessed portion 41 of the second mixing element 40.

Namely, the rectangular portion 41a of the second mixing element 40, which is positioned at the center position of the recessed portion 35 of the first mixing element 30, functions as a diverting portion for diverting a fluid into two ways. Conversely, the fluid having flown out of the two ways flows into one recessed portion 35, and is merged in consideration of a case in which the fluid flows from the side of the second mixing element 40 to the side of the first mixing element 30. In this case, the rectangular portion 41a positioned at the center position of the second mixing element 40 functions as a converging portion.

In addition, the rectangular portion 35a of the recessed portion 35 of the first mixing element 30 is positioned at a center position of the recessed portion 41 of the second mixing element 40 as well. In this case, the rectangular portion 35a of the first mixing element 30 functions as the above-described diverting section or converging section.

In this manner, between the mixing elements 30 and 40 that are disposed in opposite to each other, there is formed a mixing flow path 25 (see FIG. 15) in which the fluid fed from a center flow inlet 32 in the axial direction of both of the mixing elements 30, 40 (casing main body 21) flows in the radiation direction (radial direction) of both of the mixing elements 30, 40, repeating diversion (in a shear shape) while being sheared and confluence (in a compressive shape) while being compressed.

In the course of fluid flowing through the mixing flow path 25, mixing treatment is applied to the fluid. The fluid having passed through the mixing flow path 25 is then flown out of a flow outlet of the discharge canal 24a opening in a ring shape toward the downstream side at the outer circumferential part at the rear side of the mixing unit 24 to the outside of the mixing unit 24.

As shown in FIG. 15, the fluid mixer 11 of the embodiment allows five mixing units 24 to be set up in the casing main body 21. When a plurality of mixing units 24 are set up, the protrusion 42 of the second mixing element 40 of the mixing unit 24 that is positioned at the upstream side abuts against the upstream side face 31a (of the element main body 31) of the first mixing element 30 of the mixing unit 24 set up at the downstream side.

In this manner, a disk-shaped space is acquired as the one formed by means of the mixing units 24, 24, both of which are disposed adjacent to each other, and the casing main body 21; and a collecting flow path 26 is acquired for flowing the fluid having flown out of the flow outlet of the discharge canal 24a to the flow inlet 32 of the mixing unit 24 at the downstream side through the disk-shaped space.

The protrusion 42 of the second mixing element 40 of the mixing unit 24 disposed at the most downstream side abuts against the capping member 23 at the downstream side of the casing main body 21.

In this manner, a disk-shaped space is acquired as the one formed by means of the mixing unit 24, the capping member 23, and the casing main body 21; and a collecting flow path 26 is acquired for flowing the fluid having flown out of the flow outlet 24a of the mixing unit 24 at the most downstream side to the fluid lead-out port 23a of a casing through the disk-shaped space.

Next, a description will be given with respect to a case of applying mixing treatment to a fluid by employing the fluid mixer 11 configured as described above. Hereinafter, a description will be given by way of example of a case of applying mixing treatment to a gas-liquid mixture fluid of water and air by means of the fluid mixer 11.

First, a pressure-feed pump 2 is actuated with a communication pipe 1 being connected to a fluid feed port 22a and a fluid lead-out port 23a, of the fluid mixer 11, thereby producing a gas-liquid fluid mixed by acquiring a predetermined amount of air as a gas in the treatment liquid that is primarily mixed and treated at the primary mixing treatment section, and then, feeing the fluid to the fluid lead-out port 23a of the fluid mixer 11.

As shown in FIG. 15, the gas-liquid mixture fluid fed to the fluid mixer 11 is then flown into the flow inlet 32 of the first mixing element 30 of the first mixing unit 24 disposed at the most upstream side in the casing, and is fed to the mixing flow path 25 of the first mixing unit 24.

The gas-liquid mixture fluid fed to the mixing flow path 25 flows in the flow outlet 24a formed at the outer circumferential side of the mixing unit 24 while repeating diversion and confluence. Namely, flowage occurs while meandering in the course of repeating diversion and confluence; and thus, schematically, mixing treatment is applied to the gas-liquid mixture fluid in the course of repeating diversion and confluence while flowage occurs in the radial-spreading direction from the center of the disk-shaped mixing unit 24 to the outer circumferential side. That is, in the gas-liquid mixture fluid, fine impurities and air bubbles are ultra-miniaturized (from the nano-level to the several-microns level). In particular, the air bubbles are homogenized.

The fluid having flown out of the flow outlet 24a of the first mixing unit 24 flows through the collecting flow path 26 between the first mixing unit 24 and the second mixing unit 24 disposed at the downstream thereof, and is fed to the flow inlet 32 of the second mixing unit 24. The flow of the fluid in each of the mixing units 24 is similar to that of the fluid in the first mixing unit 24, a duplicate description of which is omitted here. A plurality of mixing units 24 are set up so that diversion while the fluid is sheared and confluence while the fluid is compressed are repeated, whereby fluid mixing treatment is applied to ultra-miniaturize and uniformize air bubbles or fine impurities more reliably.

In addition, the following treatment may be performed. In FIG. 1, a first three-way valve 12 is manipulated to be switched so that the fluid led out of the fluid lead-out port 23a of the fluid mixer 11 flows into a return pipe 14 and a second three-way valve 13 is manipulated to be switched so that the fluid of the return pipe 14 flows into the communication pipe 1.

The above fluid is then circularly fed to the fluid mixer 11 through the return pipe 14. By doing this, fluid mixing treatment is applied further reliably, allowing further finer and uniformly-sized air bubbles to be generated in the fluid.

Further, after circulation during a required period of time, the first and second three-way valves 12, 13 are manipulated to be switched, and the treated fluid is then led out.

In this way, more reliable fluid mixing treatment can be applied, allowing finer and more uniformly sized, desired air bubbles to be generated in the fluid.

Here, a total number of diversions is determined depending upon: the number of recessed portions 35, 41 formed in mixing elements 30, 40; the number of mixing units 24 set up in the casing main body 21 of the fluid mixer 11; and the number of repetitions indicating how many times the fluid is circulated for the fluid mixer 11.

For example, a summed total number of diversions reaches 1,500 times to 1,600 times, if the recessed portions 35, 41 have hexagonal openings seen in a plan view, in the case where the first mixing element 30 shaped like three columns in which the numbers of chambers in the recessed portions are 12 chambers, 18 chambers, and 18 chambers (a total of 48 chambers) is superimposed on the second mixing element 40 shaped like two columns in which the numbers of chambers are 15 chambers and 15 chambers (a total of 30 chambers). The total number of diversions used herein designates the number of diversions at the diverting section of the mixing flow path 25 that is formed between the first mixing element 30 and the second mixing element 40.

### Fluid Mixer 11A of the Second Embodiment

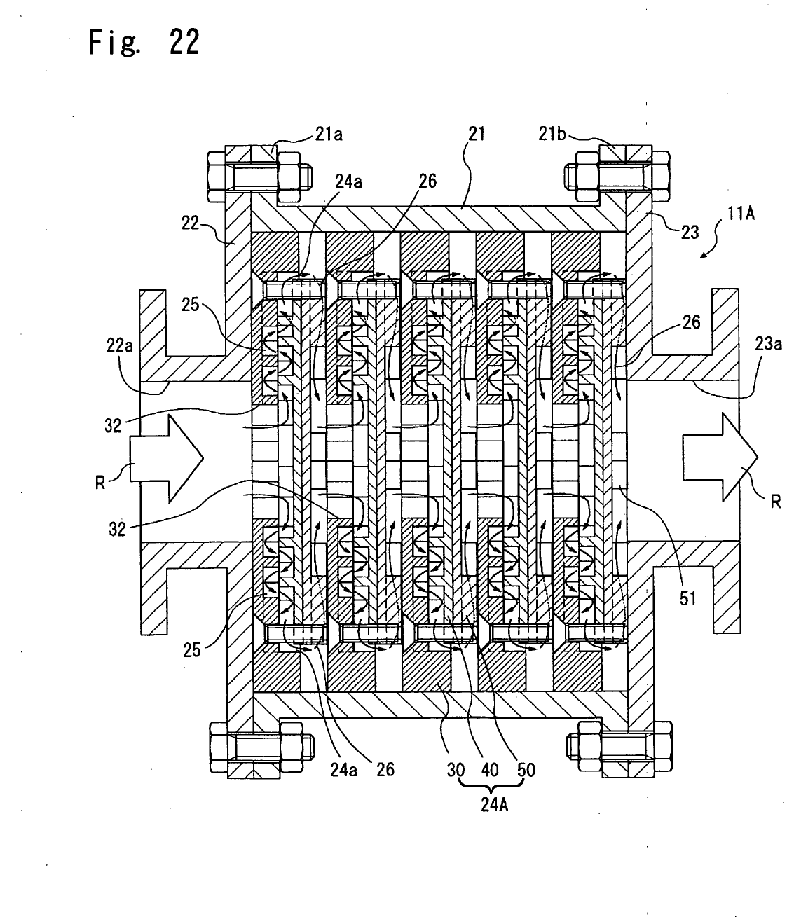

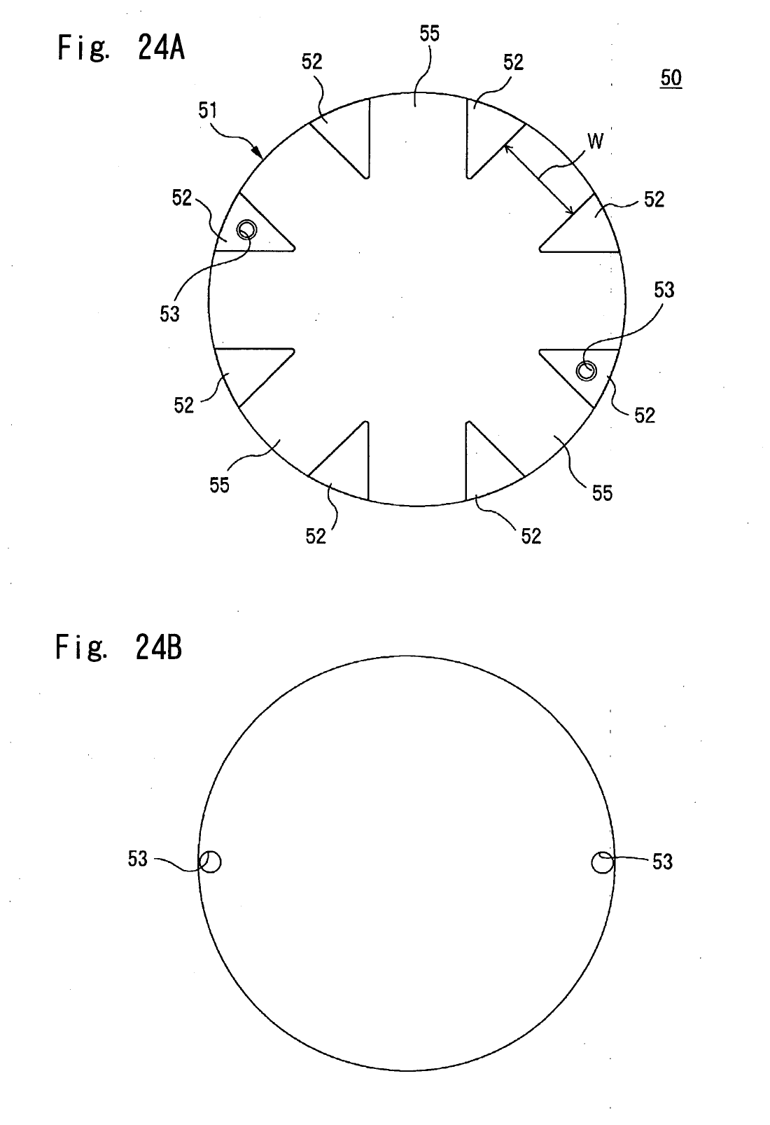

Next, a fluid mixer 11A of the second embodiment will be described referring to FIGS. 22 to 27. That is, unlike the mixing unit 24 of the first embodiment, the fluid mixer 11A is provided with a guide member 52 in the collecting flow path 26 in which the fluid having flown out of the flow outlet 24a of the mixing unit 24A flows (see FIGS. 24A and 24B). The same constituent elements of the fluid mixer 11 of the first embodiment are designated by the same reference numerals, a duplicate description of which is omitted here.

As shown in FIG. 22, the mixing unit 24A of the fluid mixer 11A of the embodiment is provided with a collecting-flow-path forming element 50 which comprises a guide member 52 which is a member of stabilizing a flow-path sectional area of the collecting flow path 26, in addition to the first mixing element 30 and the second mixing element 40.

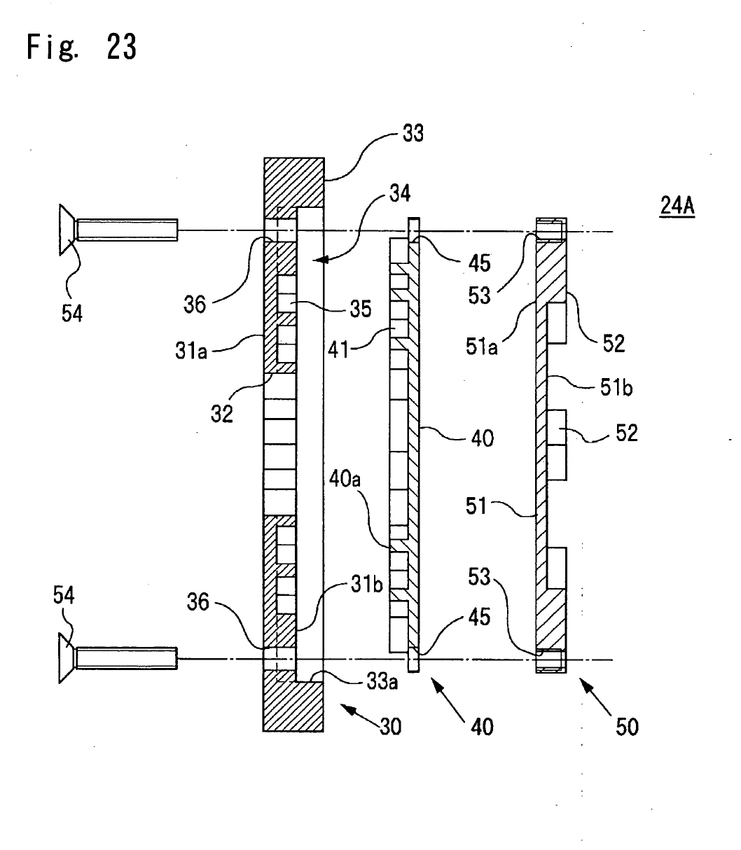

Among them, the second mixing element 40 is not provided with the protrusion 42, unlike the one of the first embodiment. Namely, a downstream side face 40b, which is oriented toward the fluid lead-out port of the second mixing element 40, is formed in a planar shape. Other constituent elements are the same as those of the second mixing element 40 of the first embodiment. In FIG. 23, reference numeral 45 designates a through hole of a screw employed to fix the second mixing element 40 to the first mixing element 30 by means of screw-tightening.

As shown in FIGS. 24 A, 24B, and 26, a collecting-flow-path forming element 50 allows the guide member 52 to be provided at the circumferential edge part of the downstream side face 51b which is one side of an element main body 51 formed in the same diameter as that of the second mixing element 40 and in a thin disk shape.

In addition, an upstream side face 51a coming into facial contact with another one, which is oriented toward the second mixing element 40 while set up in the casing main body 21, is formed in a planar shape. Further, a plurality of protrusive guide members 52 are integrally formed at the circumferential edge part of the downstream side face 51b oriented toward the fluid lead-out port 23a.

The guide member 52 is a planar member formed to be substantially shaped like a fan from: an outer circumferential arc face 52a formed on an arc face whose curvature is the same as that of the outer circumferential edge of the second mixing element 40; one pair of side faces 52a, 52b that is connected to be extended from both ends of the outer circumferential arc face 52a to the center side of the element main body 51; and an abutment face 52c formed as a plane being parallel to the element main body 51. An angle (apex angle) formed by one pair of the side faces 52b, 52b is set at 45 degrees, and an extended width of the side face 52b is set to be substantially ⅓ of the radius of the element main body 51.

At the circumferential part of the element main body 51 of the embodiment, a total of eight guide members 52 are disposed at equal intervals in the circumferential direction. In addition, the guide members 52 are formed so that: the outer circumferential arc face 52a is flush with the outer circumferential end face of the collecting-flow-path forming element 50 and that of the second mixing element 40; and the side faces 52b, 52b, which are opposite to each other, of the guide members 52 adjacent to each other, are parallel to each other in the circumferential direction.

Therefore, a groove portion 55 formed of the side faces 52b, 52b, of the guide members 52, 52 adjacent to each other, and the downstream side face 51b, allow width W of the groove portion to be constant and equal from the circumferential side to the center side of the collecting-flow-path forming element 50. Reference numeral 53 designates a screw hole formed to mount a female screw employed to integrally fix the collecting-flow-path forming element 50 to the first mixing element 30 and the second mixing element 40 by means of screw-tightening.

The mixing units 24A comprising the collecting-flow-path forming element 50 are assembled as shown in FIG. 22.

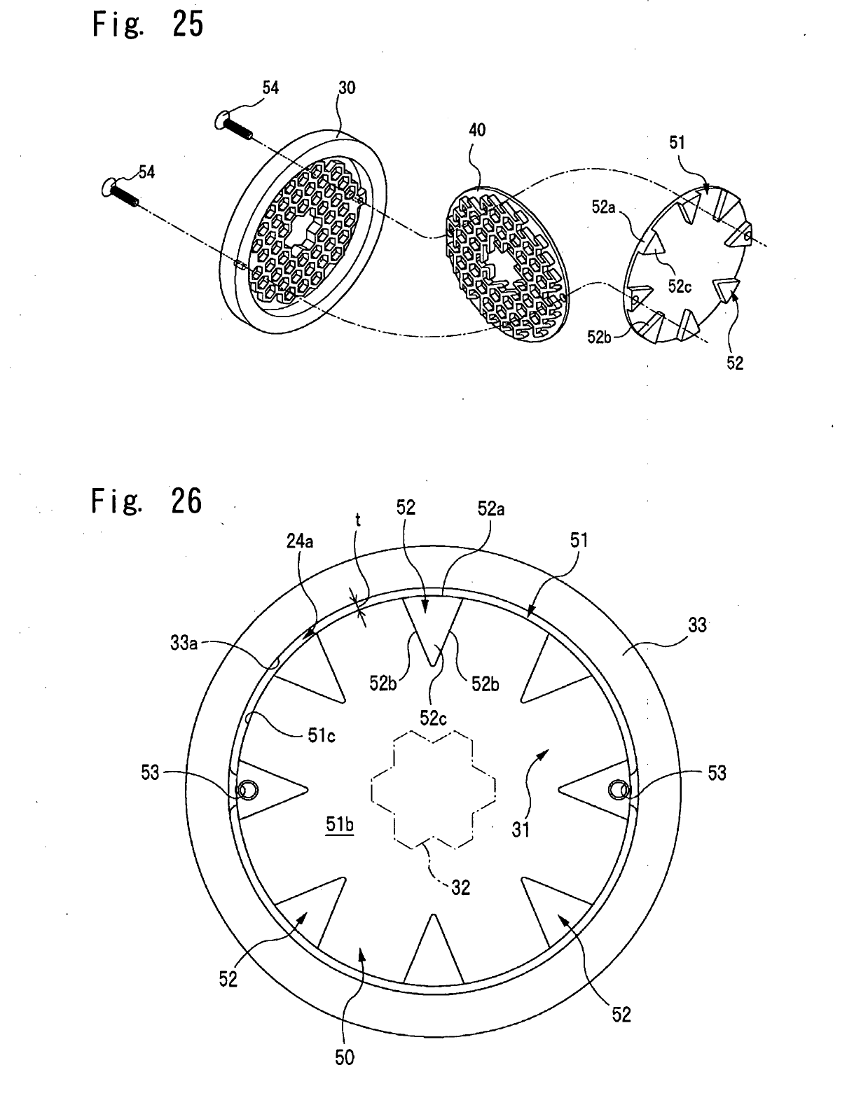

First, like the first embodiment, the second mixing element 40 is assembled with the first mixing element 30, and the collecting-flow-path forming element 50 is disposed so as to be superimposed on the second mixing element 40 (see FIGS. 23 and 25).

At this time, a planar downstream side face 40b of the second mixing element 40, which is oriented to the outside, is bought into facial contact with a planer upstream side face 51a of the collecting-flow-path forming element 50.

A face having the guide member 52 of the collecting-flow-path forming element 50 formed thereon is then oriented to the downstream side.

In this state, the through holes 36, 45 of the mixing elements 30, 40, respectively, and the screw hole 53 of the collecting-flow-path forming element 50, are positionally aligned, and these mixing elements are assembled after tightened with a screw 54.

In addition, as shown in FIG. 22, the fluid mixer 11A of the second embodiment allows five mixing units 24A to be set up in the casing main body 21. When a plurality of mixing units 24A is set up, the abutment face 52c of the guide member 52 that is provided at the collecting-flow-path forming element 50 of the mixing unit 24A that is positioned at the upstream side abuts against the upstream side face 31a of the first mixing element 30 of the mixing unit 24A that is positioned at the downstream side.

In this manner, a gap corresponding to the thickness of the guide member 52 is held between the mixing units 24A disposed adjacent to each other, and the collecting flow path 26 is acquired for flowing the fluid having flown out of the flow outlet of the discharge canal 24a into the flow inlet 32 of the mixing unit 24A at the downstream side.

Moreover, as shown in FIGS. 22 and 24, in the collecting-flow-path forming element 50, the groove portion 55 that is formed between the guide members 52, 52 adjacent to each other becomes constant in its dimensional width, as described above.

Therefore, when the abutment face 52c of the guide member 52 is brought into abutment against the upstream side face 31a of the first mixing element 30 at the downstream side, the collecting flow path 26 that is formed between the groove portion 55 and the upstream side face 31a of the first mixing element 30 becomes constant as to intervals at which the groove portions 55 are formed on a flow path cross section shaped like a elongated rectangle shape in the circumferential direction and from the outer circumferential side to the center side at which the flow path sectional area is in the direction of collecting flow. In addition, the guide members 52 are intended to rectify the flow of fluid. The guide members 52 are provided, whereby the fluid flows smoothly.

If the guide members 52 are not present, the collecting flow path 26 becomes greater in sectional area of the flow path, as the outer circumferential side approaches more, whereas the flow path becomes more rapidly smaller, as the center communicating to the discharge outlet approaches more. A structure in which the flow path sectional area rapidly increases or decreases causes a flow path resistance, or alternatively, causes the generation of a portion at which the fluid becomes locally high in pressure. If the flow path resistance increases, the fluid pressure becomes higher and the flow rate is lowered. In addition, if a high-pressure location is locally generated, the leakage of fluid occurs therefrom.

In this point of view, in the fluid mixer 11A of the embodiment, eight guide members 52 are provided at constant intervals in the circumferential direction at the circumferential edge part of the element main body 51; and eight groove portions 55 forming the collecting flow path 26 is formed in a radiation shape, allowing the flow path sectional area to be stabilized in the collecting flow path 26 from the outer circumferential side to the vicinity of the discharge outlet of the center part, which is the direction of collecting-flow.

Therefore, the fluid having flown out of the flow outlet of the ring-shaped discharge canal 24a flows out of the outer circumferential edge part of the element main body 51 into the upstream side of the nearest one of the collecting flow paths 26 equally disposed in the circumferential direction. However, if the flow path sectional area of this collecting flow path 26 is stable up to the vicinity of the discharge outlet which is the downstream side, the generation of a location in which the flow path resistance is lowered, or alternatively, the fluid pressure becomes locally high is prevented.

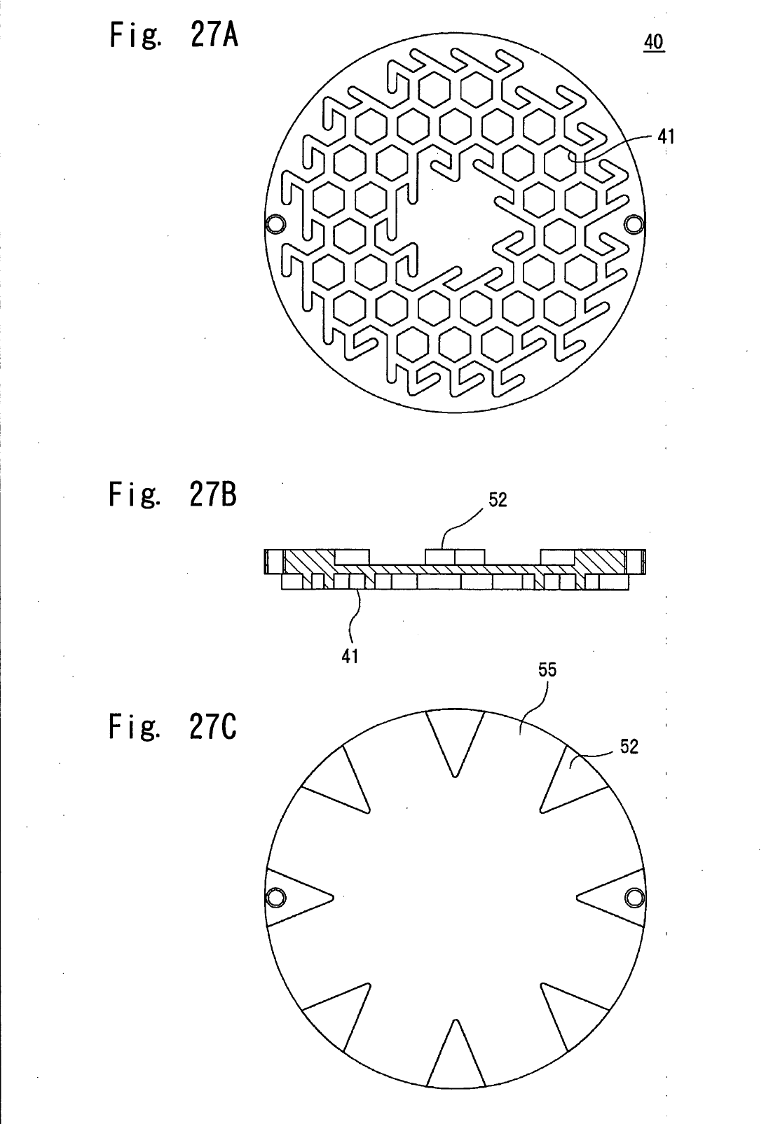

In addition, in the second embodiment described so far, the guide members 52 are formed at the collecting-flow-path forming element 50 which is independent of the second mixing element 40, whereas as shown in FIG. 27, the guide members 52 may be formed integrally with the second mixing element 40.

In this case, there is no need for the element main body 51, and the miniaturization of the fluid mixer 11 can be achieved. In addition, the number of parts is reduced, thus facilitating assembling work. Easy maintenance in activities such as disassembling/assembling work is important, since there are quite a few opportunities of performing maintenance in equipment in which a flow path is comparatively narrow like the fluid mixer 11A of the embodiment.

Further, the guide members 52 that are included in the second mixing element 40 may also be employed as the protrusion 42 of the first embodiment. Therefore, there is an advantage that no protrusion needs to be provided aside from the guide members 52.

A process for producing air bubbles by employing the fluid mixer 11A of the second embodiment itself is similar to the case of generating air bubbles by employing the fluid mixer 11 of the first embodiment, a duplicate description of which is omitted here. This is also similar to the third embodiment which will be described hereinafter.

### Fluid Mixer 11B of the Third Embodiment

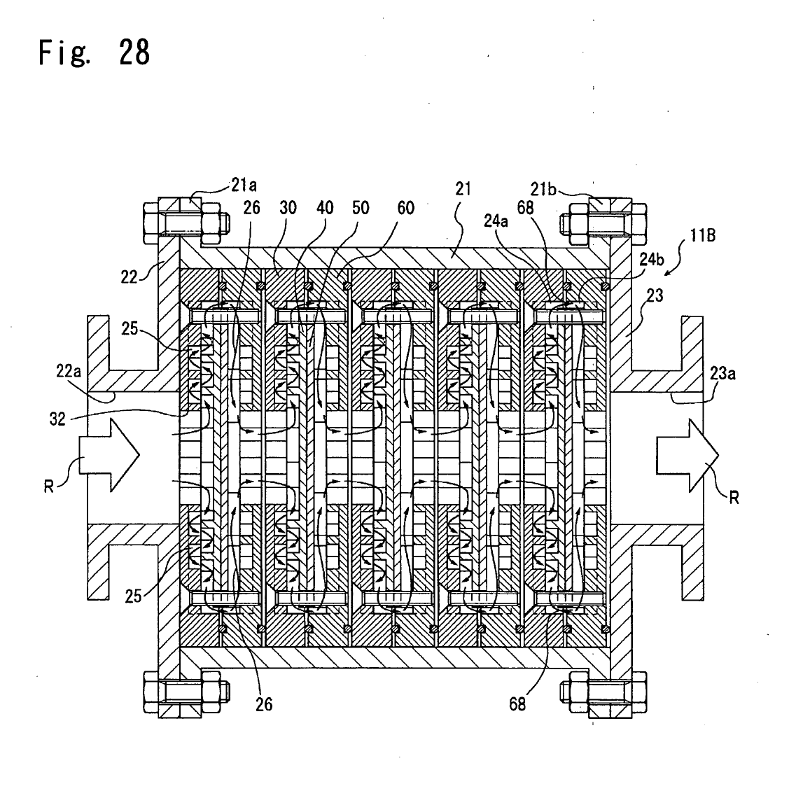

Next, a fluid mixer 11B of the third embodiment will be described referring to FIGS. 28 to 31. The same constituent elements of the abovementioned fluid mixer 11A of the second embodiment are designated by the same reference numerals, a duplicate description of which is omitted here.

Unlike the fluid mixer 11A of the second embodiment, the fluid mixer 11B of the third embodiment is provided with a lead-out side element 60 which is disposed in opposite to a collecting-flow-path forming element 50, as a constituent element of a mixing unit set up in a casing main body 21.

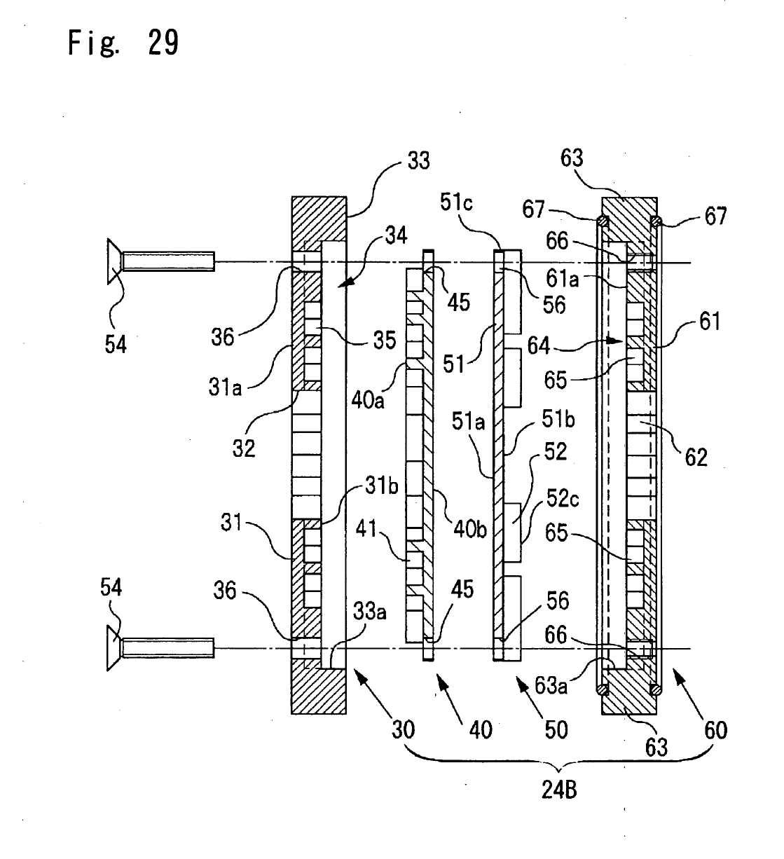

Specifically, as shown in FIG. 29, a mixing unit 24B of the fluid mixer 11B of the third embodiment is provided with: the lead-out side element 60 in addition to the first mixing element 30, the second mixing element 40, and the collecting-flow-path forming element 50, of the second embodiment.

The first and second mixing elements 30, 40 are the same as those of the second embodiment. In addition, as shown in FIG. 29, the collecting-flow-path forming element 50 of the embodiment is provided with a through hole 56 which is employed for the sake of screw-tightening in place of the screw hole 53 of the second embodiment. Other constituent elements are similar to those of the collecting-flow-path forming element 50 of the second embodiment.

As shown in FIG. 29, a lead-out side element 60 allows a fluid discharge port 62 for fluid R (indicated by the arrow in FIG. 28 or the like) is formed in a penetrative state at the center part of a disk-shaped element main body 61.

In addition, a thick circumferential wall portion 63 is formed in a protrusive shape at the upstream side all around the outer circumferential edge part of the element main body 61, and a recessed portion 64 having a circular opening toward the upstream side is formed by means of the element main body 61 and the circumferential wall portion 63. Reference numeral 61a designates an upstream side face (whose side is opposite to the collecting-flow-path forming element 50) of the element main body 61.

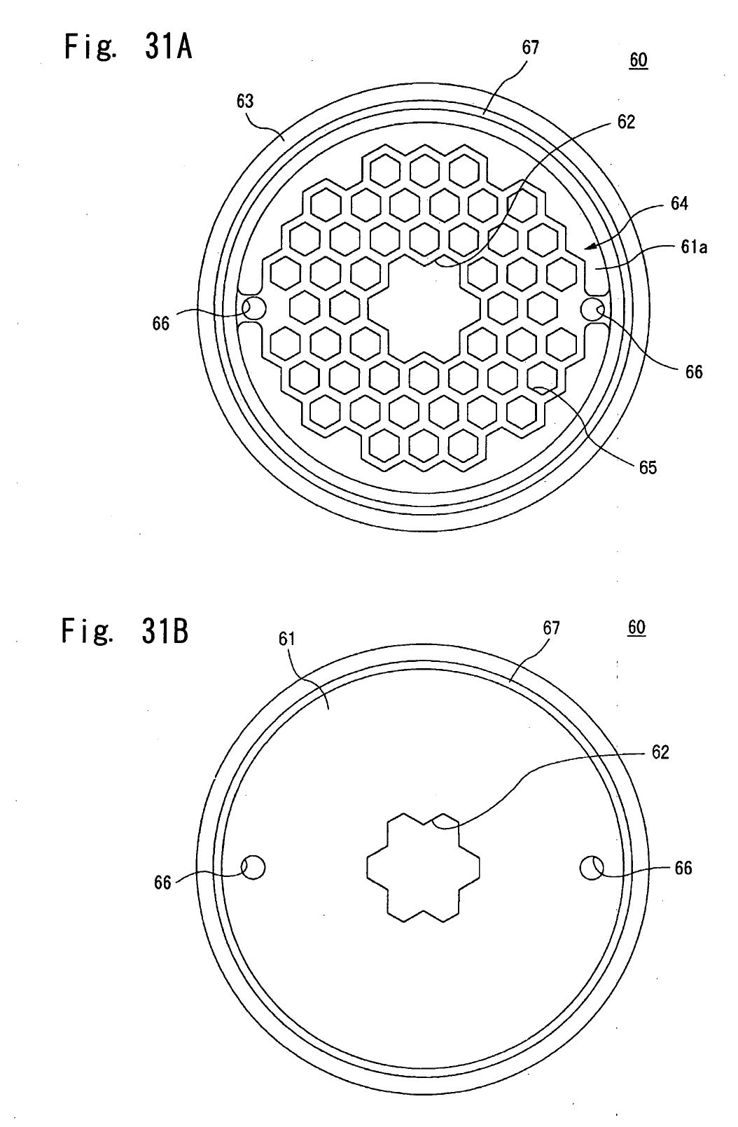

As shown in FIGS. 31A and 31B, at an upstream side face 61a of the element main body 61, a plurality of recessed portions 65 whose opening is shaped like a regular hexagon are formed in a gapless manner. A number of recessed portions 65 are formed in a so called honeycomb shape. Reference numeral 66 designates a screw hole employed to fix the lead-out side element 60 to the first mixing element 30 or the like by screw-tightening.

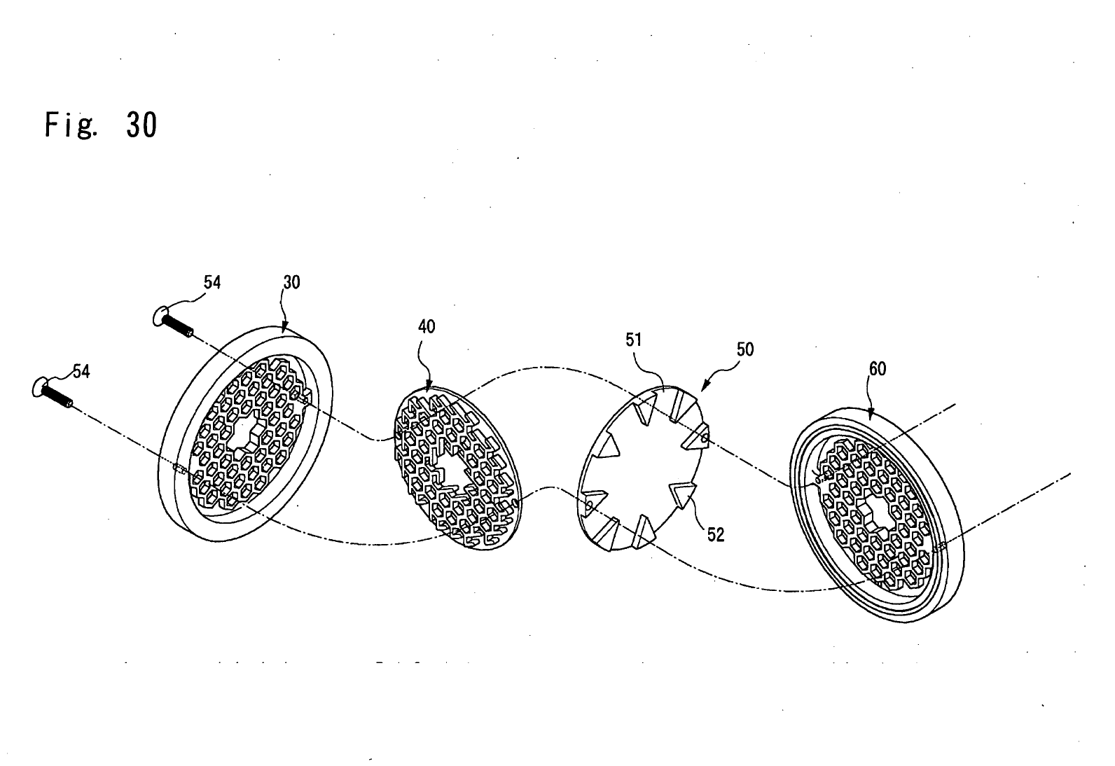

As shown in FIGS. 29 and 30, the lead-out side element 60 forms the element main body 61 or the circumferential wall portion 63 whose diameter is substantially equal to that of the element main body 31 or that of the circumferential wall portion 33, of the first mixing element 30, allowing end faces of the circumferential wall portions 63, 33 to be opposed to each other in a face-to-face manner, via packing 67.

That is, the lead-out side element 60 is greater in size than the collecting-flow-path forming element 50. In addition, the diameter of the element main body 61 is greater than that of the element main body 51 so that the collecting-flow-path forming element 50 is accommodated to be engaged in the recessed portion 64. However, it should be noted that there is a slight difference in diameter.

Therefore, upon assembling both of elements 50, 60, between an outer circumferential end face 51c of the collecting-flow-path forming element 50 and an inner circumferential face 63a of the circumferential wall portion 63 of the lead-out side element 60, a ring-shaped gap is formed as an inflow path 24b all around the outer circumferential end face of the collecting-flow-path forming element 50; and a leading edge opening portion positioned at the upstream side of the inflow path 24b is a flow inlet for fluid, and is opened in a ring shape toward the upstream side.

The inflow width of the inflow path 24b is formed to be equal all around there, and is formed to be on the order of 1/20 of the radius of the collecting-flow-path forming element 50, for example (more specifically, on the order of 2 mm).

The inflow path 24b is formed in diameter which is substantially equal to that of each of the collecting-flow-path forming element 50 and the second mixing element 40. In the embodiment, this inflow path is formed in diameter and width which is substantially equal to that of an outflow path 24a formed between the first and second mixing elements 30 and 40, and is disposed in opposite to each other in a face-to-face manner.

In addition, a flow outlet of the outflow path 24a and an flow inlet of the inflow path 24b are connected to each other, and a ring-shaped communication connecting path 68 is formed.

Moreover, in the communication connecting path 68, the flow outlet of the outflow path 24a opening in the ring shape toward the downstream side all around there and the flow inlet of the inflow path 24b opening in the ring shape toward the upstream side all around there are formed in proximity and face-to-face in a matched state, so that: a pressure loss of the fluid flowing through the outflow path 24a->the inflow path 24b->the collecting flow path 26 can be significantly lowered; the amount of treatment per a unit time can be increased; and fluid leakage from the packing 67 which is a sealing section can be reliably avoided.

The mixing unit 24B is assembled in the layout as shown in FIGS. 28 to 30. Specifically, the second mixing element 40 is disposed in the recessed portion 34 of the first mixing element 30, whereas the collecting-flow-path forming element 50 is disposed in the recessed portion 64 of the lead-out side element 60.

At this time, the orientation of the second mixing element 40 is determined so that opening faces of a number of honeycomb-shaped recessed portions 35 of the downstream side face 31b of the first mixing element 30 abuts against that of a number of honeycomb-shaped recessed portions 41 of an upstream side face 40a of the second mixing element 40 in a face-to-face state; and the orientation of each of the elements 30, 40, 50, 60 is determined so that opening faces of a number of honeycomb-shaped recessed portions 65 of the upstream side face 61a of the lead-out side element 60 abuts against the abutment face 52c of the guide member 52 of the collecting-flow-path forming element 50 in a face-to-face state (see FIG. 29).

In this state, a through hole 36 of the first mixing element 30; a screw hole 45 of the second mixing element 40; a through hole 56 of the collecting-flow-path forming element 50; and a screw hole 66 of the lead-out side element are positionally aligned with each other; and are assembled by screw-tightening them with a screw 54.

At this time, the end faces of the circumferential wall portion 63 of the lead-out side element 60 and the circumferential wall portion 33 of the first mixing element 30 are brought into intimate contact with each other in a face-to-face state, via the packing 67; and a gap 24a as a flow outlet and a gap 24b as a flow inlet, which is to be formed in a ring shape inward of both of the circumferential wall portions 33, 63 (mixing unit 24B), are caused to communicate with each other in an opposite state.

As a result, the fluid having flown out of the flow outlet 24a flows from the inflow path 24b to the collecting flow path 26 that is formed between the collecting-flow-path forming element 50 and the lead-out side element 60.

In this way, the outflow path 24a is formed all around an outer circumference of the second mixing element 40 and the inflow path 24b is formed all around an outer circumference of the collecting-flow-path forming element 50, whereby fluid can be caused to outflow/inflow all around there, thus preventing a disadvantage such that a bias of the outflow amount of fluid occurs depending upon the position of the outer circumferential part of the mixing unit 24B.

The bias of the outflow amount is prevented, whereby a flow-path resistance is lowered, preventing the generation of a location in which the fluid pressure becomes locally high. In addition, in the embodiment, the sizes of the outflow path 24a and the inflow path 24b, i.e., the widths of gaps are substantially equal to each other all around there.

In this manner, the flow path resistance can be lowered more reliably, making it possible to prevent the generation of a local high-pressure area, in particular, the generation of a local high-pressure area in the vicinity of the flow outlet 24a and the flow inlet 24b.

In addition, with such a structure, a so called dead space in which fluid is prone to become stagnant partway of the fluid flow path is eliminated. If a dead space is present, fluid is prone to become stagnant in that space, and dispersion in quality of fluid mixing treatment (for example, the quality in the size of generated air bubbles or the like) is prone to occur.

In this point of view, in the embodiment, a dead space is minimized, the occurrence of such disadvantage is restrained to the minimum; uniform mixing treatment can be applied depending upon the type of fluid; and air bubbles of more uniform sizes can be generated.

As described previously, the collecting flow path 26 (see FIG. 28) is formed between the collecting-flow-path forming element 50 and the lead-out side element 60 so that fluid flows from the inflow path 24b to the collecting flow path 26.

The fluid flows into the fluid discharge port 63 (see FIG. 29) through the collecting flow path 26, and then, flows into the flow inlet 32 of the next mixing unit 24B or is led out from the fluid lead-out port 23a of the capping member 23 of a casing.

In the collecting flow path 26, the fluid flows from the outer circumference side to the center side of the collecting-flow-path forming element 50. Guide members 52 are formed at the outer circumferential side of the collecting-flow-path forming element 50; and groove portions 55 are formed between the guide members 52 adjacent to each other. The dimensional widths of the groove portions 55 become constant, and the flow path sectional areas surrounded by the groove portions 55 and the upstream side face 61a of the lead-out side element 60 become constant.

When the flow path sectional area is thus stable, the flow path resistance or pressure is stabilized, and the distribution of fluid is stabilized.

Incidentally, as shown in FIGS. 31A and 31B, a number of so called honeycomb-shaped recessed portions 65 are formed on the upstream side face 61a which is a bottom face of the recessed portion 64 of the lead-out side element 60. The abutment face 52c of the guide member 52 of the collecting-flow-path forming element 50 is planar, and thus, even if a honeycomb recessed portion (irregular shape) is present on the abutment face at the side of the lead-out side element 60, fluid is neither diverted nor merged.

However, if a recessed portion 65 is present on the bottom face of the recessed portion 64 of the lead-out side element 60, a mixing effect due to a shear force or that due to a mechanical cavitation or the like can be imparted to the fluid in the collecting flow path 26, flowing in the vicinity of an opening of the recessed portion 65.

For example, by employing the lead-out side element 60 provided with a plurality of recessed portions 65 on a surface facing to the collecting flow path 26, a local high-pressure portion or a local low-pressure portion can be generated in the collecting flow path 26 and in the fluid flowing in the vicinity of an opening of the recessed portion 65.

When a local low-pressure portion (for example, a negative pressure portion such as a vacuum portion) is generated in the fluid, a so called foaming phenomenon in which air bubbles are generated in liquid occurs; and there occurs a so called cavitation phenomenon in which: fine air bubbles expands (collapses); and the generated air (air bubbles) break(s) (disappear(s)).

Miniaturization of the substances targeted for mixing is performed by means of a force generated when this cavitation occurs, and fluid mixing is accelerated.

However, as described above, by employing the lead-out side element 60 provided with the recessed portion 65 on the surface facing to the collecting flow path 26, a local high-pressure portion or a local low-pressure portion can be generated in fluid only in place where the opening of the recessed portion 65 of the lead-out side element 60 faces.

In addition, the flow path sectional area is stabilized at another portion, for example, in a region in which fluid leakage is prone to occur, such as the outflow path 24a or the vicinity of the inflow path 24b disposed in opposite thereto (see FIG. 28), and a state in which the generation of the local high-pressure portion is prevented is maintained. Therefore, a situation in which fluid leakage is prone to occur is prevented.

As the lead-out side element 60, the ones of various types can be employed without being limitative to the embodiment in which a plurality of recessed portions have been formed on the bottom face of the recessed portion 64. For example, there may be the ones in which: a plurality of protrusive portions are formed on the bottom face of the recessed portion 64 in place of the recessed portion; both of a plurality of recessed portions and protrusive portions are formed on the bottom of the recessed portion 64; and further, the bottom face of the recessed portion 64 is planar.

### Fluid Mixer 11C of the Fourth Embodiment

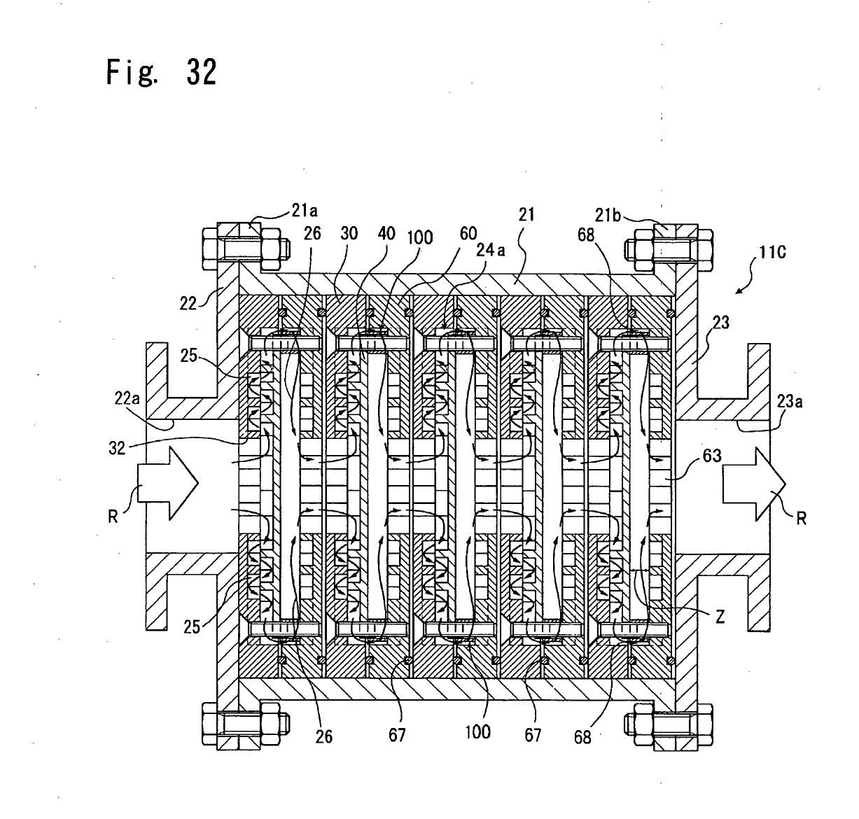

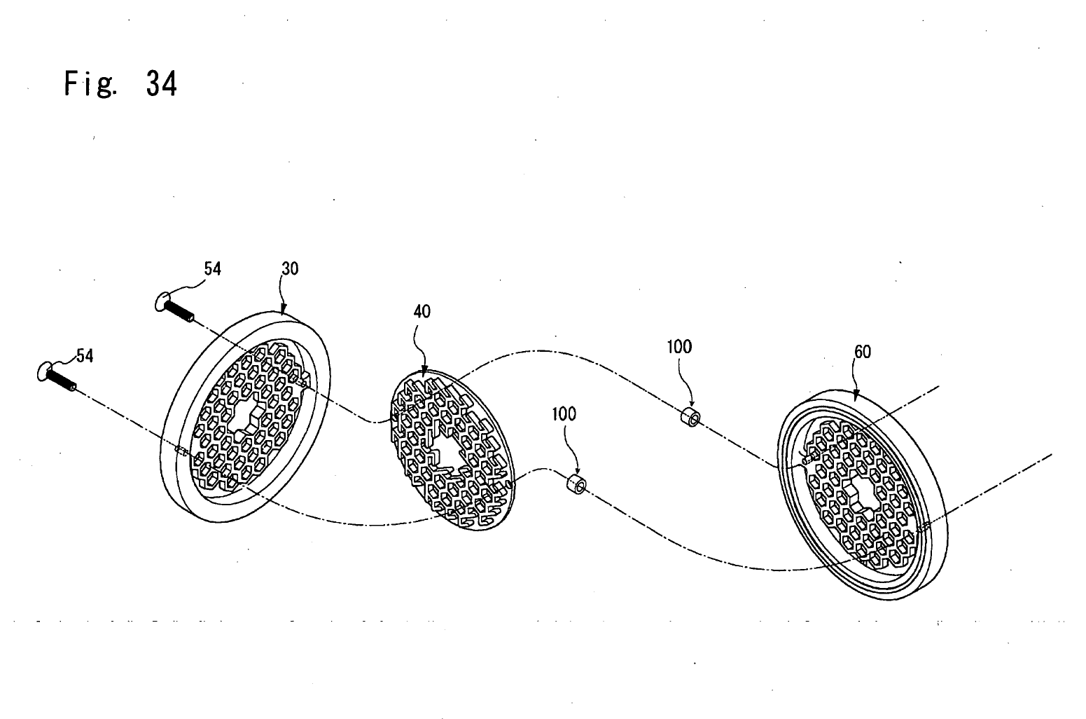

Next, a fluid mixer 11C of the fourth embodiment will be described referring to FIGS. 32 to 34. The same constituent elements of the abovementioned fluid mixer 11B of the third embodiment are designated by the same reference numerals, a duplicate description of which is omitted here.

Unlike the fluid mixer 11B of the third embodiment, in the fluid mixer 11C of the fourth embodiment, the collecting-flow-path forming element 50 is not provided as a constituent element of the mixing unit set up in the casing main body 21.

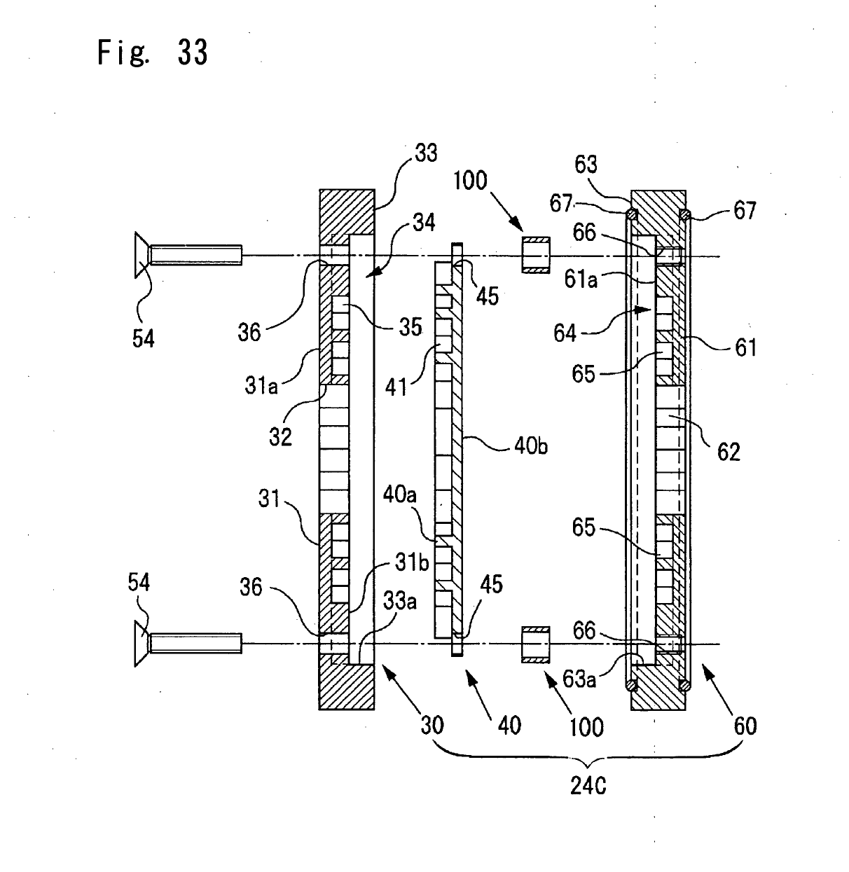

Specifically, as shown in FIG. 33, a mixing unit 24C of the fluid mixer 11C of the fourth embodiment is provided with a pair of spacers 100, 100 and a lead-out side element 60 in place of the first mixing element 30, the second mixing element 40, and the collecting-flow-path forming element 50, of the third embodiment.

The spacers 100 each are formed in a cylindrical shape having opening ends at both ends so that: an interval between the second mixing element 40 and the lead-out side element 60, i.e., a flow path depth Z (see FIG. 32) of the collecting flow path 26 which is a disk-shaped space formed between the elements 40 and 60 can be appropriately set according to the size of a cylindrical length of the spacer 100; and a change of the flow path depth Z of the collecting flow path 26 can be readily performed by replacing the current spacer with another spacer 100 having an appropriate cylindrical length.

In addition, the mixing unit 24C is assembled in the states shown in FIGS. 32 to 34.

That is, a state in which the first mixing element 30, the second mixing element 40, and the lead-out side element 60 are assembled with each other is identical to that of the third embodiment; and these elements are assembled by screw-tightening them with screws 54, 54 while through holes 36, 36 of the first mixing element 30, screw holes 43, 43 of the second mixing element 40, opening ends of the pair of spacers 100, 100, and screw holes 66, 66 of the lead-out side element 60 are positionally aligned with each other.

If the spacers 100, 100 are assembled after interposed between the second mixing element 40 and the lead-out side element 60 as described above, an inflow path 24b (see FIG. 32) which is a ring-shaped gap is formed all around the outer circumference between the second mixing element 40 and the lead-out side element 60.

In addition, as shown in FIG. 32, the inflow path 24b for the collecting flow path 26, which is a ring-shaped opening, is disposed at a position opposite to the outflow path 24a. Namely, the fluid having flown out of the outflow path 24a formed on the outer circumferential edge of the second mixing element 40 directly flows from the ring-shaped inflow path 24b to the collecting flow path 26 formed between the second mixing element 40 and the lead-out side element 60.

With such a structure, a so called dead space in which fluid is prone to stay partway of a flow path for fluid is eliminated. If the dead space is present, fluid is prone to stay in that space, and dispersion in quality of the fluid mixing treatment (the quality such as the size of generated air bubbles, for example) is prone to occur.

In this point of view, in the embodiment, a dead space is minimized so that: the occurrence of the disadvantage is restrained to the minimum; uniform mixing treatment can be applied depending upon the type of fluid; and more uniformly sized air bubbles can be generated. Moreover, in the fluid mixer 11C, a simple structure and low cost can be achieved in comparison with that of the third embodiment.

As described previously, the collecting flow path 26 (see FIG. 32) is formed between the second mixing element 40 and the lead-out side element 60 so that fluid flows from the inflow path 24b to the collecting flow path 26.

In the collecting flow path 26, the fluid flows from the outer circumferential side to the center side along the rear face of the second mixing element 40; flows into a fluid discharge port 63 (see FIG. 32); and flows into the flow inlet 32 of the next mixing unit 24C, or alternatively, is led out from the fluid lead-out port 23a of the capping member 23 of a casing.

At this time, owing to the employment of the lead-out side element 60 provided with a plurality of recessed portions 65 on a surface facing to the collecting flow path 26, a local high-pressure portion or a local low-pressure portion can be generated in the collecting flow path 26 and in the fluid flowing in the vicinity of an opening of the recessed portion 65.

When a local low-pressure portion (for example, a negative pressure portion such as a vacuum portion) is generated in the abovementioned fluid, there occurs a so called foaming phenomenon that air bubbles are generated in liquid; and there occurs a so called cavitation phenomenon that: fine air bubbles expands (collapses); and the generated air (air bubbles) break(s) (disappear(s)).

Miniaturization of substances targeted for mixing is performed by means of a force generated when this cavitation occurs, and fluid mixing is accelerated.

### Exemplary Modification of Collecting-Flow-Path Forming Element 50

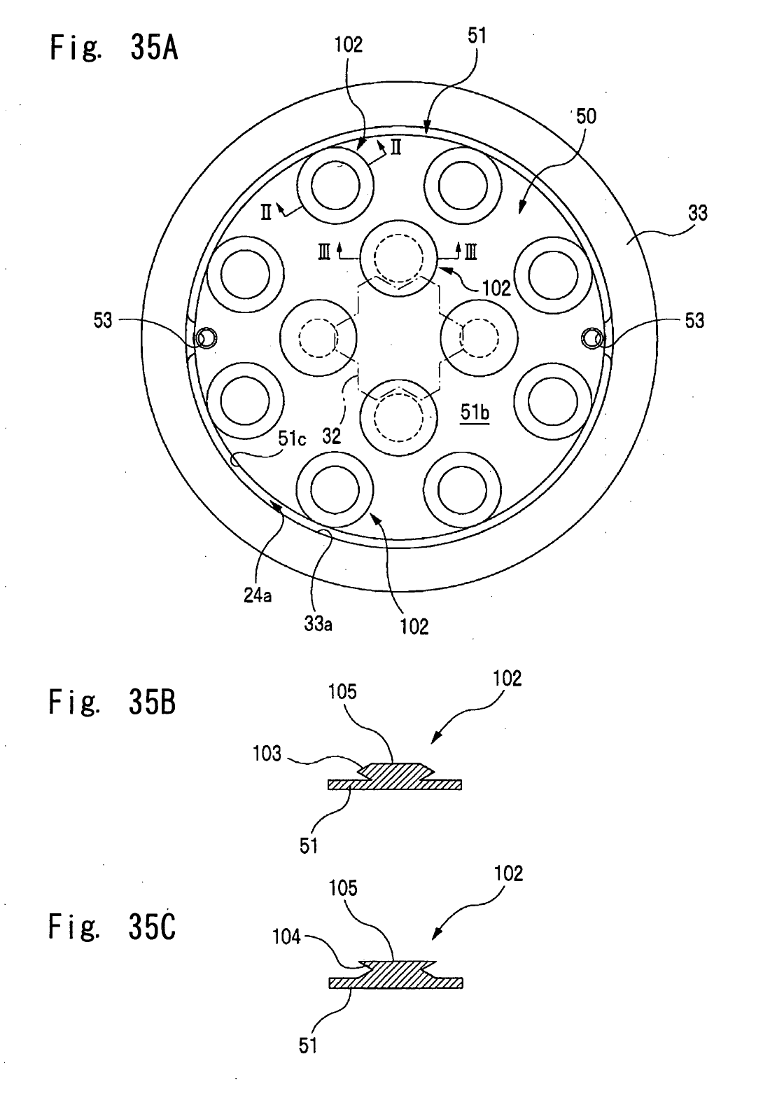

FIGS. 35A to 35C each show an exemplary modification of a collecting-flow-path forming element 50, wherein a complex flow generating members 102 as a number of complex flow generating means are protruded after integrally molded on a downstream side face 51b of an element main body 51, and a collecting flow path 26 is formed between the complex flow generating member 102 adjacent to each other.

The complex flow generating member 102 is formed in a substantially cylindrical shape, as shown in FIGS. 35A to 35C, in the exemplary modification; and a circumferential face serving as a contact face with fluid is formed in the shapes of a protrusive face 103 and a recessed face 104. The contact face with fluid is formed to be large in size. In addition, a plurality of the complex flow generating members 102 having protrusive faces 103 (eight pieces in the embodiment) are disposed at intervals in the circumferential direction at the circumferential edge part of the element main body 51 at intervals in the circumferential direction at the circumferential edge part of the element main body 51. Further, a plurality of the complex generating members 102 having recessed faces 104 (four pieces in the embodiment) are disposed at positions close to the center part between the complex flow generating members 102, 102 adjacent to each other. Reference numeral 105 designates an abutment face.

In this manner, the mixture fluid flowing from the outflow path 24a into the collecting flow path 26 flows along these protrusive face 103 and recessed face 104; and is formed as a turbulent flow while repeating a complex flow/a pulsating flow so as to flow into the flow inlet 32 and the fluid discharge port 63 of the mixing units adjacent to each other at the downstream side.

The complex flow is a flow of fluid flowing while scrubbing a face of an object, and the complex flow generating means is a protrusive matter having a face for generating the complex flow. In addition, the pulsating flow is the one wherein the flow path sectional area intermittently varies.

Therefore, the complex flow generating member 102 is disposed in the collecting flow path 26, whereby when fluid passes through the inside of the collecting flow path 26, the fluid is formed while the complex flow/pulsating flow is repeated by the presence of the complex flow generating member 102; and a local high-pressure portion or a local low-pressure portion is generated in the fluid.

When a local low-pressure portion (for example, a negative pressure portion such as a vacuum portion) is generated in the fluid, a so called foaming phenomenon occurs in which air bubbles are generated in liquid; and there occurs a so called cavitation phenomenon in which; fine air bubbles expands (collapses); and the generated air (air bubbles) break(s) (disappear(s)).

Miniaturization of substances targeted for mixing is performed by means of a force generated when this cavitation occurs, and fluid mixing is accelerated.

As described previously, if a fluid high-pressure portion is locally generated at or near a position at which the leakage of fluid is prone to occur, the leakage of the fluid is prone to occur, and thus, in that sense, it is not preferable that the local high-pressure portion be generated.

However, as described above, the complex flow generating member 102 is disposed in the collecting flow path 26, whereby, among the flow paths from the flow outlet to the discharge port, a local high-pressure portion or a local low-pressure portion can be generated in the fluid at only a site at which the complex flow generating member 102 is disposed; and fluid mixing is accelerated.

In addition, while, in the embodiment, both of the complex flow generating members 102 having the protrusive and recessed faces 103 and 104 are provided in the element main body 51, only either one of these members 102 can be provided in the element main body 51. The shape of the complex flow generating means may be any shape of forming a complex flow, and is not limitative to the substantially cylindrical shape of the embodiment.

While the several embodiments of the fluid mixers have been described so far, a variety of alterations can occur without being limitative thereto.

For example, while, in the fluid mixers of each of the embodiments, openings of the recessed portions 35, 41 were formed like regular hexagons, they may be shaped like triangles such as regular triangles, rectangles such as squares, or octagons such as regular octagons, for example, without being limitative thereto.

In addition, among the fluid mixers employed in the above-described embodiments, the fluid mixers 11B, 11C of the third and fourth embodiments are provided with sealing packing, whereas a sealing member may be set up in the fluid mixers 11, 11A of the first and second embodiments. If the sealing member is setup, sealing properties are enhanced more remarkably, and the occurrence of fluid leakage or the like is reliably prevented.

In addition, while, in the above-described embodiments, a so called dead space is minimized in the fluid mixers 11B, 11C of the third and fourth embodiments shown in FIGS. 28 and 32, respectively, there may be provided a structure of eliminating the dead space in the fluid mixers 11, 11A of the first and second embodiments to the possible extent as well.

For example, there can be proposed a structure such that, by further increasing the thickness (a thickness in the axis line) of the circumferential wall portion 33 of the first mixing element, an end face which is a downstream side face (a face at the fluid lead out port side) of the circumferential wall portion 33 is caused to abut against an upstream side face (a face at the fluid feed port side) of the first mixing element of another mixing unit 24 which is disposed at the downstream side.

### Fluid Mixer 11D as an Exemplary Modification of the First Embodiment

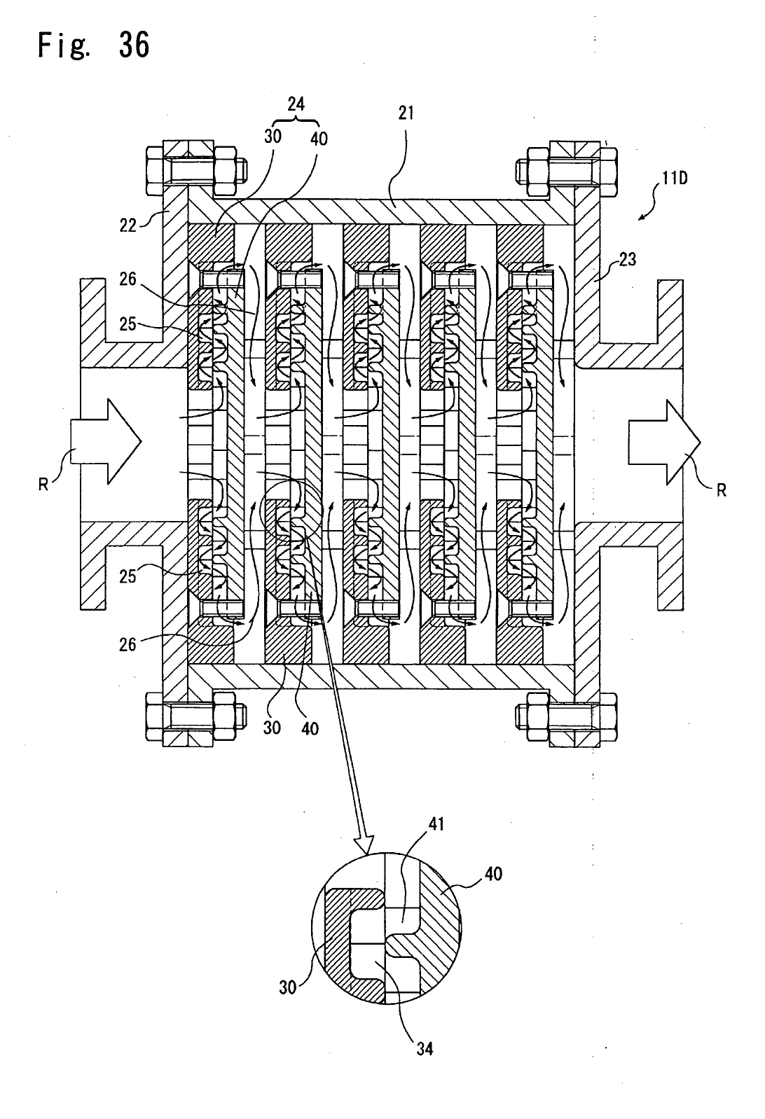

As shown in FIG. 36, a fluid mixer 11D is provided as an exemplary modification in which a smooth face is formed by rounding a rectangular part of a portion coming into contact with a treatment fluid, among the elements configuring the mixing unit 24 of the first embodiment. For example, as shown in a partially exploded view of FIG. 36, a rectangular part of an opening end of a recessed portion 35 which is formed in a recessed portion 34 of the first mixing element 30 is rounded and smoothened.

In addition, the corner part of the portion coming into contact with the treatment fluid may be formed as a rounded smooth face. For example, as shown in the partially exploded view of the FIG. 36, a corner part of a bottom face of the recessed portion 35 which is formed in the recessed portion 34 of the first mixing element 30 may be rounded and smoothened.

By means of the rounding and smoothening, a flow path resistance is reduced, and the amount of treatment per a unit time can be increased.

In addition, by rounding a corner part, a dead space is reduced; the fluid can be mixed more uniformly; and the fluid mixing treatment performance can be enhanced. For example, air bubbles of more uniform sizes can be generated, or alternatively, dispersion as to the size of generated air bubbles can be reduced more remarkably.

While the fluid mixer 11D of FIG. 36 altered the fluid mixer 11 of the first embodiment, the fluid mixers 11A, 11B, 11C of the second, third, and fourth embodiments may be altered similarly.

### Fluid Mixer 11E as Another Exemplary Modification of the First Embodiment

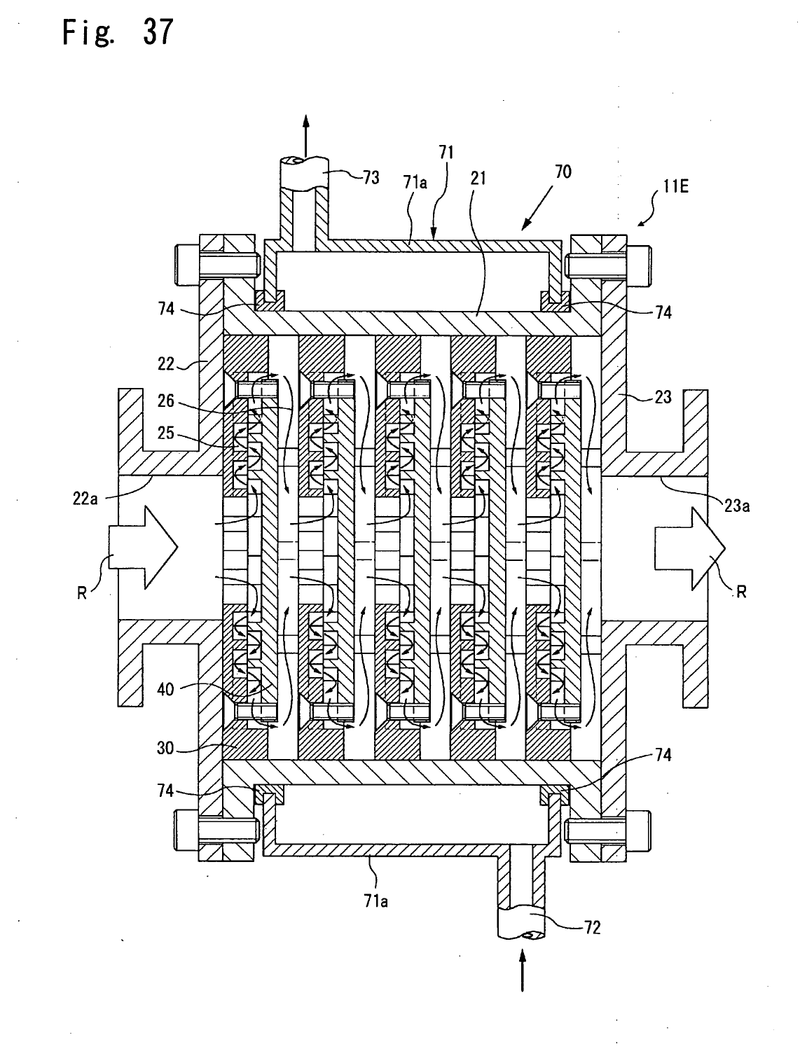

As shown in FIG. 37, a fluid mixer 11E is configured so that a temperature control unit 70 is set up in a fluid mixer 11. The temperature control unit 70 is provided with: a jacket section 71 which covers the outer circumference of a casing main body 21 of the fluid mixer 11E; a water feed pipe 72 which is connected to a water feed pump, although not shown, for feeding fluid (water in this example) for temperature control into the jacket section 71; and a drain pipe 73 for leading out water from the jacket section 71.

The jacket section 71 is adapted to assemble and align divisional jacket members 71a, 71a that are formed in a semi-cylindrical shape, so as to be removably mounted on the casing main body 21. In addition, packing 74 is mounted on a contact portion with the casing main body 21 of the jacket section 71, so as to prevent the leakage of water for temperature control.

As long as the temperature control unit 70 is set up, when an attempt is made to prevent a temperature rise of the fluid targeted for fluid mixing treatment (gas-liquid mixture fluid targeted for treatment of air bubbles, for example), the temperature rise of the treatment fluid can be readily prevented by feeding cooling water to a jacket. While the fluid mixer 10E of FIG. 28 altered the fluid mixer 11 of the first embodiment, the fluid mixers 11A, 11B, 11C, 11D of other embodiments may be altered similarly.

In addition, while the temperature control unit 70 shown in FIG. 37 performs temperature control of coolant or the like, by employing coolant such as cooling water, a variety of methods, such as a method of providing a heat radiation fin in casing, for example, can be proposed without being limitative thereto.

### Effects Pertinent to the Basic Configuration of Fluid Mixers

The effects pertinent to the basic configuration of the fluid mixers configured as described above will be described below.

That is, in the fluid mixers, a gap-shaped opening is formed as a flow outlet between the outer circumference edge of the second mixing element and the first mixing element. Namely, a flow outlet all around the outer circumference of the second mixing element is formed along the outer circumferential edge of the second mixing element. In addition, the size of an opposite face of the second mixing element is formed to be smaller than that of an opposite side face of the first mixing element, and the opening is positioned more inward than the outer circumferential edge of the first mixing element. Namely, the opening as the flow outlet is formed on a face at the downstream side of a mixing unit consisting of both of the mixing elements, i.e., on a face opposite to the face on which the flow inlet is formed. With such configuration, a liquid mixture flow path between the mixing elements directly communicates with the flow path at the downstream side of both of the mixing elements, via the flow outlet; and further, flow outlets exist all around there, so that dispersion in fluid pressure is hardly prone to occur, resulting in a lowered flow path resistance. If the flow path resistance is lowered, the amount of treatment can be increased, without need to increase the pressure of fluid to be fed; and the amount of treatment can be increased, preventing the fluid leakage from a seal section.

In particular, according to the fluid mixers, air bubbles of 500 nm or less in average particle size can be generated in the fluid to be treated; and air bubbles of 50 nm or less in average particle size can also be generated in the fluid to be treated. At this time, the fluid to be treated can be reformed. For example, assuming that water generally does not exist as a single molecule, and a cluster made of a number of molecules is formed, if the water is treated by means of the fluid mixers, reformed water, which is smaller in cluster size, can be formed. The reformed water that is smaller in cluster size is prone to be uniformly mixed with a fuel oil, via very fine air bubbles whose diameter is on the nano-level (less than 1 micron); and an emulsion fuel can be produced without employing a surfactant or the like.

Further, the following effects can also be attained.

(1) A pressure loss is lowered in a fuel mixer. If the pressure loss is lowered, an output of treatment fluid feeding means such as a pump can be reduced when the treatment fluid of the same amount is fed.
(2) As long as the same output is maintained, treatment capability increases.
(3) Although the lowered pressure loss is considered to be a cause, the noise generated due to fluid mixing treatment is reduced; quietness is enhanced; and vibration is reduced.
(4) if the noise or vibration at the time of fluid mixing treatment is reduced, the fluid mixers can be set up in location requiring quietness or the like, such as hospital.
(5) Since the pressure loss is reduced, fluid mixing treatment can be performed at a low pressure, and a seal member such as packing is not needed to be used. In this manner, cumbersomeness such as replacement of seal members is eliminated, achieving easy maintenance.

Equipment for the production of emulsion fuel, according to the present invention, is connected in communication with combustion equipment such as a burner, and the emulsion fuel is fed to the combustion equipment, whereby combustion efficiency of the combustion equipment can be enhanced.

1. (canceled)

2. An emulsion fuel comprising fine air bubbles, produced by providing that a fuel oil as a continuous phase and water mixed with fine air bubbles as a dispersed phase are mixed with each other by means of the fluid mixer set forth in claim 25.

3. An emulsion fuel comprising fine air bubbles, produced by providing that a fuel oil mixed with fine air bubbles as a continuous phase and water as a dispersed phase are mixed with each other by means of the fluid mixer set forth in claim 25.

4. An emulsion fuel comprising fine air bubbles, produced by providing that a liquid mixture, as a dispersed phase, obtained by mixing water mixed with fine air bubbles as a continuous phase and a fuel oil as a dispersed phase with each other by means of the fluid mixer set forth in claim 25, is mixed with a fuel oil as a continuous phase.

5. An emulsion fuel comprising fine air bubbles, produced by providing that a liquid mixture, as a dispersed phase, obtained by mixing water as a continuous phase and a fuel oil mixed with fine air bubbles as a dispersed phase with each other by means of the fluid mixer set forth in claim 25, is mixed with a fuel oil as a continuous phase.

6. An emulsion fuel, produced by providing that a liquid mixture, as a dispersed phase, obtained by mixing water as a continuous phase and a fuel oil as a dispersed phase with each other by means of the fluid mixer set forth in claim 25, is mixed with a fuel oil as a continuous phase.

7. An emulsion fuel, produced by providing that water treated to be reformed as a dispersed phase and a fuel oil as a continuous phase are mixed with each other by means of the fluid mixer set forth in claim 25.

8. An emulsion fuel, produced by providing that a fuel oil as a continuous phase and water as dispersed phase are miniaturized and mixed with each other at a precedent stage and are ultra-miniaturized and mixed with each other at a subsequent stage by means of the fluid mixer set forth in claim 25.

9. A process for production of emulsion fuel, wherein a fuel oil and water are treated to be mixed with each other, forming a liquid mixture comprising a fuel oil as a continuous phase and fine water droplets as a dispersed phase, and subsequently, a slight amount of air is added to the mixture, and is further treated to be mixed with each other by means of the fluid mixer set forth in claim 25, thereby producing an emulsion fuel comprising fine air bubbles.

10. A process for production of emulsion fuel, wherein water and air are treated to be mixed with each other, forming water mixed with fine air bubbles, and subsequently, the water mixed with the fine air bubbles and a fuel oil are treated to be mixed with each other by means of the fluid mixer set forth in claim 25, thereby producing an emulsion fuel including fine air bubbles, comprising a fuel oil as a continuous phase and fine water droplets and fine air bubbles, as a dispersed phase.

11. A process for production of emulsion fuel, wherein a fuel oil and water are treated to be mixed with each other, forming a fuel oil mixed with fine air bubbles, and subsequently, the fuel oil mixed with the fine air bubbles and water are treated to be mixed with each other by means of the fluid mixer set forth in claim 25, thereby producing an emulsion fuel comprising fine air bubbles, comprising a fuel oil mixed with fine air bubbles, as a continuous phase, and fine water droplets as a dispersed phase.

12. A process for production of emulsion fuel, wherein water and air are treated with each other, forming water mixed with fine air bubbles, and subsequently, the water mixed with the fine air bubbles and a fuel oil are treated to be mixed with each other by means of the fluid mixer set forth in claim 25, thereby forming a liquid mixture comprising water mixed with fine air bubbles, as a continuous phase, and fine oil droplets as a dispersed phase, and further subsequently, the liquid mixture and fuel oil are treated to be mixed with each other, thereby producing an emulsion fuel comprising fine air bubbles, comprising a fuel oil as a continuous phase and water droplets containing fine oil droplets and fine air bubbles, as dispersed phase.

13. A process for production of emulsion fuel, wherein a fuel oil and air are treated to be mixed with each other, thereby forming a fuel oil mixed with fine air bubbles, and subsequently, the fuel oil mixed with the fine air bubbles and water are treated to be mixed with each other by means of the fluid mixer set forth in claim 25, thereby forming a liquid mixture comprising water as a continuous phase, fine oil droplets as a dispersed phase, and fine air bubbles, and subsequently, the liquid mixture and fuel oil are treated to be mixed with each other, thereby producing an emulsion fuel including fine air bubbles, comprising a fuel oil as a continuous phase and water droplets containing fine oil droplets and fine air bubbles, as a dispersed phase.

14. A process for production of emulsion fuel, wherein water and a fuel oil are treated to be mixed with each other by means of the fluid mixer set forth in claim 25, forming a liquid mixture consisting of water as a continuous phase and fine oil droplets as a dispersed phase, and subsequently, the liquid mixture and fuel oil are treated to be mixed with each other, thereby producing an emulsion fuel comprising a fuel oil as a continuous phase and water droplets containing fine oil droplets as a dispersed phase.

15. A process for production of emulsion fuel, wherein water as a dispersed phase is treated to be reformed in advance, and the water as the dispersed phase, which are further treated to be reformed, and a fuel oil as a continuous phase are treated to be mixed with each other by means of the fluid mixer set forth in claim 25, thereby producing an emulsion fuel.

16. A process for production of emulsion fuel, wherein a fuel oil as a continuous phase and water as a dispersed phase are treated to miniaturized and mixed with each other in a precedent stage to form a liquid mixture, and subsequently, the liquid mixture is treated to be ultra-miniaturized and mixed in a subsequent stage by means of the fluid mixer set forth in claim 25, thereby producing an emulsion fuel.

17. Equipment for production of emulsion fuel, comprising:
a primary mixing treatment section for treating a fuel oil and water to be mixed with each other to form a liquid mixture comprising a fuel oil as a continuous phase and fine water droplets as a dispersed phase; and
a secondary mixing treatment section for adding a slight amount of air to the liquid mixture to further perform mixing treatment,
said equipment producing an emulsion fuel comprising fine air bubbles,
wherein the secondary mixing treatment section is the fluid mixer set forth in claim 25.

18. Equipment for production of emulsion fuel, comprising:
a primary mixing treatment section for treating water and air to be mixed with each other to form water mixed with fine air bubbles; and
a secondary mixing treatment section for treating water mixed with fine air bubbles and a fuel oil to be mixed with each other,
said equipment producing an emulsion fuel including fine air bubbles, comprising a fuel oil as a continuous phase and fine water droplets and fine air bubbles, as a dispersed phase,
wherein the secondary mixing treatment section is the fluid mixer set forth in claim 25.

19. Equipment for production of emulsion fuel, comprising:
a primary mixing treatment section for treating a fuel oil and air to be mixed with each other to form a fuel oil mixed with air bubbles; and
a secondary mixing treatment section for treating the fuel oil mixed with the fine air bubbles and water to be mixed with each other,
said equipment producing an emulsion fuel including fine air bubbles, comprising a fuel oil mixed with fine air bubbles, as a continuous phase, and fine water droplets as a dispersed phase,
wherein the secondary mixing treatment section is the fluid mixer set forth in claim 25.

20. Equipment for production of emulsion fuel, comprising:
a primary mixing treatment section for treating water and air to be mixed with each other to form water mixed with fine air bubbles;
a secondary mixing treatment section for treating the water mixed with the fine air bubbles and a fuel oil to be mixed with each other to form a liquid mixture comprising water mixed with fine air bubbles, as a continuous phase, and fine oil droplets as a dispersed phase; and
a third mixing treatment section for treating the liquid mixture and fuel oil to be mixed with each other,
said equipment producing an emulsion fuel including fine air bubbles, comprising a fuel oil as a continuous phase and water droplets containing fine oil droplets and fine air droplets, as a dispersed phase,
wherein the secondary mixing treatment section is the fluid mixer set forth in claim 25.

21. Equipment for production of emulsion fuel, comprising:
a primary mixing treatment section for treating a fuel oil and air to be mixed with each other to form a fuel oil mixed with fine air bubbles;
a secondary mixing treatment section for treating the fuel oil mixed with the fine air bubbles and water to be mixed with each other to form a liquid mixture comprising water as a continuous phase and fine oil droplets and fine air bubbles as a dispersed phase; and
a third mixing treatment section for treating the liquid mixture and fuel oil to be mixed with each other,
said equipment producing an emulsion fuel including fine air bubbles, comprising a fuel oil as a continuous phase and water droplets containing fine oil droplets and fine air bubbles, as a dispersed phase,
wherein the secondary mixing treatment section is the fluid mixer set forth in claim 25.

22. Equipment for production of emulsion fuel, comprising:
a primary mixing treatment section for treating water and a fuel oil to be mixed with each other to form a liquid mixture comprising water as a continuous phase and fine oil droplets as a dispersed phase; and
a secondary mixing treatment section for treating the liquid mixture and fuel oil to be mixed with each other,
said equipment producing an emulsion fuel comprising a fuel oil as a continuous phase and water droplets containing fine oil droplets as a dispersed phase,
wherein the primarily mixing treatment section is the fluid mixer set forth in claim 25.

23. Equipment for production of emulsion fuel, comprising:
a reform treatment section for treating water as a dispersed phase to be reformed, to form reform-treated water; and
a mixing treatment section for treating the water to be reformed as a dispersed phase and a fuel oil as a continuous phase to be mixed with each other,
said equipment producing an emulsion fuel,
wherein the mixing treatment section is the fluid mixer set forth in claim 25.

24. Equipment for production of emulsion fuel, comprising:
a primary mixing treatment section at a precedent stage, for treating a fuel oil as a continuous phase and water as a dispersed phase to be miniaturized and mixed with each other to form a liquid mixture; and
a secondary mixing treatment section in a subsequent stage, for treating the liquid mixture to be ultra-miniaturized and mixed,
said equipment producing an emulsion fluid,
wherein the secondary mixing treatment section is the fluid mixer set forth in claim 25.

25. An emulsion fuel comprising fine air bubbles produced by:
allowing a slight amount of air to be added to, and to be mixed with, a liquid mixture of a fuel oil as a continuous phase and water as a dispersed phase, by means of a fluid mixer,
wherein the fluid mixer comprises a mixing unit allowing a disk-shaped second mixing element to be disposed to be opposed to a disk-shaped first mixing element forming a flow inlet of a fluid at a center part thereof, the mixing unit forming a mixing flow path for flowing and mixing the fluid having in-flow from a flow inlet in a radiation direction between the mixing elements;
the mixing unit is disposed in plurality in a casing main body formed in a cylindrical shape at given intervals in an axial direction thereof, forming a space for forming a flow path by the adjacent mixing units and the casing main body;
a disk-shaped collecting-flow-path forming element is disposed in the space for forming the flow path so that a collecting-flow path is formed allowing the fluid having passed through the mixing flow path to outflow substantially equally from an entire circumference of a flow outlet opening like a ring, and then, flow and gather to an axial core side of the casing main body;
an expansive guide member for stabilizing a flow-path sectional area on one side face of an element main body is formed at the collecting-flow-path forming element, the guide member being formed in a substantially fan-like, flat shape from an outer circumferential arc face formed on an arc face of a curvature which is identical to that of an outer circumferential edge of the element main body, a pair of side faces connected to be extended from both ends of the outer circumferential arc face to a center side of the element main body, and an abutment face formed as a plane parallel to the element main body; and
the guide member is disposed in plurality at a circumferential part of the element main body at equal intervals in a circumferential direction thereof, and is formed so that: an outer circumferential arc face of each of the guide members is flush with an outer circumferential edge face of the collecting-flow-path forming element and an outer circumferential edge face of the second mixing element; and the side faces opposite to each other, of the adjacent guide members is in parallel to each other in a circumferential direction, allowing a groove portion width of a groove portion, which is formed of a side face of the adjacent guide members and a rear face of the element main body to be substantially equal to another one from a circumferential side to a center side, of the collecting-flow-path forming element.

26. Apparatus used in the production of emulsion fuel comprising:
a mixing unit allowing a disk-shaped second mixing element opposed to a disk-shaped first mixing element forming a flow inlet of a fluid at a center part thereof, the mixing unit forming a mixing flow path for flowing and mixing the fluid having in-flow from a flow inlet in a radiation direction between the mixing elements;
the mixing unit is disposed in plurality in a casing main body formed in a cylindrical shape at given intervals in an axial direction thereof, forming a space for forming a flow path by the adjacent mixing units and the casing main body;
a disk-shaped collecting-flow-path forming element is disposed in the space for forming the flow path so that a collecting-flow path is formed allowing the fluid having passed through the mixing flow path to outflow substantially equally from an entire circumference of a flow outlet opening like a ring, and then, flow and gather to an axial core side of the casing main body;
an expansive guide member for stabilizing a flow-path sectional area on one side face of an element main body is formed at the collecting-flow-path forming element, the guide member being formed in a substantially fan-like, flat shape from an outer circumferential arc face formed on an arc face of a curvature which is identical to that of an outer circumferential edge of the element main body, a pair of side faces connected to be extended from both ends of the outer circumferential arc face to a center side of the element main body, and an abutment face formed as a plane parallel to the element main body; and
the guide member is disposed in plurality at a circumferential part of the element main body at equal intervals in a circumferential direction thereof, and is formed so that: an outer circumferential arc face of each of the guide members is flush with an outer circumferential edge face of the collecting-flow-path forming element and an outer circumferential edge face of the second mixing element; and the side faces opposite to each other, of the adjacent guide members is in parallel to each other in a circumferential direction, allowing a groove portion width of a groove portion, which is formed of a side face of the adjacent guide members and a rear face of the element main body to be substantially equal to another one from a circumferential side to a center side, of the collecting-flow-path forming element.

27. An emulsion fuel comprising air bubbles produced by providing that a fuel oil as a continuous phase and water mixed with air bubbles as a dispersed phase are mixed with each other.

28. A process for production of emulsion fuel comprising providing that a fuel oil and water are treated to be mixed with each other, thereby forming a liquid mixture comprising a fuel oil as a continuous phase and fine water droplets as a dispersed phase, and subsequently, air is added to the mixture, and is further treated to be mixed with each other thereby producing an emulsion fuel comprising air bubbles.

29. A process for the production of emulsion fuel comprising providing that water and air are treated with each other, thereby forming water mixed with air bubbles, and subsequently, the water mixed with the air bubbles and a fuel oil are treated to be mixed with each other thereby forming a liquid mixture comprising water mixed with fine air bubbles, as a continuous phase, and oil droplets as a dispersed phase, and further subsequently, the liquid mixture and fuel oil are treated to be mixed with each other, thereby producing an emulsion fuel comprising air bubbles, comprising a fuel oil as a continuous phase and water droplets containing oil droplets and air bubbles, as dispersed phase.

30. Equipment for production of emulsion fuel, comprising:
a primary mixing treatment section for treating a fuel oil and water to be mixed with each other to form a liquid mixture consisting of a fuel oil as a continuos phase and water droplets as a dispersed phase; and
a secondary mixing treatment section for adding air to the liquid mixture to further perform mixing treatment,
said equipment producing and emulsion fuel comprising air bubbles.

31. Equipment for production of emulsion fuel, comprising:
a primary mixing treatment section for treating water and air to be mixed with each other to form water mixed with air bubbles;
a secondary mixing treatment section for treating the water mixed with the air bubbles and a fuel oil to be mixed with each other to form a liquid mixture comprising water mixed with air bubbles, as a continuous phase, and oil droplets as a dispersed phase; and
a third mixing treatment section for treating the liquid mixture and fuel oil to be mixed with each other;
said equipment producing an emulsion fuel comprising air bubbles, comprising fuel oil as a continuous phase and water droplets containing oil droplets and air bubbles, as a dispersed phase.

32. Equipment for production of emulsion fuel, comprising:
a primary mixing treatment section for treating water and a fuel oil to be mixed with each other to form a liquid mixture comprising water as a continuous phase and oil droplets as a dispersed phase; and
a secondary mixing treatment section for treating the liquid mixture and fuel oil to be mixed with each other,
said equipment producing an emulsion fuel comprising a fuel oil as a continuous phase and water droplets containing oil droplets as a dispersed phase.
